(19) United States
(12) Patent Application Publication
(10) Pub. No.: US 2025/0028790 A1
(43) Pub. Date: Jan. 23, 2025

(54) Systems and Methods for Token Use and Protection Using Blockchain

(71) Applicant: Artema Labs, Inc, Los Angeles, CA (US)

(72) Inventors: Keir Finlow-Bates, Eura (FI); Kenneth Rosen, Portola Valley, CA (US); Bjorn Markus Jakobsson, New York, NY (US)

(73) Assignee: Artema Labs, Inc, Los Angeles, CA (US)

(21) Appl. No.: 18/777,298

(22) Filed: Jul. 18, 2024

Related U.S. Application Data
(60) Provisional application No. 63/514,315, filed on Jul. 18, 2023.
(60) Provisional application No. 63/587,631, filed on Oct. 3, 2023.
(60) Provisional application No. 63/623,023, filed on Jan. 19, 2024.

(51) Int. Cl. G06F 21/10

(52) U.S. Cl. CPC G06F 21/1014

(57) ABSTRACT

Systems and methods for implementing sticky tokens are illustrated. One embodiment includes a machine-readable medium containing bytecode stored within an immutable ledger. The bytecode encodes a review token, comprising a token identifier. The review token comprises a content element, wherein: the content element comprises a text document; and the text document corresponds to a written review. The review token comprises a recipient identifier, wherein the recipient identifier identifies a blockchain address of an intended recipient. The review token comprises access control information, comprising a right to transfer the review token. Execution of the bytecode occurs automatically when the recipient identifier matches a current owner of the review token. Execution of the bytecode renders of the content element. Execution of the bytecode blocks the blockchain address of the intended recipient from possessing the right to transfer.

### CROSS-REFERENCE TO RELATED APPLICATIONS

The current application claims the benefit of and priority under 35 U.S.C. § 119(e) to U.S. Provisional Patent Application No. 63/514,315, titled “Systems and Methods for Tokens and Messaging Using a Blockchain,” filed Jul. 18, 2023, U.S. Provisional Patent Application No. 63/587,631, titled “Token Abuse Protection,” filed Oct. 3, 2023, U.S. Provisional Patent Application No. 63/623,023, titled “Bound Blockchains and Autonomous Smart Contracts,” filed Jan. 19, 2024, the disclosures of which are hereby incorporated by reference in their entireties for all purposes.

### FIELD OF THE INVENTION

The present invention generally relates to blockchains, specifically system communication and redundancies facilitated through blockchain.

### BACKGROUND

Blockchain technology is implemented in a manner which instantiates digital assets with clearly defined ownership. The blockchain functions as a ledger recording who owns what, and restricts the movement of digital assets, such as cryptocurrency or tokens, from one party to another based on identity and access management encoded in the blockchain. As such, blockchains (and software running on those blockchains in the form of smart contracts) can address and process digital assets as held commodities. Blockchain and smart contracts thereby facilitate transactions between parties, with the blockchain itself acting as a distributed ledger providing a public record.

### SUMMARY OF THE INVENTION

Systems and methods for implementing sticky tokens are illustrated. One embodiment includes a machine-readable medium containing bytecode stored within an immutable ledger. The bytecode encodes a review token, comprising a token identifier. The review token comprises a content element, wherein: the content element comprises a text document; and the text document corresponds to a written review. The review token comprises a recipient identifier, wherein the recipient identifier identifies a blockchain address of an intended recipient. The review token comprises access control information, comprising a right to transfer the review token. Execution of the bytecode occurs automatically when the recipient identifier matches a current owner of the review token. Execution of the bytecode renders of the content element. Execution of the bytecode blocks the blockchain address of the intended recipient from possessing the right to transfer.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 is a conceptual diagram of an NFT platform in accordance with some embodiments of the invention.

FIG. 2 is a network architecture diagram of an NFT platform in accordance with numerous embodiments of the invention.

FIG. 3 is a conceptual diagram of a permissioned blockchain in accordance with multiple embodiments of the invention.

FIG. 4 is a conceptual diagram of a permissionless blockchain in accordance with many embodiments of the invention.

FIGS. 5A-5B are diagrams of a dual blockchain in accordance with a number of embodiments of the invention.

FIG. 6 conceptually illustrates a process followed by a Proof of Work consensus mechanism in accordance with some embodiments of the invention.

FIG. 7 conceptually illustrates a process followed by a Proof of Space consensus mechanism in accordance with a number of embodiments of the invention.

FIG. 8 illustrates a dual proof consensus mechanism configured in accordance with certain embodiments of the invention.

FIG. 9 illustrates a process followed by a Trusted Execution Environment-based consensus mechanism in accordance with some embodiments of the invention.

FIGS. 10-12 depicts various devices that may be utilized alongside an NFT platform in accordance with various embodiments of the invention.

FIG. 13 depicts a media wallet application configuration in accordance with several embodiments of the invention.

FIGS. 14A-14C depicts user interfaces of various media wallet applications in accordance with a number of embodiments of the invention.

FIG. 15 illustrates an NFT ledger entry corresponding to an NFT identifier in accordance with certain embodiments of the invention.

FIGS. 16A-16B illustrate an NFT arrangement relationship with corresponding physical content in accordance with many embodiments of the invention.

FIG. 17 illustrates a process for establishing a relationship between an NFT and corresponding physical content in accordance with some embodiments of the invention.

FIG. 18 illustrates a process for performing token transfers in accordance with many embodiments of the invention.

FIG. 19 depicts an example of a smart contract directed to sticky tokens implemented in accordance with multiple embodiments of the invention.

FIG. 20 conceptually illustrates a sticky token system implemented in accordance with numerous embodiments of the invention.

FIG. 21 conceptually illustrates a smart contract directed to liability tokens implemented in accordance with many embodiments of the invention.

FIG. 22 illustrates a block diagram depicting a liability token smart contract implemented in accordance with certain embodiments of the invention.

FIG. 23 illustrates a process for utilizing liability token smart contracts configured in accordance with multiple embodiments of the invention.

FIG. 24 conceptually illustrates a system for utilizing a liability token, configured in accordance with several embodiments of the invention.

FIG. 25 illustrates a block diagram depicting a liability token system implemented in accordance with various embodiments of the invention.

FIGS. 26A-26B conceptually illustrate a mailbox smart contract configured in accordance with some embodiments of the invention.

FIG. 27 conceptually illustrates a system for communicating encrypted messages in accordance with many embodiments of the invention.

FIG. 28 illustrates a blockchain wallet-based messaging component implemented in accordance with certain embodiments of the invention.

FIG. 29 illustrates a blockchain wallet implemented in accordance with various embodiments of the invention.

FIG. 30 illustrates a process governing a smart contract configured in accordance with certain embodiments of the invention.

FIG. 31 conceptually illustrates an exchange between an owner and a recipient of a token protected through a smart contract implemented in accordance with some embodiments of the invention.

FIG. 32 depicts a token enforcing a policy, applied in accordance with many embodiments of the invention.

FIGS. 33A-33C conceptually illustrate bound blockchains implemented in accordance with some embodiments of the invention.

FIG. 34 illustrates a synchronization, performed in accordance with multiple embodiments of the invention, between a primary token on a first blockchain and a secondary token on a second blockchain.

FIG. 35 illustrates a process, performed in accordance with many embodiments of the invention, for exchanging a primary status for a first token with a secondary status for a second token.

FIG. 36 illustrates a graph of bound blockchains operating in accordance with certain embodiments of the invention.

FIG. 37 conceptually illustrates an autonomous smart contract configured in accordance with a number of embodiments of the invention.

### DETAILED DESCRIPTION

Systems and methods for incorporating blockchain, smart contract, and token-directed functionalities into non-fungible token (NFT) platforms, in accordance with many embodiments of the invention, are described herein. Such functionality may include but is not limited to configurations limiting the transferability of tokens, facilitating private token-based messaging, enabling escrow-based token transactions, implementing security policies, associated (“bound”) blockchains and/or self-managing (“autonomous”) smart contracts.

Methods and systems in accordance with a number of embodiments of the invention may be used to enable an amount of cryptocurrency and/or tokens to represent limitations rather than assets. This may include, but is not limited to limits on transferability and/or representations of debt. Additionally or alternatively, restrictions on the transfer of the tokens may be enforced to ensure any associated liabilities may not be shifted to another party without predetermined conditions being met. These (temporarily and/or permanently) non-transferable tokens may be referred to as “sticky tokens” (generally) and “liability tokens” (when applied to debt).

Systems in accordance with numerous embodiments of the invention may, additionally or alternatively, facilitate communication between parties to transactions over blockchain. Systems may be used for enabling messaging functionality on a blockchain, thus providing data communication between parties that are transacting/communicating, and where the parties may remain anonymous and/or pseudonymous.

Systems configured in accordance with multiple embodiments of the invention may modify and/or apply policies governing token operations including but not limited to security. Blockchain wallets may be able to use systems to associate particular policies with tokens, by wrapping the tokens with smart contracts referring to the policies. By associating individual tokens with varying smart contracts, systems may be able to effectively improve token security from abuse. These policies may limit token attributes including but not limited to token access, token transfer permissions, and/or token associations (e.g., product royalties).

Smart contracts implemented in accordance with some embodiments of the invention may be configured to independently execute functionality. In such cases, autonomous smart contracts may be set to execute in response to conditions including but not limited to pre-set durations and/or indirect operations from external entities.

Systems operating in accordance with multiple embodiments of the invention may use nodes to establish continuous associations between multiple blockchains. Specifically, dual nodes, configured to monitor, maintain, and/or extend two or more blockchains, may allow systems to access data and facilitate transactions related to blocks corresponding to a plurality of blockchains in more interrelated manner.

While various token, smart contract, and blockchain configurations are discussed above, NFT-based functionalities that can be utilized within NFT platforms in accordance with several embodiments of the invention are discussed further below.

### Non-Fungible Token (NFT) Platforms

Turning now to the drawings, systems and methods for implementing blockchain-based Non-Fungible Token (NFT) platforms in accordance with various embodiments of the invention are illustrated. In several embodiments, blockchain-based NFT platforms are platforms which enable content creators to issue, mint, and transfer Non-Fungible Tokens (NFTs) directed to content including, but not limited to, rich media content.

In a number of embodiments, content creators may issue NFTs to users within the NFT platform. NFTs may be created around a large range of real-world media content and intellectual property. Movie studios may mint digital collectibles for their movies, characters, notable scenes and/or notable objects. Record labels may mint digital collectibles for artists, bands, albums and/or songs. Similarly, official digital trading cards may be made from likeness of celebrities, cartoon characters and/or gaming avatars.

NFTs minted using NFT platforms in accordance with various embodiments of the invention may have multifunctional programmable use cases including rewards, private access to premium content and experiences, as discounts toward the purchase of goods, among many other value-added use cases.

In many embodiments, each NFT may have a set of attributes that define its unique properties. NFTs may therefore be classified based on which attributes are emphasized. Possible classifications may address, but are not limited to: NFTs as identifying entities, NFTs output by other NFTs, NFTs as content creation assets, and NFTs as evaluating entities. NFTs may be interpreted differently by various platforms in order to create platform-specific user experiences. The metadata associated with an NFT may also include digital media assets such as (but not limited to) images, videos about the specific NFT, and the context in which it was created (studio, film, band, company song etc.).

In many embodiments, NFT storage may be facilitated through mechanisms for the transfer of payment from users to one or more service providers. Through these mechanisms, a payment system for NFT maintenance may allow for incremental payment and ongoing asset protection. NFT storage may be additionally self-regulated through willing participants disclosing unsatisfactory NFT management in exchange for rewards.

In many embodiments, the NFT platform may include media wallet applications that enable users to securely store NFTs and/or other tokens on their devices. Furthermore, media wallets (also referred to as “digital wallets”) may enable users to obtain NFTs that prove purchase of rights to access a particular piece of media content on one platform and use the NFT to gain access to the purchased content on another platform. The consumption of such content may be governed by content classification directed to visual user interface systems.

In several embodiments, users may download and install media wallet applications to store NFTs on the same computing devices used to consume streamed and/or downloaded content. Media wallet applications and NFTs may disseminate data concerning media consumption on the computing devices on which the media wallet applications are installed and/or based upon observations indicative of media consumption independently of the device. Media consumption data may include, but is not limited to, data reporting the occurrence of NFT transactions, data reporting the occurrence of NFT event interactions data reporting the content of NFT transactions, data reporting the content of media wallet interactions, and/or data reporting the occurrence of media wallet interactions.

While various aspects of NFT platforms, NFTs, media wallets, blockchain configurations, reporting structures, and maintenance systems are discussed above, NFT platforms and different components that may be utilized within NFT platforms in accordance with various embodiments of the invention are discussed further below.

### NFT Platforms

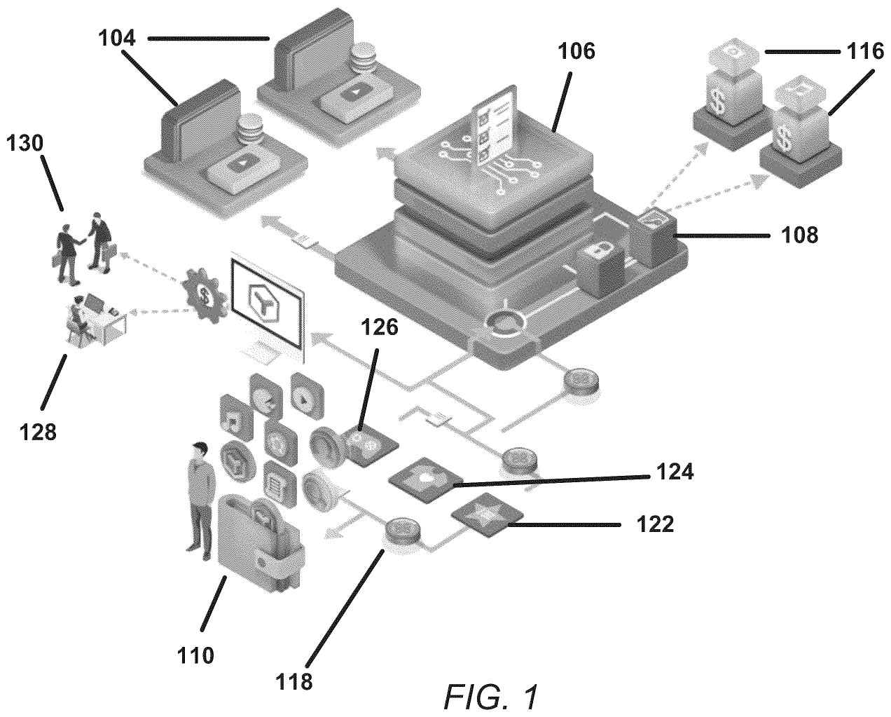

An NFT platform in accordance with an embodiment of the invention is illustrated in FIG. 1. The NFT platform 100 utilizes one or more immutable ledgers (e.g. one or more blockchains) to enable a number of verified content creators 104 to access an NFT registry service to mint NFTs 106 in a variety of forms including (but not limited to) celebrity NFTs 122, character NFTs from games 126, NFTs that are redeemable within games 126, NFTs that contain and/or enable access to collectibles 124, and NFTs that have evolutionary capabilities representative of the change from one NFT state to another NFT state.

Some parts of the disclosure may include reference to smart contracts. For the purposes of the present disclosure, smart contracts may be read to include one or more of: single and/or monolithic smart contracts, constellations of interacting smart contracts, proxy smart contracts calling one or more implementation smart contracts, smart contracts utilizing library smart contracts, and/or other decompositions of smart contract systems into multiple smart contracts that may interact.

Issuance of NFTs 106 via the NFT platform 100 enables verification of the authenticity of NFTs independently of the content creator 104 by confirming that transactions written to one or more of the immutable ledgers are consistent with the smart contracts 108 underlying the NFTs.

As is discussed further below, content creators 104 may provide the NFTs 106 to users to reward and/or incentivize engagement with particular pieces of content and/or other user behavior including (but not limited to) the sharing of user personal information (e.g., contact information or user ID information on particular services), demographic information, and/or media consumption data with the content creator and/or other entities. In addition, the smart contracts 108 underlying the NFTs may cause payments of residual royalties 116 when users engage in specific transactions involving NFTs (e.g., transfer of ownership of the NFT).

In a number of embodiments, users utilize media wallet applications 110 on their devices to store NFTs 106 distributed using the NFT platform 100. Users may use media wallet applications 110 to obtain and/or transfer NFTs 106. In facilitating the retention or transfer of NFTs 106, media wallet applications may utilize wallet user interfaces that engage in transactional restrictions through either uniform or personalized settings. Media wallet applications 110 in accordance with some embodiments may incorporate NFT filtering systems to avoid unrequested NFT assignment. Methods for increased wallet privacy may also operate through multiple associated wallets with varying capabilities. As may readily be appreciated, NFTs 106 that are implemented using smart contracts 108 having interfaces that comply with open standards are not limited to being stored within media wallets and may be stored in any of a variety of wallet applications as appropriate to the requirements of a given application. Furthermore, a number of embodiments of the invention support movement of NFTs 106 between different immutable ledgers. Processes for moving NFTs between multiple immutable ledgers in accordance with various embodiments of the invention are discussed further below.

In several embodiments, content creators 104 may incentivize users to grant access to media consumption data using offers including (but not limited to) offers of fungible tokens 118 and/or NFTs 106. In this way, the ability of the content creators to mint NFTs enables consumers to engage directly with the content creators and may be utilized to incentivize users to share with content creators' data concerning user interactions with additional content. The permissions granted by individual users may enable the content creators 104 to directly access data written to an immutable ledger. In many embodiments, the permissions granted by individual users enable authorized computing systems to access data within an immutable ledger and content creators 104 may query the authorized computing systems to obtain aggregated information. Numerous other example functions for content creators 104 are possible, some of which are discussed below.

NFT blockchains in accordance with various embodiments of the invention enable issuance of NFTs by verified users. In many embodiments, the verified users may be content creators that are vetted by an administrator of networks that may be responsible for deploying and maintaining the NFT blockchain. Once the NFTs are minted, users may obtain and conduct transactions with the NFTs. In several embodiments, the NFTs may be redeemable for items or services in the real world such as (but not limited to) admission to movie screenings, concerts, and/or merchandise.

As illustrated in FIG. 1, users may install the media wallet application 110 onto their devices and use the media wallet application 110 to purchase fungible tokens. The media wallet application could also be provided by a browser, or by a dedicated hardware unit executing instructions provided by a wallet manufacturer. The different types of wallets may have slightly different security profiles and may offer different features, but would all be able to be used to initiate the change of ownership of tokens, such as NFTs. In many embodiments, the fungible tokens may be fully converted into fiat currency and/or other cryptocurrency. In several embodiments, the fungible tokens are implemented using split blockchain models in which the fungible tokens may be issued to multiple blockchains (e.g., Ethereum). As may readily be appreciated, the fungible tokens and/or NFTs utilized within an NFT platform in accordance with various embodiments of the invention are largely dependent upon the requirements of a given application.

In several embodiments, the media wallet application is capable of accessing multiple blockchains by deriving accounts from each of the various immutable ledgers used within an NFT platform. For each of these blockchains, the media wallet application may automatically provide simplified views whereby fungible tokens and NFTs across multiple accounts and/or multiple blockchains may be rendered as single user profiles and/or wallets. In many embodiments, the single view may be achieved using deep-indexing of the relevant blockchains and API services that may rapidly provide information to media wallet applications in response to user interactions. In certain embodiments, the accounts across the multiple blockchains may be derived using BIP32 deterministic wallet key. In other embodiments, any of a variety of techniques may be utilized by the media wallet application to access one or more immutable ledgers as appropriate to the requirements of a given application.

NFTs may be purchased by way of exchanges 130 and/or from other users 128. In addition, content creators may directly issue NFTs to the media wallets of specific users (e.g., by way of push download or AirDrop). In many embodiments, the NFTs are digital collectibles such as celebrity NFTs 122, character NFTs from games 126, NFTs that are redeemable within games 126, and/or NFTs that contain and/or enable access to collectibles 124. It should be appreciated that a variety of NFTs are described throughout the discussion of the various embodiments described herein and may be utilized in any NFT platform and/or with any media wallet application.

While the NFTs are shown as static in the illustrated embodiment, content creators may utilize users' ownership of NFTs to engage in additional interactions with the user. In this way, the relationship between users and particular pieces of content and/or particular content creators may evolve over time around interactions driven by NFTs. In a number of embodiments, collection of NFTs may be gamified to enable unlocking of additional NFTs. In addition, leaderboards may be established with respect to particular content and/or franchises based upon users' aggregation of NFTs. As is discussed further below, NFTs and/or fungible tokens may also be utilized by content creators to incentivize users to share data.

NFTs minted in accordance with several embodiments of the invention may incorporate a series of instances of digital content elements in order to represent the evolution of the digital content over time. Each one of these digital elements may have multiple numbered copies, just like a lithograph, and each such version may have a serial number associated with it, and/or digital signatures authenticating its validity. The digital signature may associate the corresponding image to an identity, such as the identity of the artist. The evolution of digital content may correspond to the transition from one representation to another representation. This evolution may be triggered by the artist, by an event associated with the owner of the artwork, by an external event measured by platforms associated with the content, and/or by specific combinations or sequences of event triggers. Some such NFTs may also have corresponding series of physical embodiments. These may be physical and numbered images that are identical to the digital instances described above. They may also be physical representations of another type, e.g., clay figures or statues, whereas the digital representations may be drawings. The physical embodiments may further be of different aspects that relate to the digital series. Evolution in compliance with some embodiments may also be used to spawn additional content, for example, one NFT directly creating one or more secondary NFTs.

When the user wishes to purchase an NFT using fungible tokens, media wallet applications may request authentication of the NFT directly based upon the public key of the content creator and/or indirectly based upon transaction records within the NFT blockchain. As discussed above, minted NFTs may be signed by content creators and administrators of the NFT blockchain. In addition, users may verify the authenticity of particular NFTs without the assistance of entities that minted the NFT by verifying that the transaction records involving the NFT within the NFT blockchain are consistent with the various royalty payment transactions required to occur in conjunction with transfer of ownership of the NFT by the smart contract underlying the NFT.

Applications and methods in accordance with various embodiments of the invention are not limited to media wallet applications or use within NFT platforms. Accordingly, it should be appreciated that the data collection capabilities of any media wallet application described herein may also be implemented outside the context of an NFT platform and/or in a dedicated application and/or in an application unrelated to the storage of fungible tokens and/or NFTs. Various systems and methods for implementing NFT platforms and media wallet applications in accordance with various embodiments of the invention are discussed further below.

### NFT Platform Network Architectures

NFT platforms in accordance with many embodiments of the invention utilize public blockchains and permissioned blockchains. In several embodiments, the public blockchain is decentralized and universally accessible. Additionally, in a number of embodiments, private/permissioned blockchains are closed systems that are limited to publicly inaccessible transactions. In many embodiments, the permissioned blockchain may be in the form of distributed ledgers, while the blockchain may alternatively be centralized in a single entity.

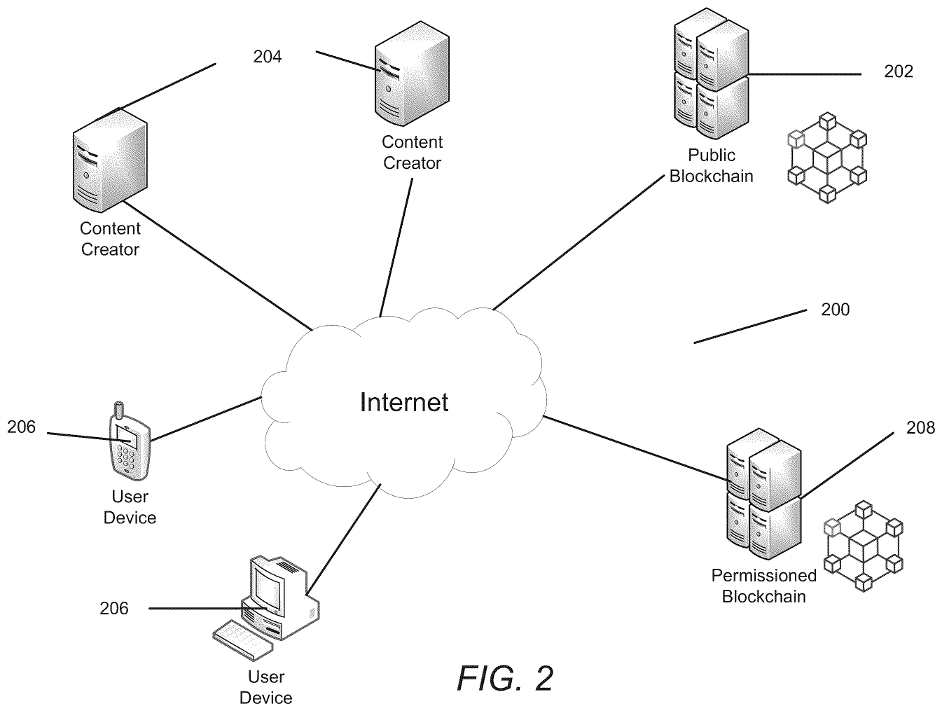

An example of network architecture that may be utilized to implement an NFT platform including a public blockchain and a permissioned blockchain in accordance with several embodiments of the invention is illustrated in FIG. 2. The NFT platform 200 utilizes computer systems implementing a public blockchain 202 such as (but not limited to) Ethereum and Solana. A benefit of supporting interactions with public blockchains 202 is that the NFT platform 200 may support minting of standards based NFTs that may be utilized in an interchangeable manner with NFTs minted by sources outside of the NFT platform on the public blockchain. In this way, the NFT platform 200 and the NFTs minted within the NFT platform are not part of a walled garden, but are instead part of a broader blockchain-based ecosystem. The ability of holders of NFTs minted within the NFT platform 200 to transact via the public blockchain 202 increases the likelihood that individuals acquiring NFTs will become users of the NFT platform. Initial NFTs minted outside the NFT platform may also be developed through later minted NFTs, with the initial NFTs being used to further identify and interact with the user based upon their ownership of both NFTs. Various systems and methods for facilitating the relationships between NFTs, both outside and within the NFT platform are discussed further below.

Users may utilize user devices configured with appropriate applications including (but not limited to) media wallet applications to obtain NFTs. In many embodiments, media wallets are smart device enabled, front-end applications for fans and/or consumers, central to all user activity on an NFT platform. As is discussed in detail below, different embodiments of media wallet applications may provide any of a variety of functionality that may be determined as appropriate to the requirements of a given application. In the illustrated embodiment, the user devices 206 are shown as mobile phones and personal computers. As may readily be appreciated user devices may be implemented using any class of consumer electronics device including (but not limited to) tablet computers, laptop computers, televisions, game consoles, virtual reality headsets, mixed reality headsets, augmented reality headsets, media extenders, and/or set top boxes as appropriate to the requirements of a given application.

In many embodiments, NFT transaction data entries in the permissioned blockchain 208 are encrypted using users' public keys so that the NFT transaction data may be accessed by the media wallet application. In this way, users control access to entries in the permissioned blockchain 208 describing the user's NFT transaction. In several embodiments, users may authorize content creators 204 to access NFT transaction data recorded within the permissioned blockchain 208 using one of a number of appropriate mechanisms including (but not limited to) compound identities where the user is the owner of the data, and the user may authorize other entities as guests that may also access the data. As may readily be appreciated, particular content creators' access to the data may be revoked by revoking their status as guests within the compound entity authorized to access the NFT transaction data within the permissioned blockchain 208. In certain embodiments, compound identities are implemented by writing authorized access records to the permissioned blockchain using the user's public key and the public keys of the other members of the compound entity.

When content creators wish to access particular pieces of data stored within the permissioned blockchain 208, they may make a request to a data access service. The data access service may grant access to data stored using the permissioned blockchain 208 when the content creators' public keys correspond to public keys of guests. In a number of embodiments, guests may be defined within a compound identity. The access record for the compound entity may also authorize the compound entity to access the particular piece of data. In this way, the user has complete control over access to their data at any time by admitting or revoking content creators to a compound entity, and/or modifying the access policies defined within the permissioned blockchain 208 for the compound entity. In several embodiments, the permissioned blockchain 208 supports access control lists and users may utilize a media wallet application to modify permissions granted by way of the access control list. In many embodiments, the manner in which access permissions are defined enables different restrictions to be placed on particular pieces of information within a particular NFT transaction data record within the permissioned blockchain 208. As may readily be appreciated, the manner in which NFT platforms and/or immutable ledgers provide fine-grained data access permissions largely depends upon the requirements of a given application.

In many embodiments, storage nodes within the permissioned blockchain 208 do not provide content creators with access to entire NFT transaction histories. Instead, the storage nodes simply provide access to encrypted records. In several embodiments, the hash of the collection of records from the permissioned blockchain is broadcast. Therefore, the record is verifiably immutable, and each result includes the hash of the record and the previous/next hashes. As noted above, the use of compound identities and/or access control lists may enable users to grant permission to decrypt certain pieces of information or individual records within the permissioned blockchain. In several embodiments, the access to the data is determined by computer systems that implement permission-based data access services.

In many embodiments, the permissioned blockchain 208 may be implemented using any blockchain technology appropriate to the requirements of a given application. As noted above, the information and processes described herein are not limited to data written to permissioned blockchains 208, and NFT transaction data simply provides an example. Systems and methods in accordance with various embodiments of the invention may be utilized to enable applications to provide fine-grained permission to any of a variety of different types of data stored in an immutable ledger as appropriate to the requirements of a given application in accordance with various embodiments of the invention.

While various implementations of NFT platforms are described above with reference to FIG. 2, NFT platforms may be implemented using any number of immutable and pseudo-immutable ledgers as appropriate to the requirements of specific applications in accordance with various embodiments of the invention. Blockchain databases in accordance with various embodiments of the invention may be managed autonomously using peer-to-peer networks and distributed timestamping servers. In some embodiments, any of a variety of consensus mechanisms may be used by public blockchains, including but not limited to Proof of Space mechanisms, Proof of Work mechanisms, Proof of Stake mechanisms, and hybrid mechanisms.

NFT platforms in accordance with many embodiments of the invention may benefit from the oversight and increased security of private blockchains. As may readily be appreciated, a variety of approaches may be taken to the writing of data to permissioned blockchains, and the particular approach is largely determined by the requirements of particular applications. As such, computer systems in accordance with various embodiments of the invention may have the capacity to create verified NFT entries written to permissioned blockchains.

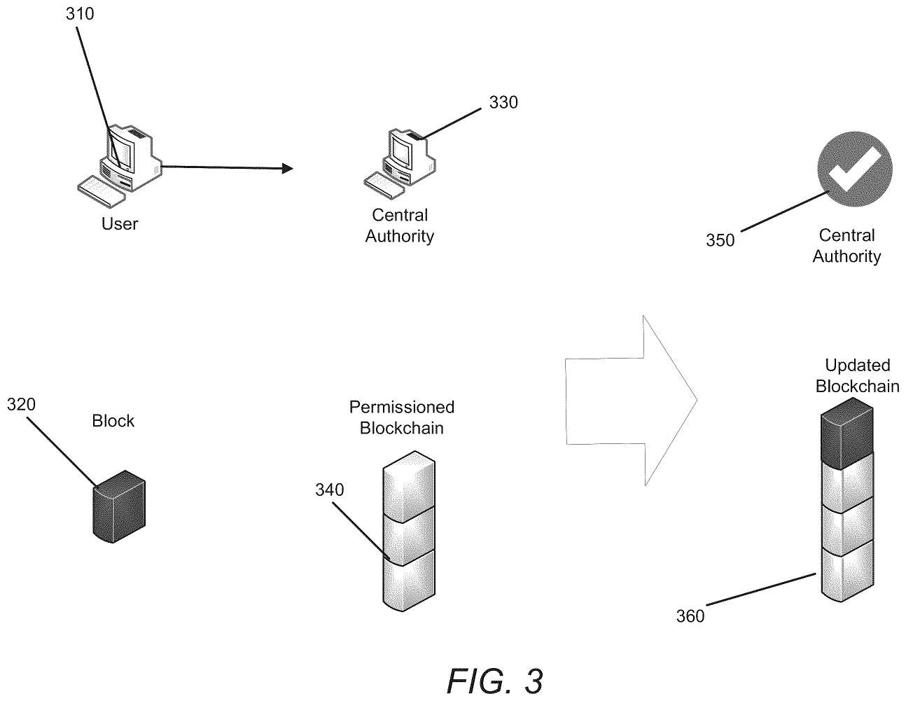

An implementation of permissioned (or private) blockchains in accordance with some embodiments of the invention is illustrated in FIG. 3. Permissioned blockchains 340 may typically function as closed computing systems in which each participant is well defined. In several embodiments, private blockchain networks may require invitations. In a number of embodiments, entries, or blocks 320, to private blockchains may be validated. In some embodiments, the validation may come from central authorities 330. Private blockchains may allow an organization or a consortium of organizations to efficiently exchange information and record transactions. Specifically, in a permissioned blockchain, a preapproved central authority 330 (which should be understood as potentially encompassing multiple distinct authorized authorities) may approve a change to the blockchain. In a number of embodiments, approval may come without the use of a consensus mechanism involving multiple authorities. As such, through a direct request from users 310 to the central authority 330, the determination of whether blocks 320 may be allowed access to the permissioned blockchain 340 may be determined. Blocks 320 needing to be added, eliminated, relocated, and/or prevented from access may be controlled through these means. In doing so the central authority 330 may manage accessing and controlling the network blocks incorporated into the permissioned blockchain 340. Upon the approval 350 of the central authority, the now updated blockchain 360 may reflect the added block 320.

NFT platforms in accordance with many embodiments of the invention may also benefit from the anonymity and accessibility of a public blockchain. Therefore, NFT platforms in accordance with many embodiments of the invention may have the capacity to create verified NFT entries written to a permissioned blockchain.

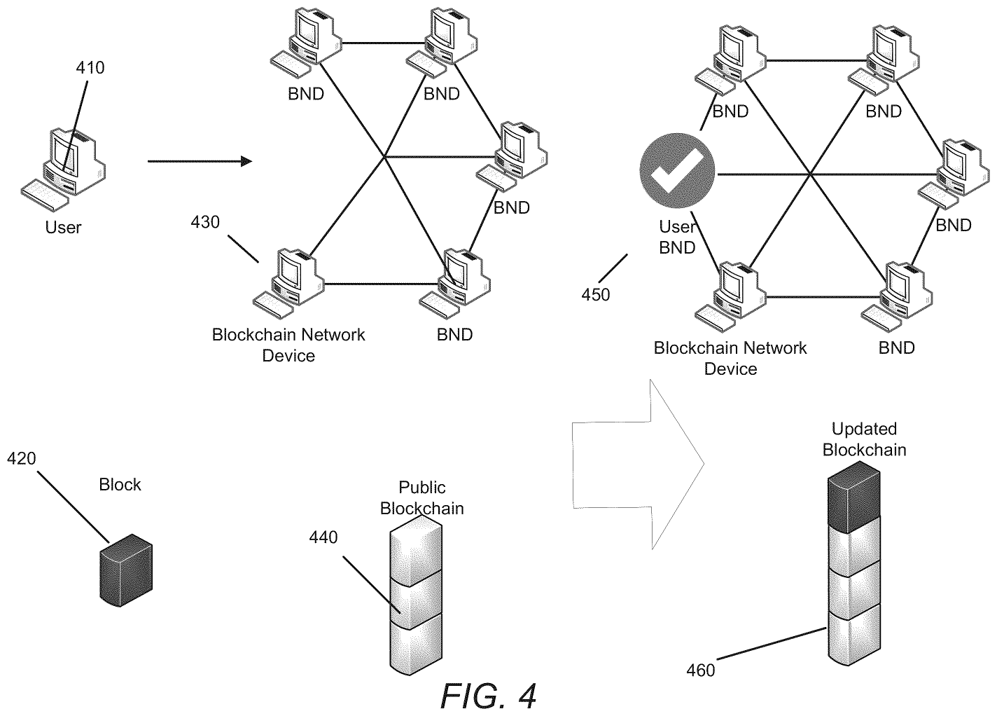

An implementation of a permissionless, decentralized, or public blockchain in accordance with an embodiment of the invention is illustrated in FIG. 4. In a permissionless blockchain, individual users 410 may directly participate in relevant networks and operate as blockchain network devices 430. As blockchain network devices 430, parties would have the capacity to participate in changes to the blockchain and participate in transaction verifications (via the mining mechanism). Transactions are broadcast over the computer network and data quality is maintained by massive database replication and computational trust. Despite being decentralized, an updated blockchain 460 cannot remove entries, even if anonymously made, making it immutable. In many decentralized blockchains, many blockchain network devices 430, in the decentralized system may have copies of the blockchain, allowing the ability to validate transactions. In many instances, the blockchain network device 430 may personally add transactions, in the form of blocks 420 appended to the public blockchain 440. To do so, the blockchain network device 430 would take steps to allow for the transactions to be validated 450 through various consensus mechanisms (Proof of Work, Proof of Stake, etc.). A number of consensus mechanisms in accordance with various embodiments of the invention are discussed further below.

Additionally, in the context of blockchain configurations, the term smart contract is often used to refer to software programs that run on blockchains. While a standard legal contract outlines the terms of a relationship (usually one enforceable by law), a smart contract enforces a set of rules using self-executing code within NFT platforms. As such, smart contracts may have the means to automatically enforce specific programmatic rules through platforms. Smart contracts are often developed as high-level programming abstractions that may be compiled down to bytecode. Said bytecode may be deployed to blockchains for execution by computer systems using any number of mechanisms deployed in conjunction with the blockchain. In many instances, smart contracts execute by leveraging the code of other smart contracts in a manner similar to calling upon a software library.

A number of existing decentralized blockchain technologies intentionally exclude or prevent rich media assets from existing within the blockchain, because they would need to address content that is not static (e.g., images, videos, music files). Therefore, NFT platforms in accordance with many embodiments of the invention may address this with blockchain mechanisms, that preclude general changes but account for updated content.

NFT platforms in accordance with many embodiments of the invention may therefore incorporate decentralized storage pseudo-immutable dual blockchains. In some embodiments, two or more blockchains may be interconnected such that traditional blockchain consensus algorithms support a first blockchain serving as an index to a second, or more, blockchains serving to contain and protect resources, such as the rich media content associated with NFTs.

In storing rich media using blockchain, several components may be utilized by an entity (“miner”) adding transactions to said blockchain. References, such as URLs, may be stored in the blockchain to identify assets. Multiple URLs may also be stored when the asset is separated into pieces. An alternative or complementary option may be the use of APIs to return either the asset or a URL for the asset. In accordance with many embodiments of the invention, references may be stored by adding a ledger entry incorporating the reference enabling the entry to be timestamped. In doing so, the URL, which typically accounts for domain names, may be resolved to IP addresses. However, when only files of certain types are located on particular resources, or where small portions of individual assets are stored at different locations, users may require methods to locate assets stored on highly-splintered decentralized storage systems. To do so, systems may identify at least primary asset destinations and update those primary asset destinations as necessary when storage resources change. The mechanisms used to identify primary asset destinations may take a variety of forms including, but not limited to, smart contracts.

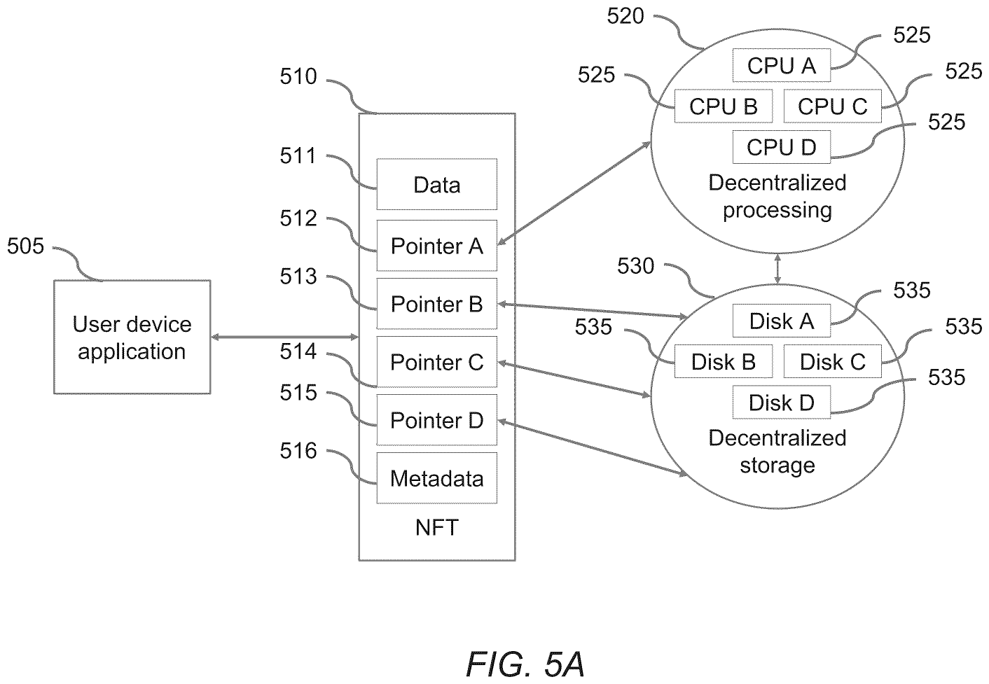

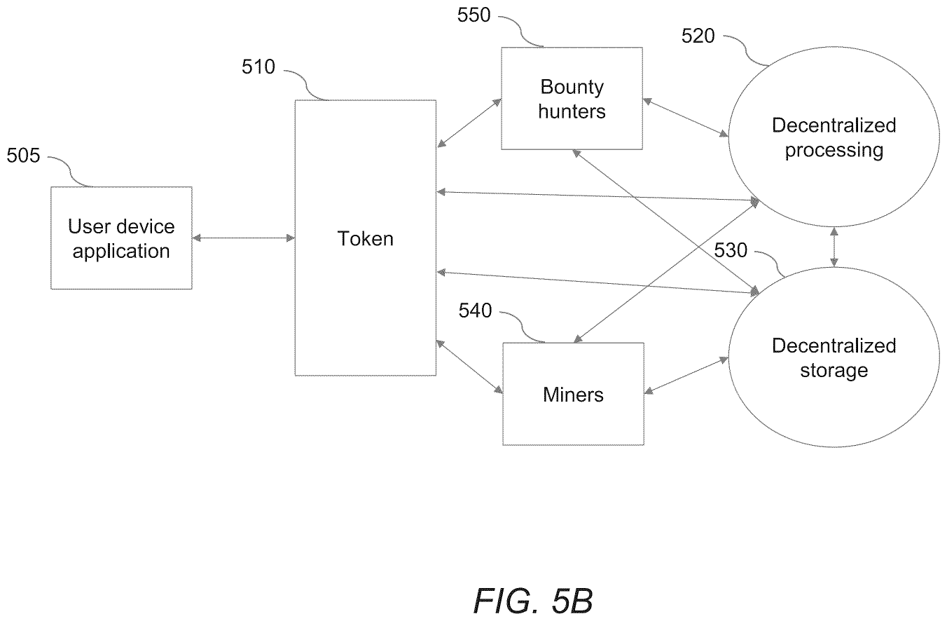

A dual blockchain, including decentralized processing 520 and decentralized storage 530 blockchains, in accordance with some embodiments of the invention is illustrated in FIG. 5A. Application running on devices 505, may interact with or make a request related to NFTs 510 interacting with such a blockchain. An NFT 510 in accordance with several embodiments of the invention may include many values including generalized data 511 (e.g., URLs), and pointers such as pointer A 512, pointer B 513, pointer C 514, and pointer D 515. In accordance with many embodiments of the invention, the generalized data 511 may be used to access corresponding rich media through the NFT 510. The NFT 510 may additionally have associated metadata 516.

Pointers within the NFT 510 may direct an inquiry toward a variety of on or off-ledger resources. In some embodiments of the invention, as illustrated FIG. 5A, pointer A 512 may direct the need for processing to the decentralized processing network 520. Processing systems are illustrated as CPU A, CPU B, CPU C, and CPU D 525. The CPUs 525 may be personal computers, server computers, mobile devices, edge IoT devices, etc. Pointer A may select one or more processors at random to perform the execution of a given smart contract. The code may be secure or nonsecure and the CPU may be a trusted execution environment (TEE), depending upon the needs of the request. In the example reflected in FIG. 5A, pointer B 513, pointer C 514, and pointer D 515 all point to a decentralized storage network 530 including remote off-ledger resources including storage systems illustrated as Disks A, B, C, and D 535.

The decentralized storage system may co-mingle with the decentralized processing system as the individual storage systems utilize CPU resources and connectivity to perform their function. From a functional perspective, the two decentralized systems may also be separate. Pointer B 513 may point to one or more decentralized storage networks 530 for the purposes of maintaining an off-chain log file of token activity and requests. Pointer C 514 may point to executable code within one or more decentralized storage networks 530. And Pointer D 515 may point to rights management data, security keys, and/or configuration data within one or more decentralized storage networks 530.

Dual blockchains may additionally incorporate methods for detection of abuse, essentially operating as a “bounty hunter” 550. FIG. 5B illustrates the inclusion of bounty hunters 550 within dual blockchain structures implemented in accordance with an embodiment of the invention. Bounty hunters 550 allow NFTs 510, which may point to networks that may include decentralized processing 520 and/or storage networks 530, to be monitored. The bounty hunter's 550 objective may be to locate incorrectly listed or missing data and executable code within the NFT 510 or associated networks. Additionally, the miner 540 may have the capacity to perform all necessary minting processes or any process within the architecture that involves a consensus mechanism.

Bounty hunters 550 may also choose to verify each step of a computation, and if they find an error, submit evidence of this in return for some reward. This may have the effect of invalidating the incorrect ledger entry and potentially based on policies, all subsequent ledger entries. Such evidence may be submitted in a manner that is associated with a public key, in which the bounty hunter 550 proves knowledge of the error, thereby assigning value (namely the bounty) with the public key.

Assertions made by bounty hunters 550 may be provided directly to miners 540 by broadcasting the assertion. Assertions may be broadcast in a manner including, but not limited to posting it to a bulletin board. In some embodiments of the invention, assertions may be posted to ledgers of blockchains, for instance, the blockchain on which the miners 540 operate. If the evidence in question has not been submitted before, this may automatically invalidate the ledger entry that is proven wrong and provide the bounty hunter 550 with some benefit.

Applications and methods in accordance with various embodiments of the invention are not limited to use within NFT platforms. Accordingly, it should be appreciated that the capabilities of any blockchain configuration described herein may also be implemented outside the context of an NFT platform network architecture unrelated to the storage of fungible tokens and/or NFTs. A variety of components, mechanisms, and blockchain configurations that may be utilized within NFT platforms are discussed further below. Moreover, any of the blockchain configurations described herein with reference to FIGS. 3-5B (including permissioned, permissionless, and/or hybrid mechanisms) may be utilized within any of the networks implemented within the NFT platforms described above.

### NFT Platform Consensus Mechanisms

NFT platforms in accordance with many embodiments of the invention may depend on consensus mechanisms to achieve agreement on network state, through proof resolution, to validate transactions. In accordance with many embodiments of the invention, Proof of Work (PoW) mechanisms may be used as a means of demonstrating non-trivial allocations of processing power. Proof of Space (PoS) mechanisms may be used as a means of demonstrating non-trivial allocations of memory or disk space. As a third possible approach, Proof of Stake mechanisms may be used as a means of demonstrating non-trivial allocations of fungible tokens and/or NFTs as a form of collateral. Numerous consensus mechanisms are possible in accordance with various embodiments of the invention, some of which are expounded on below.

Traditional mining schemes, such as Bitcoin, are based on Proof of Work, based on performing the aforementioned large computational tasks. The cost of such tasks may not only be computational effort, but also energy expenditure, a significant environmental concern. To address this problem, mining methods operating in accordance with many embodiments of the invention may instead operate using Proof of Space mechanisms to accomplish network consensus, wherein the distinguishing factor may be memory rather than processing power. Specifically, Proof of Space mechanisms may perform this through network optimization challenges. In several embodiments the network optimization challenge may be selected from any of a number of different challenges appropriate to the requirements of specific applications including graph pebbling. In some embodiments, graph pebbling may refer to a resource allocation game played on discrete mathematics graphs, ending with a labeled graph disclosing how a player might get at least one pebble to every vertex of the graph.

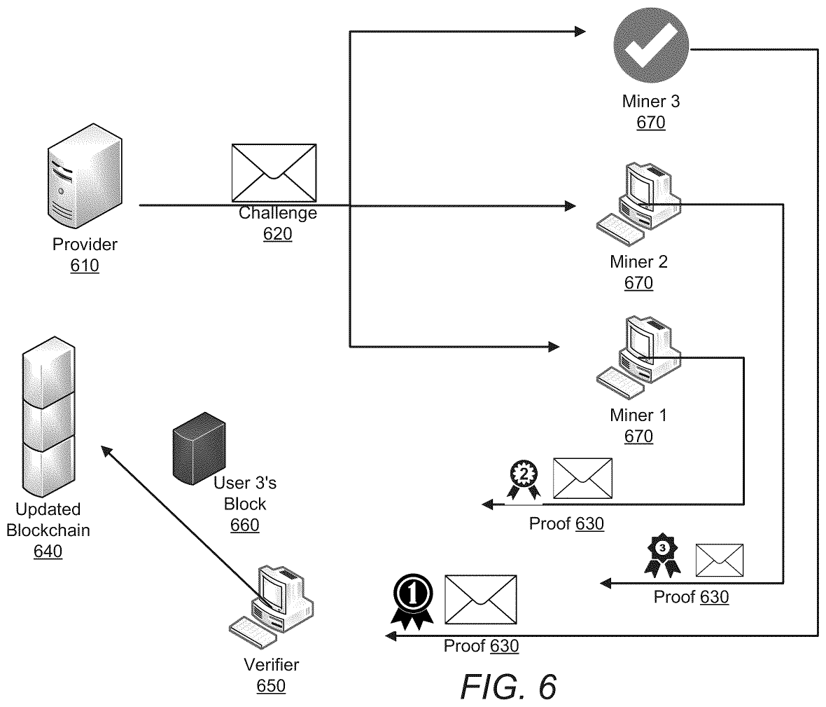

An example of Proof of Work consensus mechanisms that may be implemented in decentralized blockchains, in accordance with a number of embodiments of the invention, is conceptually illustrated in FIG. 6. The example disclosed in this figure is a challenge-response authentication, a protocol classification in which one party presents a complex problem (“challenge”) 610 and another party must broadcast a valid answer (“proof”) 620 to have clearance to add a block to the decentralized ledger that makes up the blockchain 630. As a number of miners may be competing to have this ability, there may be a need for determining factors for the addition to be added first, which in this case is processing power. Once an output is produced, verifiers 640 in the network may verify the proof, something which typically requires much less processing power, to determine the first device that would have the right to add the winning block 650 to the blockchain 630. As such, under a Proof of Work consensus mechanism, each miner involved may have a success probability proportional to the computational effort expended.

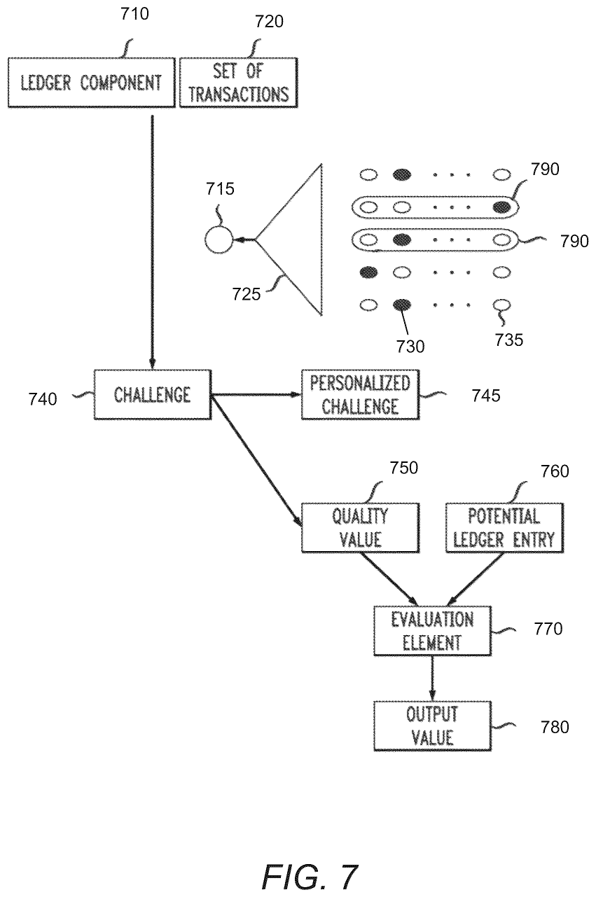

An example of Proof of Space implementations on devices in accordance with some embodiments of the invention is conceptually illustrated in FIG. 7. The implementation includes a ledger component 710, a set of transactions 720, and a challenge 740 computed from a portion of the ledger component 710. A representation 715 of a miner's state may also be recorded in the ledger component 710 and be publicly available.

In some embodiments, the material stored on the memory of the device includes a collection of nodes 730, 735, where nodes that depend on other nodes have values that are functions of the values of the associated nodes on which they depend. For example, functions may be one-way functions, such as cryptographic hash functions. In several embodiments the cryptographic hash function may be selected from any of a number of different cryptographic hash functions appropriate to the requirements of specific applications including (but not limited to) the SHA1 cryptographic hash function. In such an example, one node in the network may be a function of three other nodes. Moreover, the node may be computed by concatenating the values associated with these three nodes and applying the cryptographic hash function, assigning the result of the computation to the node depending on these three parent nodes. In this example, the nodes are arranged in rows, where two rows 790 are shown. The nodes are stored by the miner, and may be used to compute values at a setup time. This may be done using Merkle tree hash-based data structures 725, or another structure such as a compression function and/or a hash function.

Challenges 740 may be processed by the miner to obtain personalized challenges 745, made to the device according to the miner's storage capacity. The personalized challenge 745 may be the same or have a negligible change, but could also undergo an adjustment to account for the storage space accessible by the miner, as represented by the nodes the miner stores. For example, when the miner does not have a large amount of storage available or designated for use with the Proof of Space system, a personalized challenge 745 may adjust challenges 740 to take this into consideration, thereby making a personalized challenge 745 suitable for the miner's memory configuration.

In some embodiments, the personalized challenge 745 may indicate a selection of nodes 730, denoted in FIG. 7 by filled-in circles. In the FIG. 7 example specifically, the personalized challenge corresponds to one node per row. The collection of nodes selected as a result of computing the personalized challenge 745 may correspond to a valid potential ledger entry 760. However, here a quality value 750 (also referred to herein as a qualifying function value) may also be computed from the challenge 740, or from other public information that is preferably not under the control of any one miner.

A miner may perform matching evaluations 770 to determine whether the set of selected nodes 730 matches the quality value 750. This process may take into consideration what the memory constraints of the miner are, causing the evaluation 770 to succeed with a greater frequency for larger memory configurations than for smaller memory configurations. This may simultaneously level the playing field to make the likelihood of the evaluation 770 succeeding roughly proportional to the size of the memory used to store the nodes used by the miner. In some embodiments, non-proportional relationships may be created by modifying the function used to compute the quality value 750. When the evaluation 770 results in success, then the output value 780 may be used to confirm the suitability of the memory configuration and validate the corresponding transaction.

In many embodiments, nodes 730 and 735 may also correspond to public keys. The miner may submit valid ledger entries, corresponding to a challenge-response pair including one of these nodes. In that case, public key values may become associated with the obtained NFT. As such, miners may use a corresponding secret/private key to sign transaction requests, such as purchases. Additionally, any type of digital signature may be used in this context, such as RSA signatures, Merkle signatures, DSS signatures, etc. Further, the nodes 730 and 735 may correspond to different public keys or to the same public key, the latter preferably augmented with a counter and/or other location indicator such as a matrix position indicator, as described above. Location indicators in accordance with many embodiments of the invention may be applied to point to locations within a given ledger. In accordance with some embodiments of the invention, numerous Proof of Space consensus configurations are possible, some of which are discussed below.

Hybrid methods of evaluating Proof of Space problems may also be implemented in accordance with many embodiments of the invention. In many embodiments, hybrid methods may be utilized that conceptually correspond to modifications of Proof of Space protocols in which extra effort is expanded to increase the probability of success, or to compress the amount of space that may be applied to the challenge. Both come at a cost of computational effort, thereby allowing miners to improve their odds of winning by spending greater computational effort. Accordingly, in many embodiments of the invention dual proof-based systems may be used to reduce said computational effort. Such systems may be applied to Proof of Work and Proof of Space schemes, as well as to any other type of mining-based scheme.

When utilizing dual proofs in accordance with various embodiments of the invention, the constituent proofs may have varying structures. For example, one may be based on Proof of Work, another on Proof of Space, and a third may be a system that relies on a trusted organization for controlling the operation, as opposed to relying on mining for the closing of ledgers. Yet other proof structures may be combined in this way. The result of the combination will inherit properties of its components. In many embodiments, the hybrid mechanism may incorporate a first and a second consensus mechanism. In several embodiments, the hybrid mechanism includes a first, a second, and a third consensus mechanisms. In a number of embodiments, the hybrid mechanism includes more than three consensus mechanisms. Any of these embodiments may utilize consensus mechanisms selected from the group including (but not limited to) Proof of Work, Proof of Space, and Proof of Stake without departing from the scope of the invention. Depending on how each component system is parametrized, different aspects of the inherited properties will dominate over other aspects.

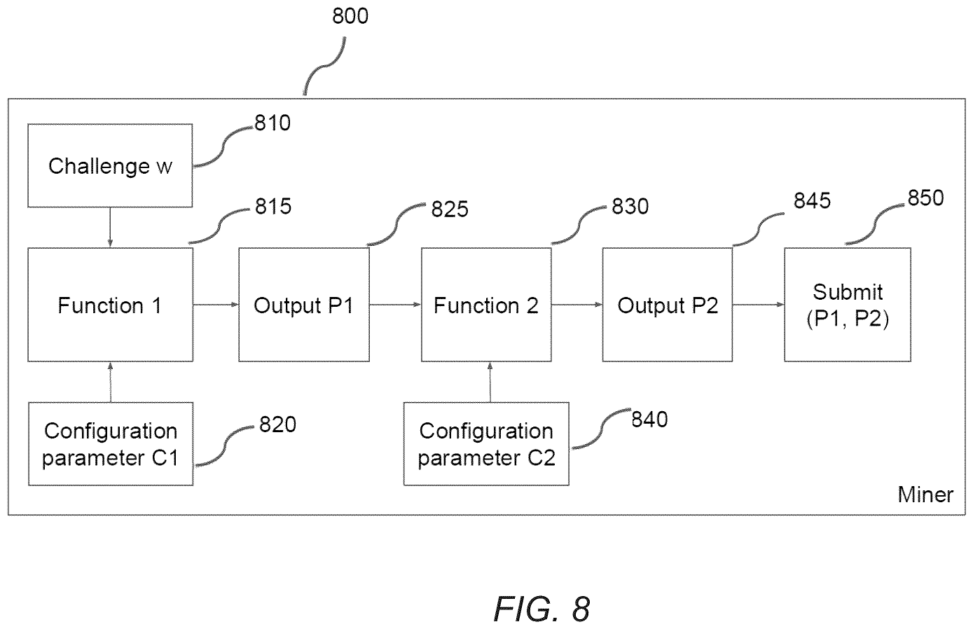

Dual proof configurations in accordance with a number of embodiments of the invention is illustrated in FIG. 8. A proof configuration in accordance with some embodiments of the invention may tend to use the notion of quality functions for tie-breaking among multiple competing correct proofs relative to a given challenge (w) 810. This classification of proof may be described as a qualitative proof, inclusive of proofs of work and proofs of space. In the example reflected in FIG. 8, proofs P1 and P2 are each one of a Proof of Work, Proof of Space, Proof of Stake, and/or any other proof related to a constrained resource, wherein P2 may be of a different type than P1, or may be of the same type.

Systems in accordance with many embodiments of the invention may introduce the notion of a qualifying proof, which, unlike qualitative proofs, are either valid or not valid, using no tie-breaking mechanism. Said systems may include a combination of one or more qualitative proofs and one or more qualifying proofs. For example, it may use one qualitative proof that is combined with one qualifying proof, where the qualifying proof is performed conditional on the successful creation of a qualitative proof. FIG. 8 illustrates challenge w 810, as described above, with a function 1 815, which is a qualitative function, and function 2 830, which is a qualifying function.

To stop miners from expending effort after a certain amount of effort has been spent, thereby reducing the environmental impact of mining, systems in accordance with a number of embodiments of the invention may constrain the search space for the mining effort. This may be done using a configuration parameter that controls the range of random or pseudo-random numbers that may be used in a proof. Upon challenge w 810 being issued to one or more miners 800, it may be input to Function 1 815 along with configuration parameter C1 820. Function 1 815 may output proof P1 825, in this example the qualifying proof to Function 2 830. Function 2 830 is also provided with configuration parameter C2 840 and computes qualifying proof P2 845. The miner 800 may then submit the combination of proofs (P1, P2) 850 to a verifier, in order to validate a ledger associated with challenge w 810. In some embodiments, miner 800 may also submit the proofs (P1, P2) 850 to be accessed by a 3rd-party verifier.

NFT platforms in accordance with many embodiments of the invention may additionally benefit from alternative energy-efficient consensus mechanisms. Therefore, computer systems in accordance with several embodiments of the invention may instead use consensus-based methods alongside or in place of proof-of-space and proof-of-space based mining. In particular, consensus mechanisms based instead on the existence of a Trusted Execution Environment (TEE), such as ARM TrustZone™ or Intel SGX™ may provide assurances exist of integrity by virtue of incorporating private/isolated processing environments.

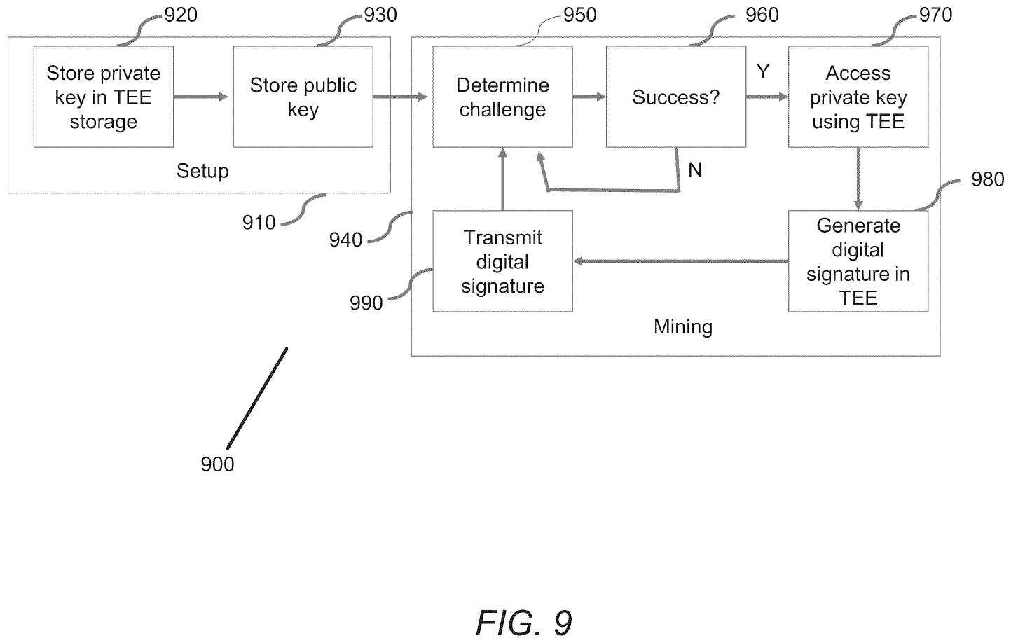

An illustration of sample process 900 undergone by TEE-based consensus mechanisms in accordance with some embodiments of the invention is depicted in FIG. 9. In some such configurations, a setup 910 may be performed by an original equipment manufacturer (OEM) or a party performing configurations of equipment provided by an OEM. Once a private key/public key pair is generated in the secure environment, process 900 may store (920) the private key in TEE storage (i.e., storage associated with the Trusted Execution Environment). While storage may be accessible from the TEE, it may be shielded from applications running outside the TEE. Additionally, processes may store (930) the public key associated with the TEE in any storage associated with the device containing the TEE. Unlike the private key, the public key may also be accessible from applications outside the TEE. In a number of embodiments, the public key may also be certified. Certification may come from OEMs or trusted entities associated with the OEMs, wherein the certificate may be stored with the public key.

In many embodiments of the invention, mining-directed steps may also be influenced by the TEE. In the illustrated embodiment, the process 900 may determine (950) a challenge. For example, this may be by computing a hash of the contents of a ledger. In doing so, process 900 may also determine whether the challenge corresponds to success 960. In some embodiments of the invention, the determination of success may result from some pre-set portion of the challenge matching a pre-set portion of the public key, e.g., the last 20 bits of the two values matching. In several embodiments, the success determination mechanism may be selected from any of a number of alternate approaches appropriate to the requirements of specific applications. The matching conditions may also be modified over time. For example, modification may result from an announcement from a trusted party or based on a determination of a number of participants having reached a threshold value.

When the challenge does not correspond to a success 960, process 900 may return to determine (950) a new challenge. In this context, process 900 may determine (950) a new challenge after the ledger contents have been updated and/or a time-based observation is performed. In several embodiments the determination of a new challenge may come from any of a number of approaches appropriate to the requirements of specific applications, including, but not limited to, the observation of as a second elapsing since the last challenge. If the challenge corresponds to a success 960, then the processing may continue on to access (970) the private key using the TEE.

When the private key is accessed, process may generate (980) a digital signature using the TEE. The digital signature may be on a message that includes the challenge and/or which otherwise references the ledger entry being closed. Process 900 may also transmit (980) the digital signature to other participants implementing the consensus mechanism. In cases where multiple digital signatures are received and found to be valid, a tie-breaking mechanism may be used to evaluate the consensus. For example, one possible tie-breaking mechanism may be to select the winner as the party with the digital signature that represents the smallest numerical value when interpreted as a number. In several embodiments the tie-breaking mechanism may be selected from any of a number of alternate tie-breaking mechanisms appropriate to the requirements of specific applications.

While specific processes for consensus mechanism operations are described above with respect to FIG. 9, any of a variety of processes may be utilized to approve transactions as appropriate to the requirements of specific applications in accordance with various embodiments of the invention. In several embodiments, steps may be executed or performed in any order or sequence not limited to the order and sequence shown and described. In numerous embodiments, some of the above steps may be executed or performed substantially simultaneously where appropriate or in parallel to reduce latency and processing times. In some embodiments, one or more of the above steps may be omitted.

Applications and methods in accordance with various embodiments of the invention are not limited to use within NFT platforms. Accordingly, it should be appreciated that consensus mechanisms described herein may also be implemented outside the context of an NFT platform network architecture unrelated to the storage of fungible tokens and/or NFTs. Moreover, any of the consensus mechanisms described herein with reference to FIGS. 6-9 (including Proof of Work, Proof of Space, Proof of Stake, and/or hybrid mechanisms) may be utilized within any of the blockchains implemented within the NFT platforms described above with reference to FIGS. 3-5B. Various systems and methods for implementing NFT platforms and applications in accordance with numerous embodiments of the invention are discussed further below.

### NFT Platform Constituent Devices and Applications

A variety of computer systems that may be utilized within NFT platforms and systems that utilize NFT blockchains in accordance with various embodiments of the invention are illustrated below. The computer systems in accordance with many embodiments of the invention may implement a processing system 1010, 1120, 1220 using one or more CPUs, GPUs, ASICs, FPGAs, and/or any of a variety of other devices and/or combinations of devices that are typically utilized to perform digital computations. As may readily be appreciated each of these computer systems may be implemented using one or more of any of a variety of classes of computing devices including (but not limited to) mobile phone handsets, tablet computers, laptop computers, personal computers, gaming consoles, televisions, set top boxes and/or other classes of computing device.

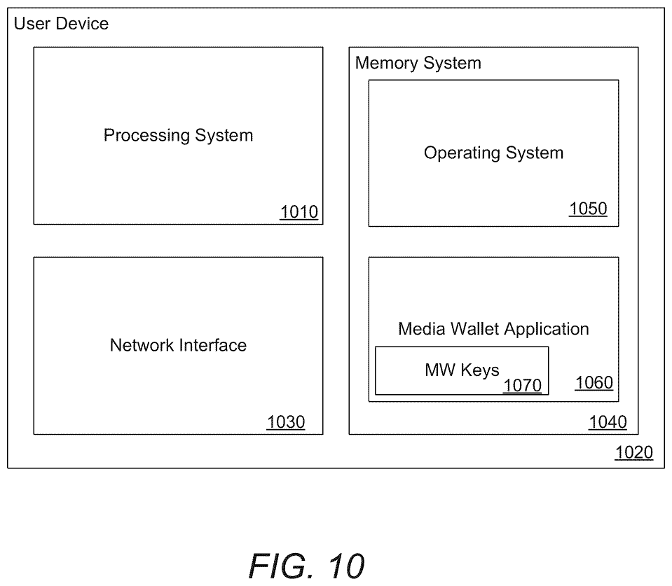

A user device capable of communicating with an NFT platform in accordance with an embodiment of the invention is illustrated in FIG. 10. The memory system 1040 of particular user devices may include an operating system 1050 and media wallet applications 1060. Media wallet applications may include sets of media wallet (MW) keys 1070 that may include public key/private key pairs. The set of MW keys may be used by the media wallet application to perform a variety of actions including, but not limited to, encrypting and signing data. In many embodiments, the media wallet application enables the user device to obtain and conduct transactions with respect to NFTs by communicating with an NFT blockchain via the network interface 1030. In some embodiments, the media wallet applications are capable of enabling the purchase of NFTs using fungible tokens via at least one distributed exchange. User devices may implement some or all of the various functions described above with reference to media wallet applications as appropriate to the requirements of a given application in accordance with various embodiments of the invention. In accordance with many embodiments, user devices may include at least one processor, which may be configured to process input data according to instructions stored in memory. The memory may be a tangible, non-transitory, computer-readable medium configured to store instructions that are executable by the processor. For example, the memory may be data storage that may be loaded with software code that is executable by the processor to achieve certain functions.

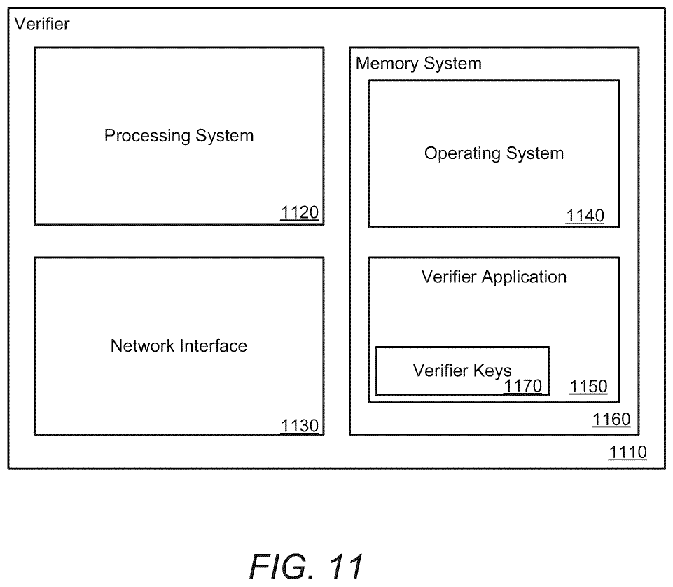

A verifier 1110 capable of verifying blockchain transactions in an NFT platform in accordance with many embodiments of the invention is illustrated in FIG. 11. The memory system 1160 of the verifier computer system includes an operating system 1140 and a verifier application 1150 that enables the verifier 1110 computer system to access a decentralized blockchain in accordance with various embodiments of the invention. Accordingly, the verifier application 1150 may utilize a set of verifier keys 1170 to affirm blockchain entries. When blockchain entries may be verified, the verifier application 1150 may transmit blocks to the corresponding blockchains. The verifier application 1150 may also implement some or all of the various functions described above with reference to verifiers as appropriate to the requirements of a given application in accordance with various embodiments of the invention.

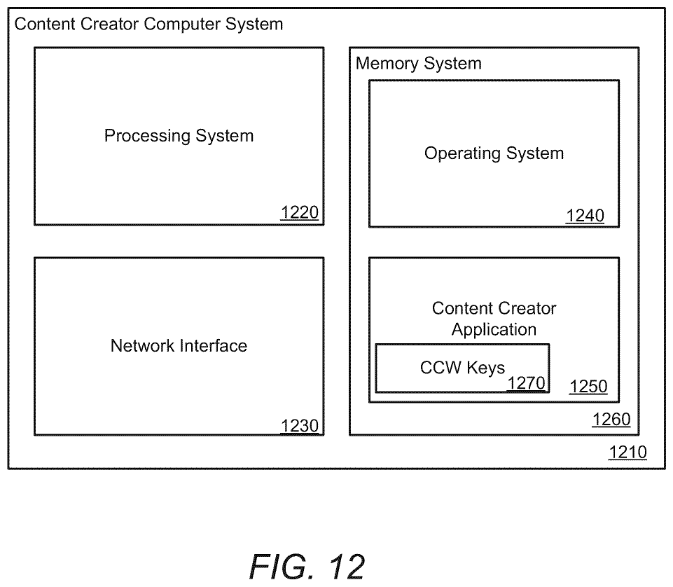

A content creator system 1210 capable of disseminating content in an NFT platform in accordance with an embodiment of the invention is illustrated in FIG. 12. The memory system 1260 of the content creator computer system may include an operating system 1240 and a content creator application 1250. The content creator application 1250 may enable the content creator computer system to mint NFTs by writing smart contracts to blockchains via the network interface 1230. The content creator application may include sets of content creator wallet (CCW) keys 1270 that may include a public key/private key pairs. Content creator applications may use these keys to sign NFTs minted by the content creator application. The content creator application may also implement some or all of the various functions described above with reference to content creators as appropriate to the requirements of a given application in accordance with various embodiments of the invention.

Computer systems in accordance with many embodiments of the invention incorporate digital wallets (herein also referred to as “wallets” or “media wallets”) for NFT and/or fungible token storage. In several embodiments, the digital wallet may securely store rich media NFTs and/or other tokens. Additionally, in some embodiments, the digital wallet may display user interface through which user instructions concerning data access permissions may be received.

In a number of embodiments of the invention, digital wallets may be used to store at least one type of token-directed content. Example content types may include, but are not limited to crypto currencies of one or more sorts; non-fungible tokens; and user profile data.

Example user profile data may incorporate logs of user actions. In accordance with some embodiments of the invention, example anonymized user profile data may include redacted, encrypted, and/or otherwise obfuscated user data. User profile data in accordance with some embodiments may include, but are not limited to, information related to classifications of interests, determinations of a post-advertisement purchases, and/or characterizations of wallet contents.

Media wallets, when storing content, may store direct references to content. Media wallets may also reference content through keys to decrypt and/or access the content. Media wallets may use such keys to additionally access metadata associated with the content. Example metadata may include, but is not limited to, classifications of content. In a number of embodiments, the classification metadata may govern access rights of other parties related to the content.

Access governance rights may include, but are not limited to, whether a party may indicate their relationship with the wallet; whether they may read summary data associated with the content; whether they have access to peruse the content; whether they may place bids to purchase the content; whether they may borrow the content, and/or whether they are biometrically authenticated.

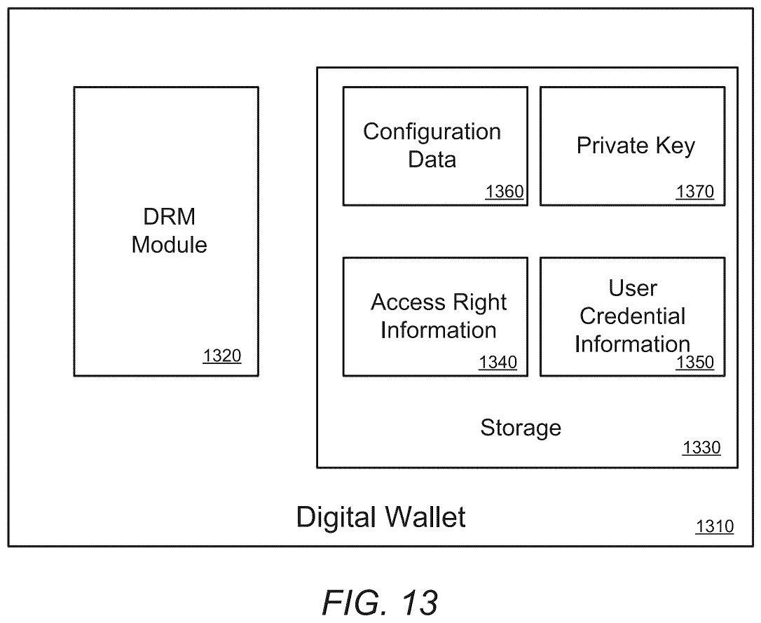

An example of a media wallet 1310 capable of storing rich media NFTs in accordance with an embodiment of the invention is illustrated in FIG. 13. Media wallets 1310 may include a storage component 1330, including access right information 1340, user credential information 1350, token configuration data 1360, and/or at least one private key 1370. In accordance with many embodiments of the invention, a private key 1370 may be used to perform a plurality of actions on resources, including but not limited to decrypting NFT and/or fungible token content. Media wallets may also correspond to a public key, referred to as a wallet address. An action performed by private keys 1370 may be used to prove access rights to digital rights management modules. Additionally, private keys 1370 may be applied to initiating ownership transfers and granting NFT and/or fungible token access to alternate wallets. In accordance with some embodiments, access right information 1340 may include lists of elements that the wallet 1310 has access to. Access right information 1340 may also express the type of access provided to the wallet. Sample types of access include, but are not limited to, the right to transfer NFT and/or fungible ownership, the right to play rich media associated with a given NFT, and the right to use an NFT and/or fungible token. Different rights may be governed by different cryptographic keys. Additionally, the access right information 1340 associated with a given wallet 1310 may utilize user credential information 1350 from the party providing access.

In accordance with many embodiments of the invention, third parties initiating actions corresponding to requesting access to a given NFT may require user credential information 1350 of the party providing access to be verified. User credential information 1350 may be taken from the group including, but not limited to, a digital signature, hashed passwords, PINs, and biometric credentials. User credential information 1350 may be stored in a manner accessible only to approved devices. In accordance with some embodiments of the invention, user credential information 1350 may be encrypted using a decryption key held by trusted hardware, such as a trusted execution environment. Upon verification, user credential information 1350 may be used to authenticate wallet access.

Available access rights may be determined by digital rights management (DRM) modules 1320 of wallets 1310. In the context of rich media, encryption may be used to secure content. As such, DRM systems may refer to technologies that control the distribution and use of keys required to decrypt and access content. DRM systems in accordance with many embodiments of the invention may require a trusted execution zone. Additionally, said systems may require one or more keys (typically a certificate containing a public key/private key pair) that may be used to communicate with and register with DRM servers. DRM modules 1320 in some embodiments may also use one or more keys to communicate with a DRM server. In several embodiments, the DRM modules 1320 may include code used for performing sensitive transactions for wallets including, but not limited to, content access. In accordance with a number of embodiments of the invention, the DRM module 1320 may execute in a Trusted Execution Environment. In a number of embodiments, the DRM may be facilitated by an Operating System (OS) that enables separation of processes and processing storage from other processes and their processing storage.

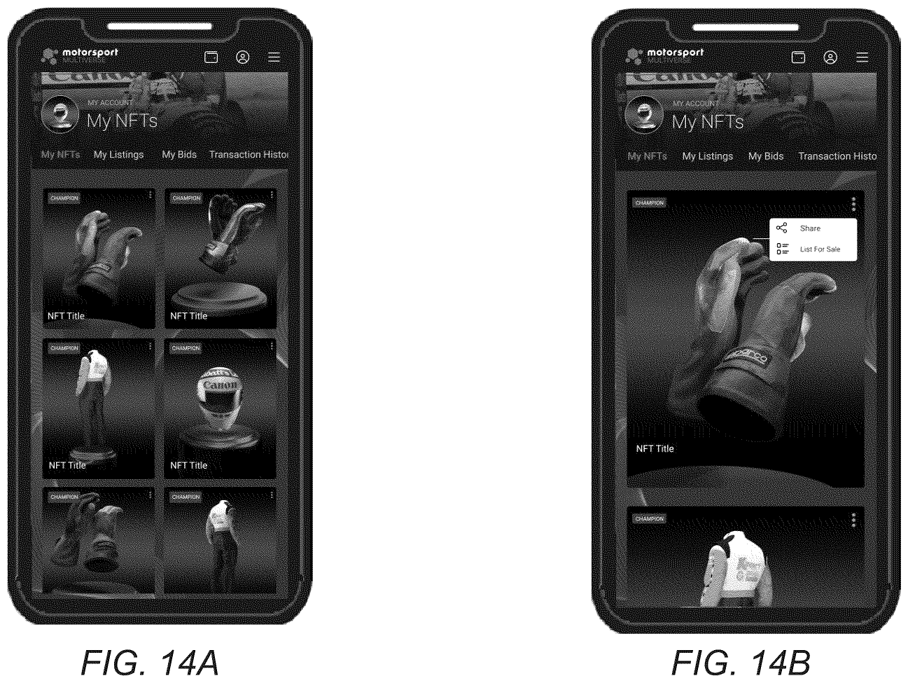

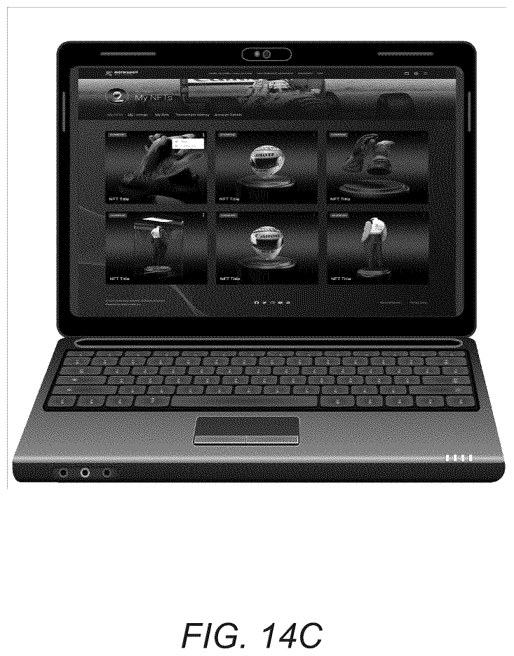

Operation of media wallet applications implemented in accordance with some embodiments of the invention is conceptually illustrated by way of the user interfaces shown in FIGS. 14A-14C. In many embodiments, media wallet applications may refer to applications that are installed upon user devices such as (but not limited to) mobile phones and tablet computers running the IOS, Android and/or similar operating systems. Launching media wallet applications may provide a number of user interface contexts. In many embodiments, transitions between these user interface contexts may be initiated in response to gestures including (but not limited to) swipe gestures received via a touch user interface. As may readily be appreciated, the specific manner in which user interfaces operate through media wallet applications is largely dependent upon the user input capabilities of the underlying user device. In several embodiments, a first user interface context is a dashboard (see, FIGS. 14A, 14C) that may include a gallery view of NFTs owned by the user. In several embodiments, the NFT listings may be organized into category index cards. Category index cards may include, but are not limited to digital merchandise/collectibles, special event access/digital tickets, fan leaderboards. In certain embodiments, a second user interface context (see, for example, FIG. 14B) may display individual NFTs. In a number of embodiments, each NFT may be main-staged in said display with its status and relevant information shown. Users may swipe through each collectible and interacting with the user interface may launch a collectible user interface enabling greater interaction with a particular collectible in a manner that may be determined based upon the smart contract underlying the NFT.

A participant of an NFT platform may use a digital wallet to classify wallet content, including NFTs, fungible tokens, content that is not expressed as tokens such as content that has not yet been minted but for which the wallet may initiate minting, and other non-token content, including executable content, webpages, configuration data, history files and logs. This classification may be performed using a visual user interface. Users interface may enable users to create a visual partition of a space. In some embodiments of the invention, a visual partition may in turn be partitioned into sub-partitions. In some embodiments, a partition of content may separate wallet content into content that is not visible to the outside world (“invisible partition”), and content that is visible at least to some extent by the outside world (“visible partition”). Some of the wallet content may require the wallet use to have an access code such as a password or a biometric credential to access, view the existence of, or perform transactions on. A visible partition may be subdivided into two or more partitions, where the first one corresponds to content that may be seen by anybody, the second partition corresponds to content that may be seen by members of a first group, and/or the third partition corresponds to content that may be seen by members of a second group.

For example, the first group may be users with which the user has created a bond, and invited to be able to see content. The second group may be users who have a membership and/or ownership that may not be controlled by the user. An example membership may be users who own non-fungible tokens (NFTs) from a particular content creator. Content elements, through icons representing the elements, may be relocated into various partitions of the space representing the user wallet. By doing so, content elements may be associated with access rights governed by rules and policies of the given partition.

One additional type of visibility may be partial visibility. Partial visibility may correspond to a capability to access metadata associated with an item, such as an NFT and/or a quantity of crypto funds, but not carry the capacity to read the content, lend it out, or transfer ownership of it. As applied to a video NFT, an observer to a partition with partial visibility may not be able to render the video being encoded in the NFT but see a still image of it and a description indicating its source.

Similarly, a party may have access to a first anonymized profile which states that the user associated with the wallet is associated with a given demographic. The party with this access may also be able to determine that a second anonymized profile including additional data is available for purchase. This second anonymized profile may be kept in a sub-partition to which only people who pay a fee have access, thereby expressing a form of membership. Alternatively, only users that have agreed to share usage logs, aspects of usage logs or parts thereof may be allowed to access a given sub-partition. By agreeing to share usage log information with the wallet comprising the sub-partition, this wallet learns of the profiles of users accessing various forms of content, allowing the wallet to customize content, including by incorporating advertisements, and to determine what content to acquire to attract users of certain demographics.

Another type of membership may be held by advertisers who have sent promotional content to the user. These advertisers may be allowed to access a partition that stores advertisement data. Such advertisement data may be encoded in the form of anonymized profiles. In a number of embodiments, a given sub-partition may be accessible only to the advertiser to whom the advertisement data pertains. Elements describing advertisement data may be automatically placed in their associated partitions, after permission has been given by the user. This partition may either be visible to the user. Visibility may also depend on a direct request to see “system partitions.” A first partition may correspond to material associated with a first set of public keys, a second partition to material associated with a second set of public keys not overlapping with the first set of public keys, wherein such material may comprise tokens such as crypto coins and NFTs. A third partition may correspond to usage data associated with the wallet user, and a fourth partition may correspond to demographic data and/or preference data associated with the wallet user. Yet other partitions may correspond to classifications of content, e.g., child-friendly vs. adult; classifications of whether associated items are for sale or not, etc.

The placing of content in a given partition may be performed by a drag-and-drop action performed on a visual interface. By selecting items and clusters and performing a drag-and-drop to another partition and/or to a sub-partition, the visual interface may allow movement including, but not limited to, one item, a cluster of items, and a multiplicity of items and clusters of items. The selection of items may be performed using a lasso approach in which items and partitions are circled as they are displayed. The selection of items may also be performed by alternative methods for selecting multiple items in a visual interface, as will be appreciated by a person of skill in the art.

Some content classifications may be automated in part or full. For example, when user place ten artifacts, such as NFTs describing in-game capabilities, in a particular partition, they may be asked if additional content that are also in-game capabilities should be automatically placed in the same partition as they are acquired and associated with the wallet. When “yes” is selected, then this placement may be automated in the future. When “yes, but confirm for each NFT” is selected, then users may be asked, for each automatically classified element, to confirm its placement. Before the user confirms, the element may remain in a queue that corresponds to not being visible to the outside world. When users decline given classifications, they may be asked whether alternative classifications should be automatically performed for such elements onwards. In some embodiments, the selection of alternative classifications may be based on manual user classification taking place subsequent to the refusal.

Automatic classification of elements may be used to perform associations with partitions and/or folders. The automatic classification may be based on machine learning (ML) techniques considering characteristics including, but not limited to, usage behaviors exhibited by the user relative to the content to be classified, labels associated with the content, usage statistics; and/or manual user classifications of related content.

Multiple views of wallets may also be accessible. One such view may correspond to the classifications described above, which indicates the actions and interactions others may perform relative to elements. Another view may correspond to a classification of content based on use, type, and/or user-specified criterion. For example, all game NFTs may be displayed in one collection view. The collection view may further subdivide the game NFTs into associations with different games or collections of games. Another collection may show all audio content, clustered based on genre. users-specified classification may be whether the content is for purposes of personal use, investment, or both. A content element may show up in multiple views. users may search the contents of his or her wallet by using search terms that result in potential matches.

Alternatively, the collection of content may be navigated based the described views of particular wallets, allowing access to content. Once a content element has been located, the content may be interacted with. For example, located content elements may be rendered. One view may be switched to another after a specific item is found. For example, this may occur through locating an item based on its genre and after the item is found, switching to the partitioned view described above. In some embodiments, wallet content may be rendered using two or more views in a simultaneous manner. They may also select items using one view.

Media wallet applications in accordance with various embodiments of the invention are not limited to use within NFT platforms. Accordingly, it should be appreciated that applications described herein may also be implemented outside the context of an NFT platform network architecture unrelated to the storage of fungible tokens and/or NFTs. Moreover, any of the computer systems described herein with reference to FIGS. 10-14C may be utilized within any of the NFT platforms described above.

### NFT Platform NFT Interactions

NFT platforms in accordance with many embodiments of the invention may incorporate a wide variety of rich media NFT configurations. The term “Rich Media Non-Fungible Tokens” may be used to refer to blockchain-based cryptographic tokens created with respect to a specific piece of rich media content and which incorporate programmatically defined digital rights management. In some embodiments of the invention, each NFT may have a unique serial number and be associated with a smart contract defining an interface that enables the NFT to be managed, owned and/or traded.

Under a rich media blockchain in accordance with many embodiments of the invention, a wide variety of NFT configurations may be implemented. Some NFTs may be referred to as anchored NFTs (or anchored tokens), used to tie some element, such as a physical entity, to an identifier. Of this classification, one sub-category may be used to tie users' real-world identities and/or identifiers to a system identifier, such as a public key. In this disclosure, this type of NFT applied to identifying users, may be called a social NFT, identity NFT, identity token, and a social token. In accordance with many embodiments of the invention, an individual's personally identifiable characteristics may be contained, maintained, and managed throughout their lifetime so as to connect new information and/or NFTs to the individual's identity. A social NFT's information may include, but are not limited to, personally identifiable characteristics such as name, place and date of birth, and/or biometrics.

An example social NFT may assign a DNA print to a newborn's identity. In accordance with a number of embodiments of the invention, this first social NFT might then be used in the assignment process of a social security number NFT from the federal government. In some embodiments, the first social NFT may then be associated with some rights and capabilities, which may be expressed in other NFTs. Additional rights and capabilities may also be directly encoded in a policy of the social security number NFT.

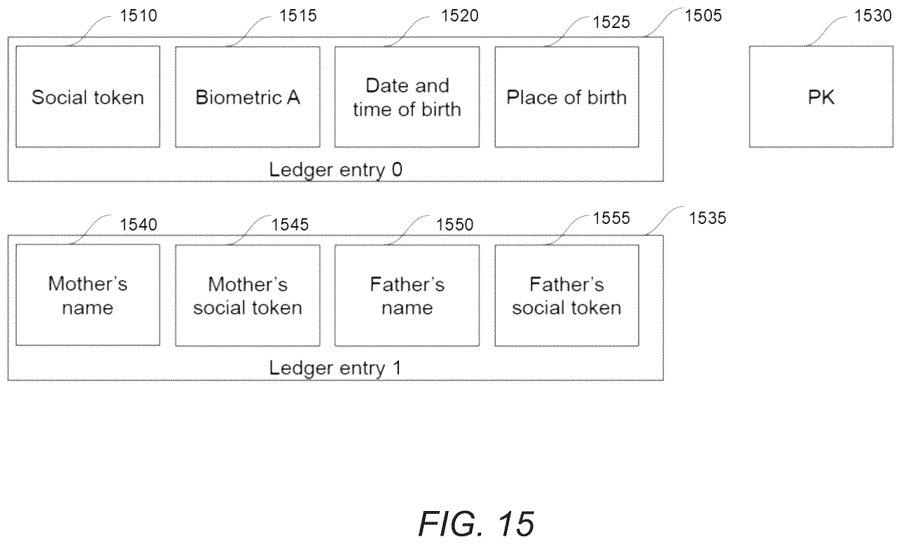

A social NFT may exist on a personalized branch of a centralized and/or decentralized blockchain. Ledger entries related to an individual's social NFT in accordance with several embodiments of the invention are depicted in FIG. 15. Ledger entries of this type may be used to build an immutable identity foundation whereby biometrics, birth and parental information are associated with an NFT. As such, this information may also be protected with encryption using a private key 1530. The initial entry in a ledger, “ledger entry 0” 1505, may represent a social token 1510 assignment to an individual with a biometric “A” 1515. In this embodiment, the biometric may include but is not limited to a footprint, a DNA print, and a fingerprint. The greater record may also include the individual's date and time of birth 1520 and place of birth 1525. A subsequent ledger entry 1 1535 may append parental information including but not limited to mothers' name 1540, mother's social token 1545, father's name 1550, and father's social token 1555.

In a number of embodiments, the various components that make up a social NFT may vary from situation to situation. In a number of embodiments, biometrics and/or parental information may be unavailable in a given situation and/or period of time. Other information including, but not limited to, race, gender, and governmental number assignments such as social security numbers, may be desirable to include in the ledger. In a blockchain, future NFT creation may create a life-long ledger record of an individual's public and private activities. In accordance with some embodiments, the record may be associated with information including, but not limited to, identity, purchases, health and medical records, access NFTs, family records such as future offspring, marriages, familial history, photographs, videos, tax filings, and/or patent filings. The management and/or maintenance of an individual's biometrics throughout the individual's life may be immutably connected to the first social NFT given the use of a decentralized blockchain ledger.

In some embodiments, a certifying third party may generate an NFT associated with certain rights upon the occurrence of a specific event. In one such embodiment, the DMV may be the certifying party and generate an NFT associated with the right to drive a car upon issuing a traditional driver's license. In another embodiment, the certifying third party may be a bank that verifies a person's identity papers and generates an NFT in response to a successful verification. In a third embodiment, the certifying party may be a car manufacturer, who generates an NFT and associates it with the purchase and/or lease of a car.

In many embodiments, a rule may specify what types of policies the certifying party may associate with the NFT. Additionally, a non-certified entity may also generate an NFT and assert its validity. This may require putting up some form of security. In one example, security may come in the form of a conditional payment associated with the NFT generated by the non-certified entity. In this case, the conditional payment may be exchangeable for funds if abuse may be detected by a bounty hunter and/or some alternate entity. Non-certified entities may also relate to a publicly accessible reputation record describing the non-certified entity's reputability.

Anchored NFTs may additionally be applied to automatic enforcement of programming rules in resource transfers. NFTs of this type may be referred to as promise NFTs. A promise NFT may include an agreement expressed in a machine-readable form and/or in a human-accessible form. In a number of embodiments, the machine-readable and human-readable elements may be generated one from the other. In some embodiments, an agreement in a machine-readable form may include, but is not limited to, a policy and/or an executable script. In some embodiments, an agreement in a human-readable form may include, but is not limited to, a text and/or voice-based statement of the promise.

In some embodiments, regardless of whether the machine-readable and human-readable elements are generated from each other, one may be verified based on the other. Smart contracts including both machine-readable statements and human-accessible statements may also be used outside the implementation of promise NFTs. Moreover, promise NFTs may be used outside actions taken by individual NFTs and/or NFT-owners. In some embodiments, promise NFTs may relate to general conditions, and may be used as part of a marketplace.

In one such example, horse betting may be performed through generating a first promise NFT that offers a payment of $10 if a horse does not win. Payment may occur under the condition that the first promise NFT is matched with a second promise NFT that causes a transfer of funds to a public key specified with the first promise NFT if horse X wins.

A promise NFT may be associated with actions that cause the execution of a policy and/or rule indicated by the promise NFT. In some embodiments of the invention, a promise of paying a charity may be associated with the sharing of an NFT. In this embodiment, the associated promise NFT may identify a situation that satisfies the rule associated with the promise NFT, thereby causing the transfer of funds when the condition is satisfied (as described above). One method of implementation may be embedding in and/or associating a conditional payment with the promise NFT. A conditional payment NFT may induce a contract causing the transfer of funds by performing a match. In some such methods, the match may be between the promise NFT and inputs that identify that the conditions are satisfied, where said input may take the form of another NFT. In a number of embodiments, one or more NFTs may also relate to investment opportunities.

For example, a first NFT may represent a deed to a first building, and a second NFT a deed to a second building. Moreover, the deed represented by the first NFT may indicate that a first party owns the first property. The deed represented by the second NFT may indicate that a second party owns the second property. A third NFT may represent one or more valuations of the first building. The third NFT may in turn be associated with a fourth NFT that may represent credentials of a party performing such a valuation. A fifth NFT may represent one or more valuations of the second building. A sixth may represent the credentials of one of the parties performing a valuation. The fourth and sixth NFTs may be associated with one or more insurance policies, asserting that if the parties performing the valuation are mistaken beyond a specified error tolerance, then the insurer would pay up to a specified amount.

A seventh NFT may then represent a contract that relates to the planned acquisition of the second building by the first party, from the second party, at a specified price. The seventh NFT may make the contract conditional provided a sufficient investment and/or verification by a third party. A third party may evaluate the contract of the seventh NFT, and determine whether the terms are reasonable. After the evaluation, the third party may then verify the other NFTs to ensure that the terms stated in the contract of the seventh NFT agree. If the third party determines that the contract exceeds a threshold in terms of value to risk, as assessed in the seventh NFT, then executable elements of the seventh NFT may cause transfers of funds to an escrow party specified in the contract of the sixth NFT.

Alternatively, the first party may initiate the commitment of funds, conditional on the remaining funds being raised within a specified time interval. The commitment of funds may occur through posting the commitment to a ledger. Committing funds may produce smart contracts that are conditional on other events, namely the payments needed to complete the real estate transaction. The smart contract also may have one or more additional conditions associated with it. For example, an additional condition may be the reversal of the payment if, after a specified amount of time, the other funds have not been raised. Another condition may be related to the satisfactory completion of an inspection and/or additional valuation.

NFTs may also be used to assert ownership of virtual property. Virtual property in this instance may include, but is not limited to, rights associated with an NFT, rights associated with patents, and rights associated with pending patents. In a number of embodiments, the entities involved in property ownership may be engaged in fractional ownership. In some such embodiments, two parties may wish to purchase an expensive work of digital artwork represented by an NFT. The parties may enter into smart contracts to fund and purchase valuable works. After a purchase, an additional NFT may represent each party's contribution to the purchase and equivalent fractional share of ownership.

Another type of NFTs that may relate to anchored NFTs may be called “relative NFTs.” This may refer to NFTs that relate two or more NFTs to each other. Relative NFTs associated with social NFTs may include digital signatures that is verified using a public key of a specific social NFT. In some embodiments, an example of a relative NFT may be an assertion of presence in a specific location, by a person corresponding to the social NFT. This type of relative NFT may also be referred to as a location NFT and a presence NFT. Conversely, a signature verified using a public key embedded in a location NFT may be used as proof that an entity sensed by the location NFT is present. Relative NFTs are derived from other NFTs, namely those they relate to, and therefore may also be referred to as derived NFTs. An anchored NFT may tie to another NFT, which may make it both anchored and relative. An example of such may be called pseudonym NFTs.

Pseudonym NFTs may be a kind of relative NFT acting as a pseudonym identifier associated with a given social NFT. In some embodiments, pseudonym NFTs may, after a limited time and/or a limited number of transactions, be replaced by a newly derived NFTs expressing new pseudonym identifiers. This may disassociate users from a series of recorded events, each one of which may be associated with different pseudonym identifiers. A pseudonym NFT may include an identifier that is accessible to biometric verification NFTs. Biometric verification NFTs may be associated with a TEE and/or DRM which is associated with one or more biometric sensors. Pseudonym NFTs may be output by social NFTs and/or pseudonym NFTs.

Inheritance NFTs may be another form of relative NFTs, that transfers rights associated with a first NFT to a second NFT. For example, computers, represented by an anchored NFT that is related to a physical entity (the hardware), may have access rights to WiFi networks. When computers are replaced with newer models, users may want to maintain all old relationships, for the new computer. For example, users may want to retain WiFi hotspots. For this to be facilitated, a new computer may be represented by an inheritance NFT, inheriting rights from the anchored NFT related to the old computer. An inheritance NFT may acquire some or all pre-existing rights associated with the NFT of the old computer, and associate those with the NFT associated with the new computer.

More generally, multiple inheritance NFTs may be used to selectively transfer rights associated with one NFT to one or more NFTs, where such NFTs may correspond to users, devices, and/or other entities, when such assignments of rights are applicable. Inheritance NFTs may also be used to transfer property. One way to implement the transfer of property may be to create digital signatures using private keys. These private keys may be associated with NFTs associated with the rights. In accordance with a number of embodiments, transfer information may include the assignment of included rights, under what conditions the transfer may happen, and to what NFT(s) the transfer may happen. In this transfer, the assigned NFTs may be represented by identifiers unique to these, such as public keys. The digital signature and message may then be in the form of an inheritance NFT, or part of an inheritance NFT. As rights are assigned, they may be transferred away from previous owners to new owners through respective NFTs. Access to financial resources is one such example.

However, sometimes rights may be assigned to new parties without taking the same rights away from the party (i.e., NFT) from which the rights come. One example of this may be the right to listen to a song, when a license to the song is sold by the artist to consumers. However, if the seller sells exclusive rights, this causes the seller not to have the rights anymore.

In accordance with many embodiments of the invention, multiple alternative NFT configurations may be implemented. One classification of NFT may be an employee NFT or employee token. Employee NFTs may be used by entities including, but not limited to, business employees, students, and organization members. Employee NFTs may operate in a manner analogous to key card photo identifications. In a number of embodiments, employee NFTs may reference information including, but not limited to, company information, employee identity information and/or individual identity NFTs.

Additionally, employee NFTs may include associated access NFT information including but not limited to, what portions of a building employees may access, and what computer system employees may utilize. In several embodiments, employee NFTs may incorporate their owner's biometrics, such as a face image. In a number of embodiments, employee NFTs may operate as a form of promise NFT. In some embodiments, employee NFT may comprise policies or rules of employing organization. In a number of embodiments, the employee NFT may reference a collection of other NFTs.

Another type of NFT may be referred to as the promotional NFT or promotional token. Promotional NFTs may be used to provide verification that promoters provide promotion winners with promised goods. In some embodiments, promotional NFTs may operate through decentralized applications for which access restricted to those using an identity NFT. The use of a smart contract with a promotional NFT may be used to allow for a verifiable release of winnings. These winnings may include, but are not limited to, cryptocurrency, money, and gift card NFTs useful to purchase specified goods. Smart contracts used alongside promotional NFTs may be constructed for winners selected through random number generation.

Another type of NFT may be called the script NFT or script token. Script tokens may incorporate script elements including, but not limited to, story scripts, plotlines, scene details, image elements, avatar models, sound profiles, and voice data for avatars. Script tokens may also utilize rules and policies that describe how script elements are combined. Script tokens may also include rightsholder information, including but not limited to, licensing and copyright information. Executable elements of script tokens may include instructions for how to process inputs; how to configure other elements associated with the script tokens; and how to process information from other tokens used in combination with script tokens.

Script tokens may be applied to generate presentations of information. In accordance with some embodiments, these presentations may be developed on devices including but not limited to traditional computers, mobile computers, and virtual reality display devices. Script tokens may be used to provide the content for game avatars, digital assistant avatars, and/or instructor avatars. Script tokens may comprise audio-visual information describing how input text is presented, along with the input text that provides the material to be presented. It may also comprise what may be thought of as the personality of the avatar, including how the avatar may react to various types of input from an associated user.

In some embodiments, script NFTs may be applied to govern behavior within an organization. For example, this may be done through digital signatures asserting the provenance of the scripts. Script NFTs may also, in full and/or in part, be generated by freelancers. For example, a text script related to a movie, an interactive experience, a tutorial, and/or other material, may be created by an individual content creator. This information may then be combined with a voice model or avatar model created by an established content producer. The information may then be combined with a background created by additional parties. Various content producers may generate parts of the content, allowing for large-scale content collaboration.

Features of other NFTs may be incorporated in a new NFT using techniques related to inheritance NFTs, and/or by making references to other NFTs. As script NFTs may consist of multiple elements, creators with special skills related to one particular element may generate and combine elements. This may be used to democratize not only the writing of storylines for content, but also outsourcing for content production. For each such element, an identifier establishing the origin or provenance of the element may be included. Policy elements may also be incorporated to identify the conditions under which a given script element may be used. Conditions may be related to, but are not limited to execution environments, trusts, licenses, logging, financial terms for use, and various requirements for the script NFTs. Requirements may concern, but are not limited to, what other types of elements the given element are compatible with, what is allowed to be combined with according the terms of service, and/or local copyright laws that must be obeyed.

Evaluation units may be used with various NFT classifications to collect information on their use. Evaluation units may take a graph representing subsets of existing NFTs and make inferences from the observed graph component. From this, valuable insights into NFT value may be derived. For example, evaluation units may be used to identify NFTs whose popularity is increasing or waning. In that context, popularity may be expressed as, but not limited to, the number of derivations of the NFT that are made; the number of renderings, executions or other uses are made; and the total revenue that is generated to one or more parties based on renderings, executions or other uses.

Evaluation units may make their determination through specific windows of time and/or specific collections of end-users associated with the consumption of NFT data in the NFTs. Evaluation units may limit assessments to specific NFTs (e.g., script NFTs). This may be applied to identify NFTs that are likely to be of interest to various users. In addition, the system may use rule-based approaches to identify NFTs of importance, wherein importance may be ascribed to, but is not limited to, the origination of the NFTs, the use of the NFTs, the velocity of content creation of identified clusters or classes, the actions taken by consumers of NFT, including reuse of NFTs, the lack of reuse of NFTs, and the increased or decreased use of NFTs in selected social networks.

Evaluations may be repurposed through recommendation mechanisms for individual content consumers and/or as content originators. Another example may address the identification of potential combination opportunities, by allowing ranking based on compatibility. Accordingly, content creators such as artists, musicians and programmers may identify how to make their content more desirable to intended target groups.

The generation of evaluations may be supported by methods including, but not limited to machine learning (ML) methods, artificial intelligence (AI) methods, and/or statistical methods. Anomaly detection methods developed to identify fraud may be repurposed to identify outliers. This may be done to flag abuse risks or to improve the evaluation effort.

Multiple competing evaluation units may make competing predictions using alternative and proprietary algorithms. Thus, different evaluation units may be created to identify different types of events to different types of subscribers, monetizing their insights related to the data they access.

In a number of embodiments, evaluation units may be a form of NFTs that derive insights from massive amounts of input data. Input data may correspond, but is not limited to the graph component being analyzed. Such NFTs may be referred to as evaluation unit NFTs.

The minting of NFTs may associate rights with first owners and/or with an optional one or more policies and protection modes. An example policy and/or protection mode directed to financial information may express royalty requirements. An example policy and/or protection mode directed to non-financial requirements may express restrictions on access and/or reproduction. An example policy directed to data collection may express listings of user information that may be collected and disseminated to other participants of the NFT platform.

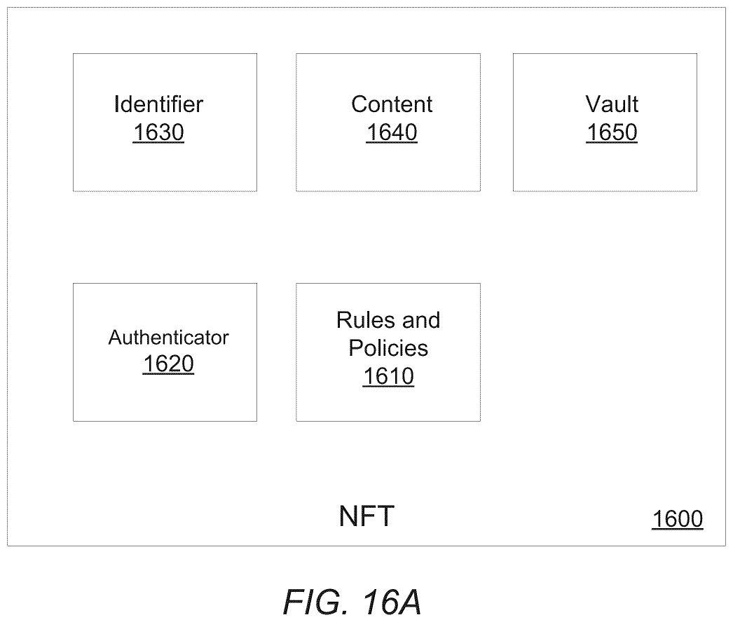

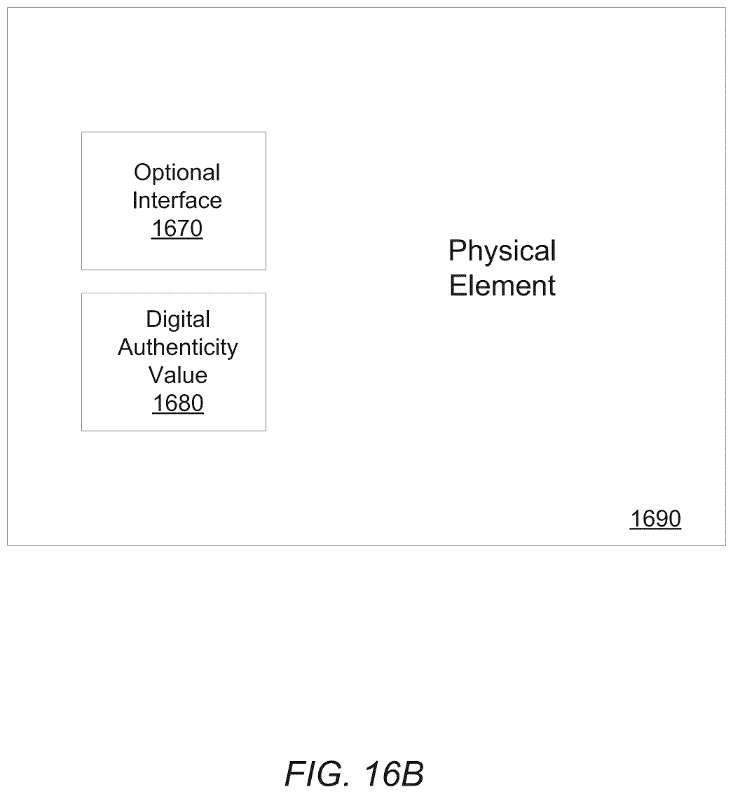

An example NFT which may be associated with specific content in accordance with several embodiments of the invention is illustrated in FIG. 16A. In some embodiments, an NFT 1600 may utilize a vault 1650, which may control access to external data storage areas. Methods of controlling access may include, but are not limited to, user credential information 1350. In accordance with a number of embodiments of the invention, control access may be managed through encrypting content 1640. As such, NFTs 1600 may incorporate content 1640, which may be encrypted, not encrypted, yet otherwise accessible, or encrypted in part. In accordance with some embodiments, an NFT 1600 may be associated with one or more content 1640 elements, which may be contained in or referenced by the NFT. A content 1640 element may include, but is not limited to, an image, an audio file, a script, a biometric user identifier, and/or data derived from an alternative source. An example alternative source may be a hash of biometric information). An NFT 1600 may also include an authenticator 1620 capable of affirming that specific NFTs are valid.

In accordance with many embodiments of the invention, NFTs may include a number of rules and policies 1610. Rules and policies 1610 may include, but are not limited to access rights information 1340. In some embodiments, rules and policies 1610 may also state terms of usage, royalty requirements, and/or transfer restrictions. An NFT 1600 may also include an identifier 1630 to affirm ownership status. In accordance with many embodiments of the invention, ownership status may be expressed by linking the identifier 1630 to an address associated with a blockchain entry.

In accordance with a number of embodiments of the invention, NFTs may represent static creative content. NFTs may also be representative of dynamic creative content, which changes over time. In accordance with many examples of the invention, the content associated with an NFT may be a digital content element.

One example of a digital content element in accordance with some embodiments may be a set of five images of a mouse. In this example, the first image may be an image of the mouse being alive. The second may be an image of the mouse eating poison. The third may be an image of the mouse not feeling well. The fourth image may be of the mouse, dead. The fifth image may be of a decaying mouse.

The user credential information 1350 of an NFT may associate each image to an identity, such as of the artist. In accordance with a number of embodiments of the invention, NFT digital content may correspond to transitions from one representation (e.g., an image of the mouse, being alive) to another representation (e.g., of the mouse eating poison). In this disclosure, digital content transitioning from one representation to another may be referred to as a state change and/or an evolution. In a number of embodiments, an evolution may be triggered by the artist, by an event associated with the owner of the artwork, randomly, and/or by an external event.

When NFTs representing digital content are acquired in accordance with some embodiments of the invention, they may also be associated with the transfer of corresponding physical artwork, and/or the rights to said artwork. The first ownership records for NFTs may correspond to when the NFT was minted, at which time its ownership may be assigned to the content creator. Additionally, in the case of “lazy” minting, rights may be directly assigned to a buyer.

In some embodiments, as a piece of digital content evolves, it may also change its representation. The change in NFTs may also send a signal to an owner after it has evolved. In doing so, a signal may indicate that the owner has the right to acquire the physical content corresponding to the new state of the digital content. Under an earlier example, buying a live mouse artwork, as an NFT, may also carry the corresponding painting, and/or the rights to it. A physical embodiment of an artwork that corresponds to that same NFT may also be able to replace the physical artwork when the digital content of the NFT evolves. For example, should the live mouse artwork NFT change states to a decaying mouse, an exchange may be performed of the corresponding painting for a painting of a decaying mouse.

The validity of one of the elements, such as the physical element, may be governed by conditions related to an item with which it is associated. For example, a physical painting may have a digital authenticity value that attests to the identity of the content creator associated with the physical painting.

An example of a physical element 1690 corresponding to an NFT, in accordance with some embodiments of the invention is illustrated in FIG. 16B. A physical element 1690 may be a physical artwork including, but not limited to, a drawing, a statue, and/or another physical representation of art. In a number of embodiments, physical representations of the content (which may correspond to a series of paintings) may each be embedded with a digital authenticity value (or a validator value) value. In accordance with many embodiments of the invention, a digital authenticity value (DAV) 1680 may therefore be associated with a physical element 1690 and a digital element. A digital authenticity value may be a value that includes an identifier and a digital signature on the identifier. In some embodiments the identifier may specify information related to the creation of the content. This information may include the name of the artist, the identifier 1630 of the digital element corresponding to the physical content, a serial number, information such as when it was created, and/or a reference to a database in which sales data for the content is maintained. A digital signature element affirming the physical element may be made by the content creator and/or by an authority associating the content with the content creator.

In some embodiments, the digital authenticity value 1680 of the physical element 1690 may be expressed using a visible representation. The visible representation may be an optional physical interface 1670 taken from a group including, but not limited to, a barcode and a quick response (QR) code encoding the digital authenticity value. In some embodiments, the encoded value may also be represented in an authenticity database. Moreover, the physical interface 1670 may be physically associated with the physical element. One example of such may be a QR tag being glued to or printed on the back of a canvas. In some embodiments of the invention, the physical interface 1670 may be possible to physically disassociate from the physical item it is attached to. However, if a DAV 1680 is used to express authenticity of two or more physical items, the authenticity database may detect and block a new entry during the registration of the second of the two physical items. For example, if a very believable forgery is made of a painting the forged painting may not be considered authentic without the QR code associated with the digital element.

In a number of embodiments, the verification of the validity of a physical item, such as a piece of artwork, may be determined by scanning the DAV. In some embodiments, scanning the DAV may be used to determine whether ownership has already been assigned. Using techniques like this, each physical item may be associated with a control that prevents forgeries to be registered as legitimate, and therefore, makes them not valid. In the context of a content creator receiving a physical element from an owner, the content creator may deregister the physical element 1690 by causing its representation to be erased from the authenticity database used to track ownership. Alternatively, in the case of an immutable blockchain record, the ownership blockchain may be appended with new information. Additionally, in instances where the owner returns a physical element, such as a painting, to a content creator in order for the content creator to replace it with an “evolved” version, the owner may be required to transfer the ownership of the initial physical element to the content creator, and/or place the physical element in a stage of being evolved.

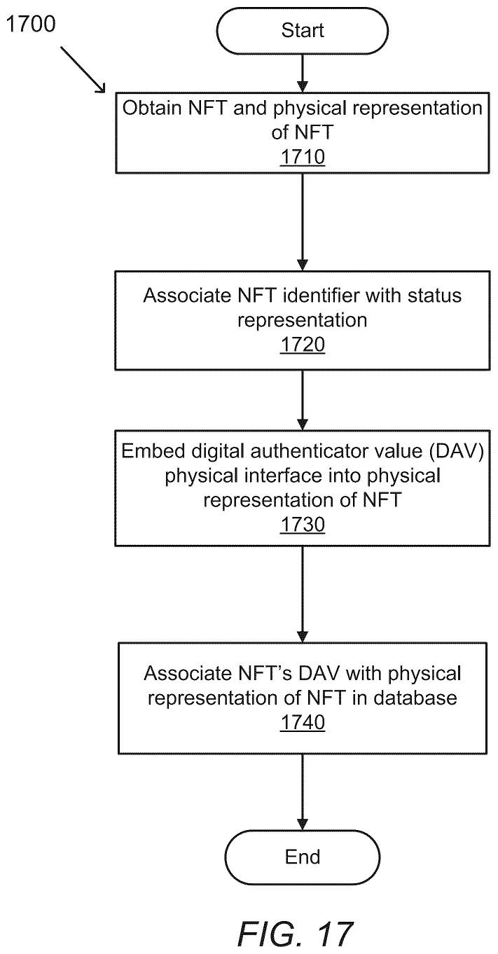

An example of a process for connecting an NFT digital element to physical content in accordance with some embodiments of the invention is illustrated in FIG. 17. Process 1700 may obtain (1710) an NFT and a physical representation of the NFT in connection with an NFT transaction. Under the earlier example, this may be a painting of a living mouse and an NFT of a living mouse. By virtue of establishing ownership of the NFT, the process 1700 may associate (1720) an NFT identifier with a status representation of the NFT. The NFT identifier may specify attributes including, but not limited to, the creator of the mouse painting and NFT (“Artist”), the blockchain the NFT is on (“NFT-Chain”), and an identifying value for the digital element (“no. 0001”). Meanwhile, the status representation may clarify the present state of the NFT (“alive mouse”). Process 1700 may also embed (1730) a DAV physical interface into the physical representation of the NFT. In a number of embodiments of the invention, this may be done by implanting a QR code into the back of the mouse painting. In affirming the connection between the NFT and painting, Process 1700 may associate (1740) the NFT's DAV with the physical representation of the NFT in a database. In some embodiments, the association may be performed through making note of the transaction and clarifying that it encapsulates both the mouse painting and the mouse NFT.

While specific processes are described above with reference to FIGS. 15-17, NFTs may be implemented in any of a number of different ways to enable token transactions as appropriate to the requirements of specific applications in accordance with various embodiments of the invention. In many embodiments, steps may be executed or performed in any order or sequence not limited to the order and sequence shown and described. In numerous embodiments, some of the above steps may be executed or performed substantially simultaneously where appropriate or in parallel to reduce latency and processing times. In some embodiments, one or more of the above steps may be omitted. Additionally, the specific manner in which NFTs may be utilized within NFT platforms in accordance with various embodiments of the invention is largely dependent upon the requirements of a given application.

### NFT Platform Token Functionalities

### A. Sticky Tokens

Systems configured in accordance with various embodiments of the invention may implement tokens called “sticky tokens” that implement transfer restrictions including but not limited to non-transferability. The term “soulbound tokens” may refer to tokens that, by design, are not transferable by owners of the tokens. In accordance with some embodiments of the invention, whether or not tokens are soulbound may depend on the ownership of the tokens.

For example, systems in accordance with many embodiments of the invention may set parameters to reflect that the preferred ownership of given tokens is that the owner is a person. In accordance with multiple embodiments of the invention, when the owner is determined to be a person (for example, in Ethereum when the owning address is an externally owned account, or “EOA”), then execution of the code implementing the transfer functions may be configured to proceed. Additionally or alternatively, when the owners are determined not to be people; for instance, when they are smart contracts, transfer functions may revert and the token transfers may fail. Through this, tokens may be passed from person to person, but once transferred to the ownership of any smart contract, any subsequent transfer requests are set to fail. This may thereby ensure that the tokens permanently remain in the possession of the smart contract(s). In the terminology of Ethereum, those skilled in the art will now appreciate that said token smart contracts may implement standard NFTs that subsequently become “soulbound” when transferred to smart contracts.

Additionally or alternatively, the preferred ownership may be the opposite, preferring that owners be smart contracts. In such cases, when owners are determined to be smart contracts, then execution of code implementing the transfer functions may proceed. Additionally or alternatively, when the owners and/or senders are not smart contracts (i.e., EOAs) then the transfer functions may revert. In a number of embodiments, said smart contracts may implement tokens that may be transferred from smart contract to smart contract, but subsequently become soulbound when transferred to EOAs.

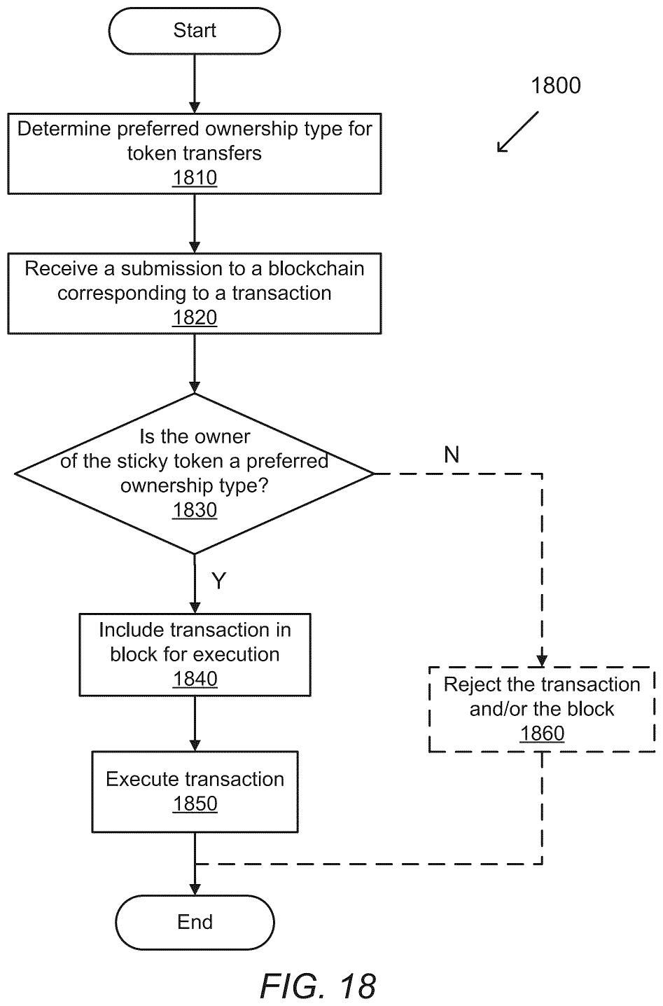

A process for performing token transfers in accordance with many embodiments of the invention is illustrated in FIG. 18. Process 1800 may be performed by entities including but not limited to blockchain nodes and/or smart contracts. Process 1800 determines (1810) a preferred ownership type for token transfers. As described above, preferred ownership types may include but are not limited to EOAs and/or smart contracts. Systems in accordance with various embodiments of the invention may be configured to determine that tokens owned by all non-preferred ownership types be considered soulbound.

Process 1800 receives (1820) a submission to a blockchain, corresponding to a transaction for processing and/or possible inclusion in a block. In accordance with various embodiments of the invention, transactions may concern but are not limited to token transfers and/or token minting. Process 1800 assesses (1830) the transaction to determine whether the token is owned by a preferred ownership type (e.g., smart contracts and/or an EOA).

When process 1800 assesses (1830) that the token is owned by a preferred ownership type, process 1800 includes (1840) the transaction in a block (of the blockchain) for execution. In such cases, the other nodes may accept the block. When the block is accepted, process 1800 executes (1850) the transaction.

When process 1800 assesses (1830) that the token is not owned by a preferred ownership type, process 1800 rejects (1860) the transaction and/or the block. In such cases, the node may personally decide whether to include the transaction in a block. When the node decides to not include the transaction in a block, the node may reject the transaction. When the node decides to include the transaction in a block, the node may include the transaction in a block and submit the block to a peer-to-peer network of blockchain nodes. Subsequently, the blockchain nodes may reject the block (i.e., for failure to comply with the requirements of instantiating the token) and the block may be rejected. In some cases, despite the token not being owned by a preferred ownership type, the blockchain nodes may nevertheless accept the block.

In multiple embodiments of the invention, smart contracts may be configured to determine when to proceed with token transactions. In some cases, this may, as above, be done through determining token ownership. In accordance with some embodiments of the invention, smart contracts (e.g., that are configured to instantiate given tokens) may determine whether message senders (msg.sender in the Solidity programming language) of transfer calls themselves possess preferred ownership types (e.g., EOAs, smart contracts). In doing so, the smart contracts may be configured to restrict the requested transactions accordingly.

For example, in many embodiments, the transfer functions of token smart contracts may check for when transfer calls come from EOAs. In such cases where they do, the token smart contracts may block the transfers. Additionally or alternatively, the transfer functions may detect that the transfer calls come from other smart contracts, in which case the token smart contracts may allow the transfer.

In numerous embodiments, the transfer functions of token smart contracts may check for when transfer calls come from (other) smart contracts. In such cases where they do, the token smart contracts may block the transfer. Additionally or alternatively, the transfer functions may detect that the transfer calls come from EOAs, in which case the token smart contracts may allow the transfer.

In miscellaneous embodiments of the invention, token smart contracts may be deployed with two (or more) classes of transfer functions. A first class of transfer functions may function for basic transfers. When token transfers occur using such transfer functions, recipients (independent of ownership type) may be able to transfer the received token(s) onwards when the token(s) are received. A second class of transfer functions, now disclosed in the present disclosure, may function as final transfers, where the recipients (again independent of ownership type) may be prevented from transferring the tokens onward. In accordance with many embodiments of the invention, this limit on transferal may take several forms, including but not limited to permanent prevention, permanent prevention subject to specific conditions being met, and/or temporary prevention (e.g., for preset durations). In accordance with some embodiments of the invention, the latter transfer functions may be associated with “sticky” token smart contracts.

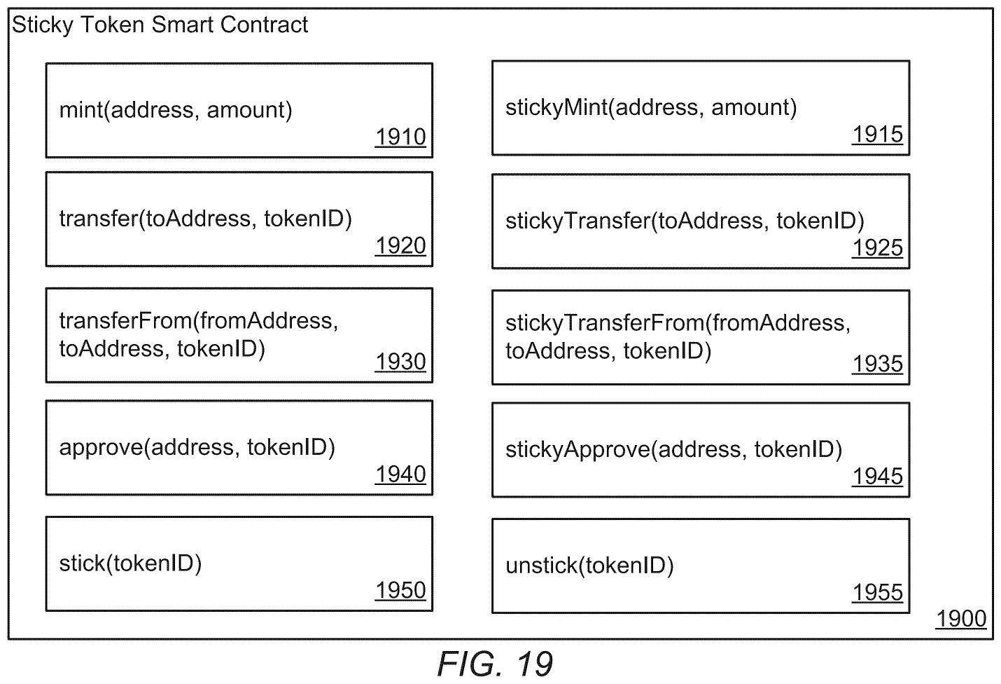

An example of a smart contract directed to sticky tokens implemented in accordance with multiple embodiments of the invention is illustrated in FIG. 19. Sticky token smart contracts 1900 may include functions for instantiating sticky tokens including but not limited to minting 1910, 1915 functions for tokens; transfer 1920, 1925 1930, 1935 functions for tokens; access right approval 1940, 1945 functions; and/or conversion 1950, 1955 functions.

In accordance with some embodiments, sticky token smart contracts 1900 may utilize minting functions used for minting various categories of tokens. In accordance with various embodiments of the invention, minting functions may take, as input, parameters including but not limited to an address parameter (address) identifying the addresses to which the tokens will be minted; and/or an amount parameter (amount) identifying the number of tokens that will be minted in a particular call. Minting functions may include but are not limited to transferable token minting functions (e.g., mint( ) 1910) for minting tokens that may, by default, be transferable. Additionally or alternatively, sticky token smart contracts 1900 may include sticky token minting functions (e.g., stickyMint( ) 1915) for minting tokens that may, by default, be non-transferable, that is, soulbound.

In accordance with multiple embodiments of the invention, sticky token smart contracts 1900 may include transfer functions for transferring various categories of tokens owned by a given party. In accordance with several embodiments of the invention, these transfer functions may take, as input, parameters including but not limited to token identifiers (tokenID) that identify the tokens being transferred in the call; and/or (recipient) address parameters (toAddress). Potential transfer functions may include but are not limited to transferable token transfer functions (e.g., transfer( ) 1920) used for tokens that may remain transferable after a (basic) transfer. Additionally or alternatively, sticky token smart contracts 1900 may include sticky token transfer functions (e.g., stickyTransfer( ) 1925) for transferring sticky tokens, i.e., tokens that may no longer be transferable after the transfer. Specifically, in accordance with various embodiments of the invention, sticky tokens may be considered soulbound after the sticky transfer.

In accordance with certain embodiments of the invention, sticky token smart contracts 1900 may, additionally or alternatively, include indirect transfer functions enabling transfers of tokens that are owned by a first party, but where the transfer is performed by approved second parties. As such, indirect transfer functions may take, as input, parameters including but not limited to token identifiers (tokenID) that identify the tokens being transferred in the call; sending addresses, identifying the address of a first party, from which the tokens will be transferred (fromAddress); and/or (recipient) address parameters (toAddress). Indirect transfer functions may include but are not limited to transferFrom( ) 1930 functions, used for tokens that may remain transferable after a transfer. Additionally or alternatively, sticky token smart contracts 1900 may include sticky TransferFrom( ) 1935 functions for enabling transfers of sticky tokens, i.e., tokens that may no longer be transferable after the transfer. As above, after a sticky TransferFrom( ) call, the tokens may be considered soulbound. In accordance with multiple embodiments of the invention, actions performed by (indirect) transfer functions may differ from transfers performed on other networks (e.g., ERC20 transfer functions on the Ethereum network). Specifically, in addition or alternative to the (recipient) address parameter, transfer functions called in accordance with some embodiments of the invention may take, as input, a (sending) address parameter (fromAddress), while having the recipient call the function.

In accordance with some embodiments of the invention, sticky token smart contracts 1900 may include approving functions, enabling the approval of second parties for transferring tokens (e.g., using indirect transfer functions). As such, approving functions may take, as input, parameters including but not limited to the address (address) of the second party being granted approval for transfers; and/or token identifiers (tokenID) that identify the tokens for which the approval is granted. Approval functions may include but are not limited to the approve( ) 1940 function, enabling approval of second parties for transferring tokens using the transferFrom( ) 1930 function (where the tokens are owned by other—first—parties). Additionally or alternatively, the sticky token smart contracts 1900 may include stickyApprove( ) 1945 functions enabling approval of second parties for transferring tokens using the sticky TransferFrom( ) 1935 functions.

In some embodiments of the invention, smart contracts may include functions for converting tokens (that have become soulbound) into transferrable tokens or vice versa. Such functions may be referred to as conversion functions. In numerous embodiments, the conversion functions may be exclusively executable by addresses granted administrator roles within the smart contracts (and/or by some other authorized party). For example, certain tokens may be transferred to smart contracts and may become soulbound to the smart contracts. Subsequently, administrators may call the conversion functions for converting the tokens to no longer being soulbound, and the smart contracts may thenceforth transfer the token(s) to other addresses and/or burn the token(s). As indicated in FIG. 19, in accordance with a number of embodiments of the invention, sticky token smart contracts 1900 may include unstick functions 1955 which may render tokens referenced by token identifiers (taken as arguments) transferable. Additionally or alternatively, sticky token smart contracts 1900 may include stick functions 1950 which may render tokens referenced by token identifiers (taken as arguments) non-transferable, that is, soulbound.

In some embodiments, the stick functions 1950 and/or unstick functions 1955 may be successfully called by one or more (external) authorized parties. In some implementations, authorized parties may include but are not limited to previous token owners, sticky token smart contract owners, designated authorities, government-appointed officials, regulatory authorities, and/or judicial authorities.

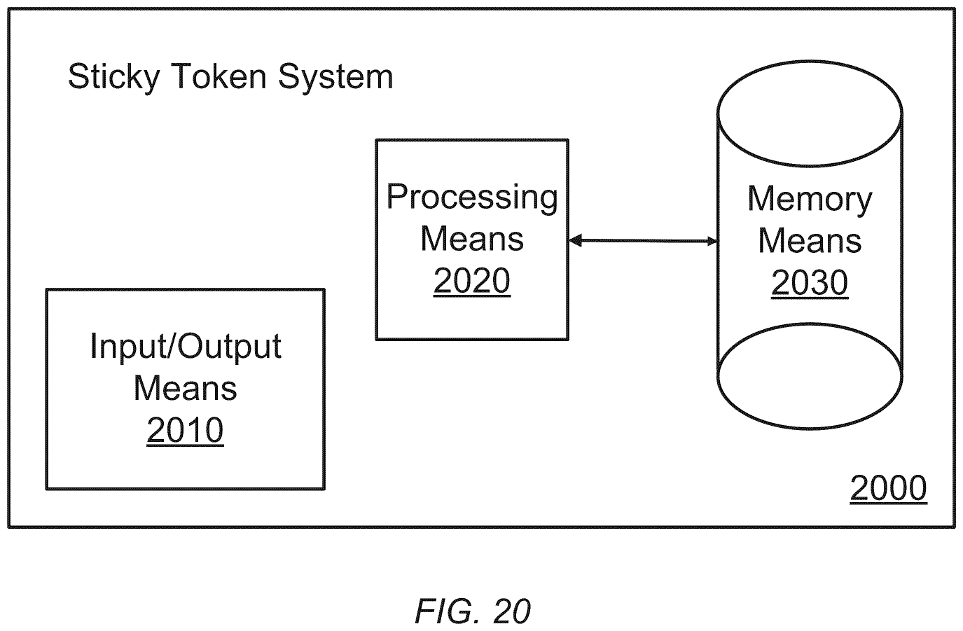

A block diagram depicting a sticky token system implemented in accordance with numerous embodiments of the invention is illustrated in FIG. 20. As mentioned above, sticky token systems 2000 may be used for transactions associated with sticky tokens. In accordance with various embodiments of the invention, such transactions may include but are not limited to one or more of instantiating sticky tokens, destroying sticky tokens, transferring sticky tokens, querying a balance state of sticky tokens, restricting a transfer capability of sticky tokens, re-enabling a transfer capability of sticky tokens, etc.

Sticky token systems 2000 implemented in accordance with various embodiments of the invention may incorporate input/output means 2010 including but not limited to receivers configured to receive information and/or transmitters configured to provide information to other units, devices and/or entities. FIG. 20 illustrates that sticky token systems 2000 may, additionally or alternatively, include processing means 2020 and memory means 2030. The memory means 2030 may include instructions, which, when executed by the processing means 2020 causes the sticky token system 2000 to perform methods configured in accordance with certain embodiments of the invention.

In several embodiments of the invention, token smart contracts (including but not limited to NFT smart contracts) may include voting functions and/or distributed autonomous organization (DAO) functionalities. Using the voting functions, opportunities to convert soulbound tokens to standard transferable tokens (or vice versa) may be enabled through votes. Such tokens may be referred to as DAO-enabled/disabled tokens.

An example of DAO-enabled/disabled tokens may be a token representing a review of a service provided by a service provider. A user of the service may wish to leave a (positive, negative, neutral) review of the service, and may do so through the use of DAO-enabled/disabled tokens. In accordance with many embodiments of the invention, users may mint (e.g., DAO-enabled/disabled) tokens representing negative (and/or positive) reviews that are transferred to addresses associated with service providers. In accordance with multiple embodiments of the invention, the addresses associated with service providers may be open to the general public (e.g., a review of a store by customers) and/or limited to certain subsets of the population (e.g., a review of a professor by students).

In cases where DAO-enabled/disabled tokens are used, the tokens may be non-transferrable, thereby allowing other users to continuously identify the (e.g., negative) reviews held by the service providers by accessing the address. When a review is negative, service providers may intend to remove the DAO-enabled/disabled token and therefore the review. Even when the review is (e.g., unjustifiably) positive, a community of service users may wish to have the DAO-enabled/disabled token and therefore the review removed. In accordance with some embodiments of the invention, individuals including but not limited to the service providers being reviewed may petition reviewers (including but not limited to the DAOs associated with the tokens) to revoke reviews. These revocations may themselves be performed through revoking the non-transferability of the tokens.

When DAOs receive petitions to revoke the non-transferability of (review-based) NFTs, their responses may be based on voting. Specifically, based on the outcome of voting, DAOs may determine whether petitions are approved. In accordance with multiple embodiments of the invention, petitions may require results including but not limited to a majority of votes in favor, unanimous assent, and/or a pre-determined fraction of votes (e.g., ⅔) in favor to be approved. When petitions are not approved, tokens may remain non-transferable (i.e., sticky). In some cases, service providers may be able to appeal this result and/or request a re-vote.

When petitions are approved, DAOs may (e.g., automatically) convert the underlying NFT(s) to be transferrable (i.e., non-sticky). In several cases, service providers may send the (now transferrable) NFT(s) to different (e.g., burner) addresses, where they are no longer publicly displayed against the (public) addresses of the service providers.

Sticky tokens implemented in accordance with many embodiments of the invention are not limited to use within NFT platforms. Accordingly, it should be appreciated that applications described herein may also be implemented outside the context of an NFT platform network architecture unrelated to fungible tokens and/or NFTs. Moreover, any of the computer systems described herein with reference to FIGS. 18-20 may be utilized within any of the NFT platforms described above.

### B. Liability Tokens

Smart contracts configured in accordance with many embodiments of the invention may be used to instantiate tokens representing liabilities on blockchains. In such cases, as above, restrictions may apply on the movement of the tokens that are non-standard, including but not limited to the registered owners being unable to transfer the tokens.

Liability tokens configured in accordance with some embodiments may comply with existing token standards including but not limited to Ethereum standards, which are incorporated by reference in their entireties.

For example, in the Ethereum blockchain ecosystem, the Ethereum Request for Comment No. 20 (ERC20) standard facilitates transferring a token with a transfer function. In an asset implementation of an ERC20 token, the transfer function may only be successfully called by the owner of the token or an approved delegate, and takes, as its arguments, an Ethereum address to send the token to, and an amount of the token to transfer. The ERC20 standard provides the following definitions for transfer functions, indirect transfer (e.g., transferFrom( )) functions, and approval functions:
function transfer (address_to, uint256_value) public returns (bool success)
function transferFrom (address_from, address_to, uint256_value) public returns (bool success)
function approve (address_spender, uint256_value) public returns (bool success)

When smart contracts include particular token (e.g., Ethereum) functions, as specified above (in accordance with the ERC20 specification) all the specified functions take the specified number of function arguments. From a technical perspective, smart contracts configured in accordance with many embodiments of the invention may thereby appear, for all intents and purposes, to comply with the (e.g., ERC20) specification.

Transfer functions in accordance with several embodiments of the invention may be modified such that certain tokens (e.g., liability tokens) may be: transferred by any address except an address of the registered “owner” of the token; and/or transferred to the address calling the transfer function. In doing so, the transfer functions may have their traditional functionality inverted. Such modifications may be used to ensure that owners of liability tokens may not transfer liability to other parties without them explicitly accepting the liability through actions on the blockchain (i.e., by a second party transferring the liability token to themselves). Additionally or alternatively, functions including but not limited to indirect functions and approval functions may be modified. For example, an address (not belonging to the token owner) calling the approve( ) function may approve a transfer of the token to the address calling the approve function. Subsequently any address may call transferFrom functions to transfer the token to the address calling the approve function.

Through these modifications, the tokens configured in accordance with many embodiments of the invention may conform to (e.g., ERC20) token standards, while providing implementations instantiating tokens to represent liabilities rather than an assets. In doing so, any first party that “owns” such tokens may not transfer them, and a second party may either transfer the tokens to themselves and/or may authorize a transfer of the tokens to themselves by a third party.

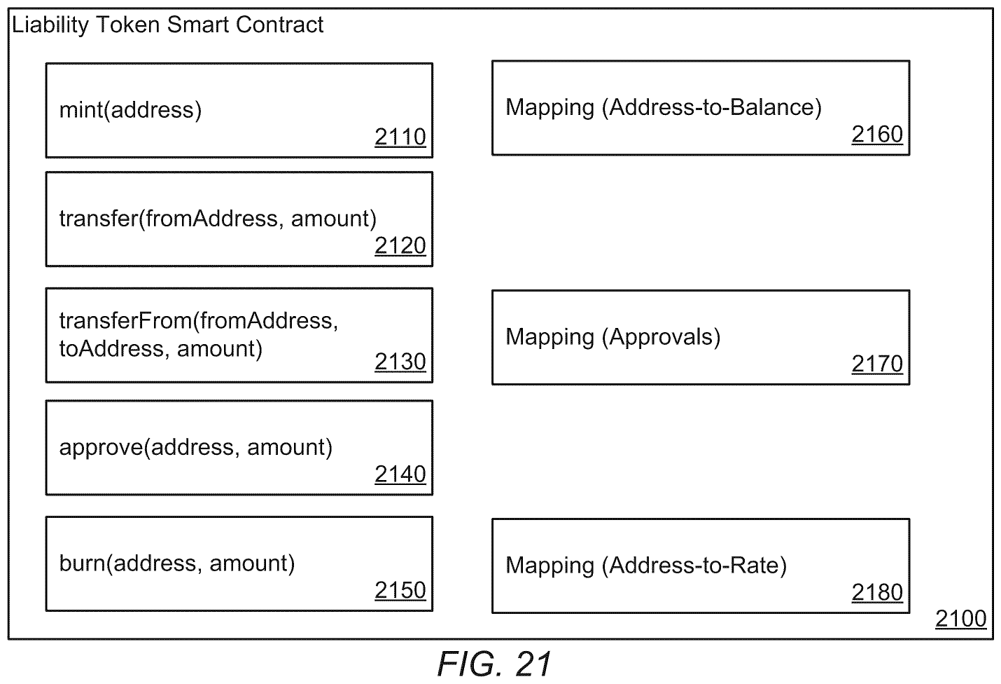

Smart contracts directed to liability tokens implemented in accordance with many embodiments of the invention is illustrated in FIG. 21. Liability token smart contracts 2100 may include functions for instantiating liability tokens including but not limited to minting 2110 functions for tokens; transfer functions 2120, 2130 for tokens; access right approval functions 2140; burning 2150 functions; and/or mappings 2160, 2170, 2180.

In accordance with some embodiments, liability token smart contracts 2100 may incorporate minting functions used for minting various categories of liability tokens. Minting functions (e.g., mint( ) 2110) may take, as input, parameters including but not limited to address parameters (address) identifying the address to which the liability tokens will be minted.

In accordance with several embodiments of the invention, liability token smart contracts 2100 may include transfer functions for transferring various categories of liability tokens owned by a given party. In accordance with several embodiments of the invention, (basic) transfer functions (e.g., transfer( ) 2120) may take, as input, parameters including but not limited to amount parameters (amount) identifying the amount of liability tokens that will be transferred in a particular call; and (sending/current owner) address parameters (fromAddress). In accordance with many embodiments of the invention, actions performed by (basic) transfer functions may differ from transfers performed on other networks (e.g., ERC20 transfer functions on the Ethereum network). Specifically, in addition or alternative to the (current owner) address parameter, transfer functions called in accordance with some embodiments of the invention may have the recipient call the function, with the fromAddress parameter identifying whose liability tokens will be transferred to them.

In accordance with certain embodiments of the invention, liability token smart contracts 2100 may, additionally or alternatively, include indirect transfer functions enabling transfers of tokens owned by a first party, but performed by approved second parties. As such, indirect transfer (e.g., transferFrom( ) 2130) functions may take, as input, parameters including but not limited to; sending addresses, identifying the address of a given owner, from which the tokens will be transferred (fromAddress); (recipient) address parameters (toAddress); and/or an amount parameters (amount) identifying the amount of tokens that will be transferred in a particular call.

In accordance with some embodiments of the invention, liability token smart contracts 2100 may include approving functions, enabling the approval of the above second parties for transferring (and/or burning) tokens (e.g., using indirect transfer functions). As such, approving functions (e.g., approve( ) 2140) may take, as input, parameters including but not limited to the address (address) of the second party being granted approval for transfers; and/or an amount parameter (amount) identifying the amount of liability tokens for which the approval is granted.

In accordance with multiple embodiments of the invention, liability token smart contracts 2100 may include burning functions that may allow approved authorities (e.g., second parties) to destroy liability tokens. As such, burning functions (e.g., burn( ) 2150) may take, as input, parameters including but not limited to amount parameters (amount) identifying the amount of liability tokens that will be burned relative to a given balance; and address parameters (address) identifying the address of the entity whose liability tokens will be burned. In accordance with some embodiments of the invention, calls to the burn( ) 2150 function may thereby permanently remove the specified amount of liability tokens from a balance of the address specified.

In accordance with some embodiments of the invention, liability token smart contracts 2100 may include various mapping data structures that may be updated in response to called functions. For example, mapping data structures implemented in accordance with multiple embodiments of the invention may include but are not limited to address-to-balance mapping 2160 data structures, approvals mapping 2170 data structures, and/or address-to-rate mapping 2180 data structures. Address-to-balance mapping 2160 data structures may be used for recording balances against particular addresses. The liability token smart contracts 2100 may update the address-to-balance mapping 2160 data structures when functions including but not limited to minting 2110 functions, transfer 2120, 2130 functions and/or burning 2150 functions are called, reflecting changes in the balances of addresses. In many embodiments, the liability token smart contracts 2100 may include approvals mapping 2170 data structures for recording which addresses given entities (via their own addresses) have received approval to move and/or destroy liability tokens for. In some implementations, the approvals mapping 2170 data structures may, additionally or alternatively, record amounts for each listed approval, specifying amounts of liability tokens that may be moved and/or destroyed by the entities. In miscellaneous embodiments, liability token smart contracts 2100 may include various statistics/summaries of transactions. For example, liability token smart contracts 2100 may include data structures including but not limited to address-to-rate mapping 2180 data structures indicating rates at which the balance of liability tokens associated with individual addresses increments over particular periods.

In accordance with many embodiments of the invention, tokens may be instantiated at a blockchain protocol level rather than through smart contracts running at the application level, as all the functionality disclosed above may equally be implemented at the blockchain protocol level.

In certain embodiments of the invention, one or more of transfer functions, indirect transfer (e.g., transferFrom( )) functions, and/or approval functions may be successfully called by addresses on allowlists. Examples of such an implementation, which are not meant to be limiting in any way, as described in co-pending U.S. patent application Ser. No. 18/323,344, titled “Systems and Methods for Facilitating Access to Token Content,” filed May 24, 2023, the disclosure of which is incorporated by reference in its entirety. In various embodiments, even when on allowlists, addresses associated with liability token owners may be prevented from calling transfer functions, indirect transfer functions, and/or approval functions to transfer liability tokens away.

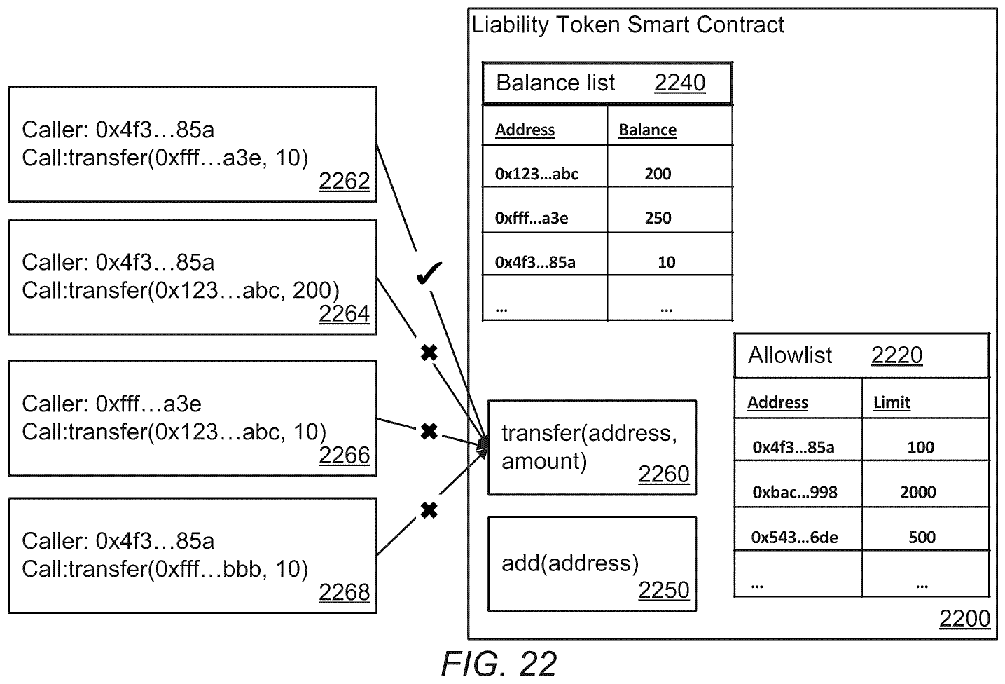

A block diagram depicting a liability token smart contract implemented in accordance with certain embodiments of the invention is illustrated in FIG. 22. In accordance with numerous embodiments of the invention liability token smart contracts may use listings and functions to govern the transferability (and/or lack of transferability) of tokens.

In a number of embodiments, liability token smart contracts 2200 may include (but are not limited to) allowlists 2220 configured to record addresses permitted to receive liability tokens. Allowlists 2220 may, additionally or alternatively, account for limits on the maximum number of liability tokens that each listed address is allowed to receive. For example, as indicated in FIG. 22, a first address on a given allowlist 2220 may have a limit of 100 liability tokens, a second address may have a limit of 2000 liability tokens, and a third may have a limit of 500 liability tokens. Addresses may be added to allowlists 2220 through add 2250 functions, representing new entities that are permitted to receive liability tokens for given liability token smart contracts 2200. In several embodiments, add 2250 functions may only be successfully called by authorized entities.

In multiple embodiments, liability token smart contracts 2200 may, additionally or alternatively, include balance lists 2240, recording balances of liability tokens for addresses. For example, the first address in FIG. 22 holds a balance of 200 liability tokens, the second address holds a balance of 250 liability tokens, and the third address holds a balance of 10 liability tokens in the balance list 2240. Those skilled in the art will appreciate that addresses and balances are provided for illustrative purposes only to provide a practical demonstration of the functionality disclosed in FIG. 22, and are not meant to be limiting in any way.

In several embodiments, as above, liability token smart contracts 2200 may, additionally or alternatively, include transfer 2260 functions taking, as input, address and amount parameters. When conditions imposed by allowlists 2220 and balance lists 2240 are met, calls to the transfer 2260 functions may be able to successfully transfer the requested amount of liability tokens from the address listed in the argument (the transferor address) to an address of the caller (also referred to as a caller address in this disclosure). Four example transactions, provided for illustrative purposes and not meant to be limiting in any way, are presented to illustrate the functionality of the transfer 2260 functions of liability token smart contracts 2200 implemented in accordance with some embodiments of the invention.

In a first illustrative transaction 2262, a caller address is 0x4f3 . . . 85a, and arguments to the transfer 2260 function are a transferor address of 0xfff . . . a3e, and an amount of 10 liability tokens. Note that:
the caller address is on the allowlist 2220;
the transferor address holds a balance (250) greater than the amount in the called function (10);
a limit in the allowlist 2220 for the caller address is 100; and
a balance in the balance list 2240 for the caller address (10) is less than the limit minus the current requested amount (100-10).
   Accordingly, the first illustrative transaction 2262 succeeds, as indicated by a check mark; a new balance for the caller address is 20 liability tokens and a new balance for the transferor address is 240 liability tokens.

In a second illustrative transaction 2264, a caller address is 0x4f3 . . . 85a, and arguments to the transfer 2260 function are a transferor address of 0x123 . . . abc, and an amount of 200 liability tokens. Note now that, although the transferor address has a balance of liability tokens (200) equal to the amount associated with the caller address on the balance list 2240, the limit in the allowlist 2220 for the caller address is only 100, which is less than the amount of 200 liability tokens. Accordingly, the second illustrative transaction 2264 fails, as indicated by a cross mark, and balances on the balance list 2240 for the caller address and the transferor address remain unchanged.

In a third illustrative transaction 2266 a caller address is 0x0xfff . . . a3e, and arguments to the transfer 2260 function are a transferor address of 0x123 . . . abc, and an amount of 10 liability tokens. The third illustrative transaction fails, as indicated by a cross mark, as the caller address is not on the allowlist 2220.

In a fourth illustrative transaction 2268 a caller address is 0x4f3 . . . 85a, and arguments to the transfer 2260 function are a transferor address of 0xfff . . . bbb, and an amount of 10 liability tokens. The fourth illustrative transaction 2268 fails, as indicated by a cross mark, as the transferor address has no balance listed in the balance list 2240.

Systems configured in accordance with some embodiments of the invention may be utilized to prevent Sybil (i.e., false identity) attacks, whereby entities remove liability tokens from their addresses by generating new throwaway addresses for the tokens to be transferred to. In particular, systems may avoid this by enacting policies such that an entity's address may not be added to the allowlist until a know-your-customer (KYC) process has been acceptably completed, determining that the address is not under the control of the owner of the liability token.

Systems configured in accordance with many embodiments of the invention may use addresses to lock amounts of cryptocurrency and/or tokens in escrow before liability tokens are transferred. In multiple embodiments, the escrow systems may be implemented using escrow smart contracts that hold escrow tokens and/or record links between the liability token(s) and the escrow tokens. Escrow smart contracts may include but are not limited to liability token smart contracts. In implementation, escrow smart contracts may include encoded terms and conditions under which the escrow tokens may be redeemed. For example, in some embodiments, escrow tokens may be released after one or more of: a predetermined period of time has passed, a payment has been made to the escrow smart contract, interest payments have been made over a term of a loan, a debt associated with the liability token is written off by a lending party, inflationary activity has reduced a value of the liability token relative to a generally accepted unit of accounting, and/or deflationary activity has increased a value of the escrow tokens in relation to a generally accepted unit of accounting.

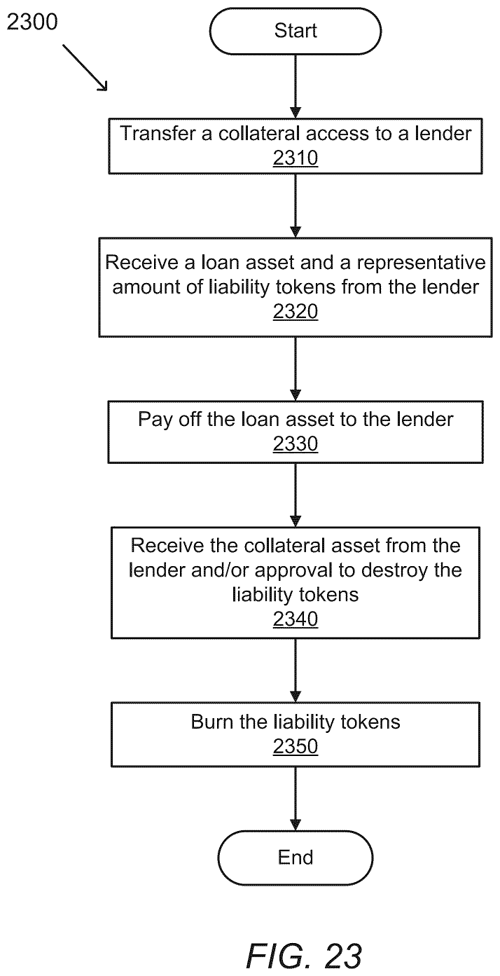

A process for utilizing a liability token smart contract, configured in accordance with multiple embodiments of the invention, with escrow and/or collateral backing is illustrated in FIG. 23. Process 2300 may be performed by terminals operated by borrowers performing asset transfers in accordance with various embodiments of the invention. Process 2300 transfers (2310) a collateral asset to a lender. Process 2300 receives (2320) a loan asset and a representative amount of liability tokens from the lender. In accordance with numerous embodiments of the invention, the amount of liability tokens transferred may correspond in value to the value of the loan asset. Loan assets may take the form of, but are not limited to, cryptocurrency, NFTs, and/or actual currency. Process 2300 pays off (2330) the loan asset to the lender. In the interim, the liability tokens may serve as an indication of the persisting debt. Process 2300 receives (2340) the collateral asset from the lender and/or approval to destroy the liability tokens. Process 2300 burns (2350) the liability tokens. Process 2300 may burn the liability tokens through methods including but not limited to transferring the liability tokens to a burn address. Through the above steps and asset transfers, life cycles of loans may be recorded on blockchains.

While specific processes are described above, smart contracts may be implemented in any of a number of different ways to enable escrow as appropriate to the requirements of specific applications in accordance with multiple embodiments of the invention. In some embodiments, steps may be executed or performed in any order or sequence not limited to the order and sequence shown and described. In various embodiments, some of the above steps may be executed or performed substantially simultaneously where appropriate or in parallel to reduce latency and processing times. In some embodiments, one or more of the above steps may be omitted. Additionally, the specific manner in which liability tokens may be utilized within NFT platforms in accordance with a number of embodiments of the invention is largely dependent upon the requirements of a given application.

In miscellaneous embodiments, liability token instantiating smart contracts may determine the balances associated with liability tokens through methods including but not limited to automatic interest rate functionality. Using this functionality, balances of liability tokens (registered against addresses) may change at rates including but not limited to fixed rates over time; variable rates over time; rates calculated using functions; rates taking (as parameters) an initial balance, an initial time, and/or a final time; etc. Systems in accordance with a number of embodiments of the invention may include balance (e.g., balanceOf( )) functions that take, as arguments, blockchain addresses and/or return current balances associated with corresponding liability tokens. Additionally or alternatively, balance functions may calculate a given current balance (B₁) under a number of formulas using variables including but not limited to rates of increase per block R, initial balance B₁ at time T₁, current time T₂, and/or the average number of seconds between consecutive blocks k. An example formula may take the form: B₂=B₁*R\hat{ }((T₂−T₁)/k). In some implementations, calls to balance functions may, additionally or alternatively, update balances as stored in the liability token instantiating smart contracts. For example, a liability token instantiation smart contract may have a record of a balance for an address A at time T₁ of B₁. When a user calls balanceOf(A) at time T₂, the balanceOf( ) function may overwrite the record of the balance for A to be B₂ with the time of the balance update stored explicitly as B₂ and/or with the time of the balance update implicitly stored based on the timestamp of a block in which the balance update transaction is recorded.

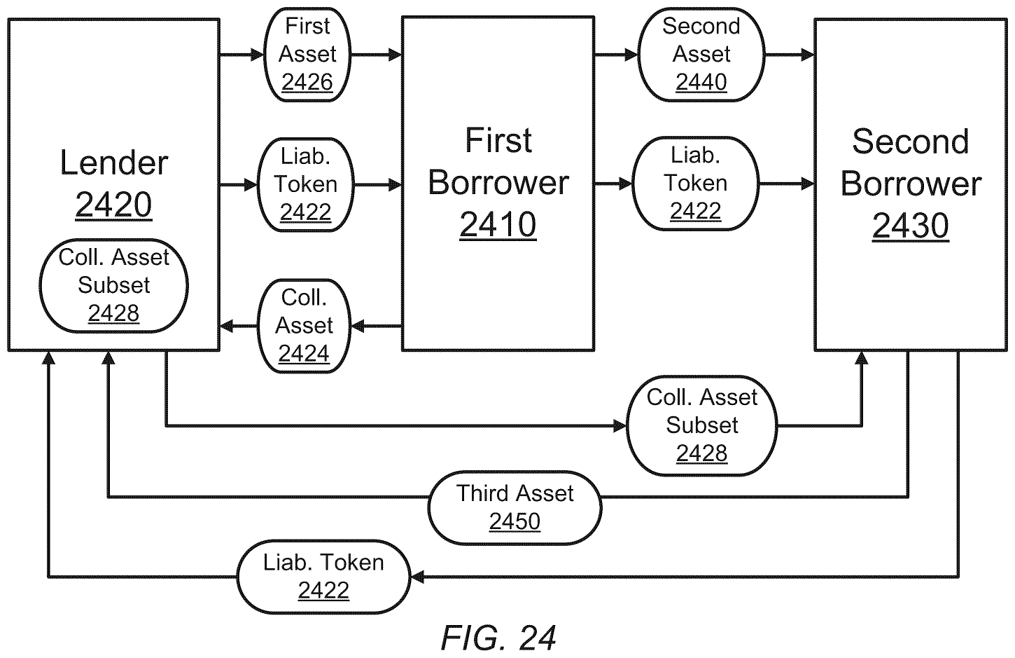

A system for utilizing a liability token, configured in accordance with several embodiments of the invention, with escrow and/or collateral backing, for interest payments is illustrated in FIG. 24. In using liability tokens, a lender 2420 may provide a loan and lend a first asset 2426 to a first borrower 2410. The debt incurred through the loan may be represented with minting and first transfer of a liability token 2422 to the borrower 2410. The first borrower 2410 may, in return, transfer a collateral asset 2424 to the lender 2420 to cover interest payments on the loan.

Over time, the various tokens and/or assets involved may be modified. For example, a quantity of the collateral asset 2424 to return on payment of the loan may decrease, as represented by a subset of the collateral asset remaining 2428 in FIG. 24. In accordance with many embodiments, loans may be transferred from the first borrower 2410 to a second borrower 2430, as indicated by a second transfer of the liability token 2422 in FIG. 24. Additionally or alternatively, transfer of the loan(s) may be accompanied by transfer of a second asset 2440, which may include some or all of the first asset 2426.

Eventually, the second borrower 2430 may pay off the loan to the lender 2420, as indicated by a third transfer of the liability token 2422 to the lender 2420. In multiple embodiments, paying off the loan may be accompanied by a transfer of a third asset 2450 which may include some or all of the first asset 2426 (e.g., the balance of the loan). In various embodiments, paying off the loan by the second borrower 2430 may result in a transfer of the quantity of collateral assets remaining 2460 to the party that paid of the loan.

In a number of embodiments, the number of borrowers involved in the system may vary. For example, the first borrower 2410 and the second borrower 2430 may be a singular entity, in such cases, the transfer of the second asset 2440 and the second transfer of the liability token 2422 may be omitted. Alternatively, systems configured in accordance with certain embodiments may include more than two borrowers, wherein the relationship between the second borrower 2430 and any subsequent borrowers may be similar to those between the first borrower 2410 (in addition to the lender 2420) and the second borrower 2430.

In numerous embodiments of the invention, liability tokens are issued in tandem with credit tokens that may be used to annihilate (e.g., burn) liability tokens under predetermined conditions. For example, certain credit tokens may annihilate liability tokens in circumstance including but not limited to: automatically when a credit token and a liability token are held by the same address, manually when a credit token and a liability token are transferred to a burning address in the same transaction, and/or when a burn function in an issuing smart contract is called with the credit token and the liability token as arguments of the burn function. Credit tokens and liability tokens may thus act in a manner similar to particles and their corresponding anti-particles in particle physics.

In some embodiments of the invention, conditions under which a liability token may be transferred may be stipulated in one or more policies. The policies may be described in policy documents that may include but are not limited to JavaScript Object Notation (JSON) files, Extensible Markup Language (XML) files, and/or digital files. In accordance with multiple embodiments, policies may be interpreted and enforced on blockchains at protocol level. Additionally or alternatively, smart contracts may be configured to interpret and/or enforce the policies described in the policies document. In accordance with many embodiments, policies may be immutable, i.e., unable to be changed once recorded on a blockchain. In various implementations, the policies may be able to be changed under certain conditions, including but not limited to: after a predetermined time has passed, on passing of a proposal to change through a vote, when modified by an approved authority, and/or other alteration conditions. In some embodiments, voting on passing proposals may take place through the use of decentralized autonomous organizations (DAOs).

In numerous embodiments, policies may specify conditions applying to liability tokens. The policies may concern (but are not limited to) one or more of: terms governing the conditions under which liability may be transferred, geographic limitations in terms of transfer, timeliness requirements for transactions, required sequences of transactions (for example before a specified time and date, after a specified time and date, within a specified time period), ordering transactions for sequences of transactions, requirements of the holders of associated resource(s) to approve the transfers, financial assurances required before permitting transfers (where such financial assurances may be functions of the resources associated with the liabilities), current holders of the resource(s) and/or of the liability, legal requirements based on the content of the resource(s), legal requirements based on the jurisdiction of the creation and/or holding of the resource, and/or the liability itself. These are non-limiting examples, as will be understood by a person of skill in the art. The policies may be encoded using one or more conditions and/or sets of instructions. Additionally or alternatively, the encoding may include reference to policies stored on blockchain. In accordance with some embodiments, policies may have machine-readable components and/or corresponding human-readable components. Policies may be selected and/or added to liability tokens by entities including but not limited to the holder(s) of the associated resource(s) and/or the holder(s) of the corresponding liability. Policies may, additionally or alternatively, be amended, modified and/or removed based on the agreement of parties that existing policies identify having the right to make such changes.

In multiple embodiments, policies may apply to sets and/or subsets of liability tokens. Global policies may apply to universal sets of all liability tokens implemented by smart contracts. Specific policies may apply to subsets of liability tokens, wherein the subsets may be determined through (but are not limited to) one or more of: properties and/or characteristics of some of the liability tokens, ownership history of some of the liability tokens, and/or some other distinguishing property/feature of some of the liability tokens.

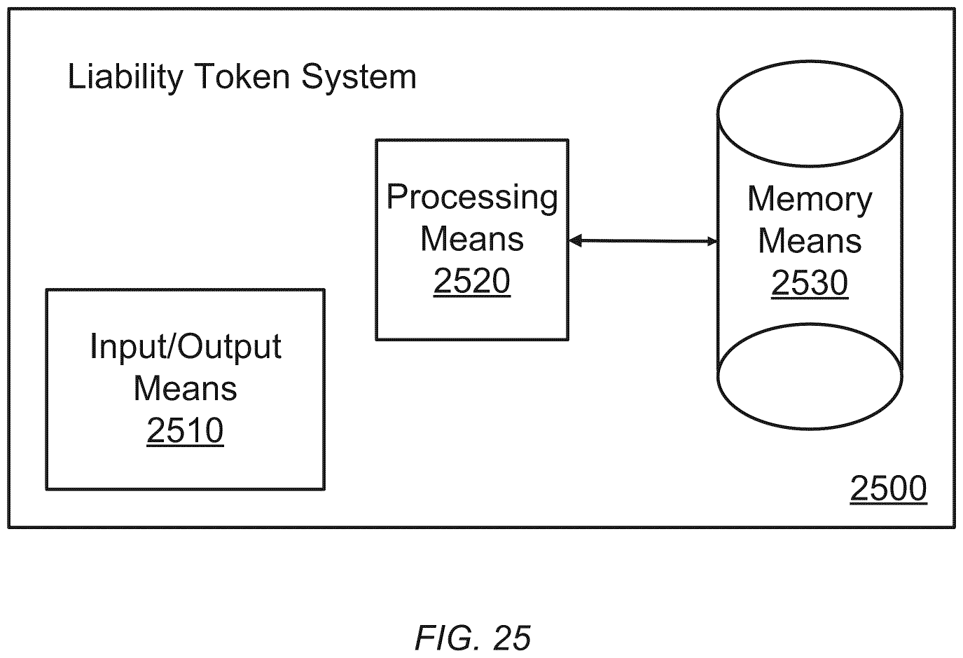

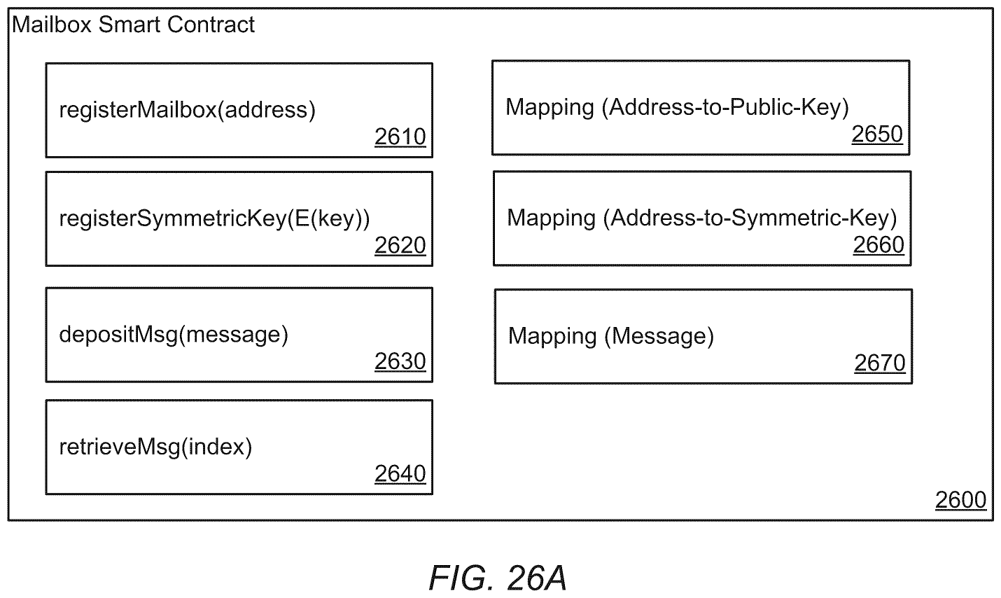

A block diagram depicting a liability token system implemented in accordance with various embodiments of the invention is illustrated in FIG. 25. Liability token systems 2500 may be used for instantiating, initiating transfers of and/or limiting transfers of liability tokens through transactions on blockchains. In accordance with various embodiments of the invention, such transactions may include but are not limited to one or more of instantiating liability tokens, destroying liability tokens, transferring liability tokens, querying balance states of liability tokens, restricting transfer capabilities of liability tokens, re-enabling transfer capabilities of liability tokens, etc.

Liability token systems 2500 implemented in accordance with some embodiments of the invention may incorporate input/output means 2510 including but not limited to receivers configured to receive information and/or transmitters configured to provide information to other units, devices and/or entities. FIG. 25 illustrates that liability token systems 2500 may, additionally or alternatively, include processing means 2520 and memory means 2530. The memory means 2530 may include instructions, which, when executed by the processing means 2520 causes the liability token system 2500 to perform methods configured in accordance with many embodiments of the invention.

In accordance with certain embodiments of the invention, liability tokens implemented as non-fungible tokens (NFTs) may represent liabilities and/or obligations on the part of entities. A given entity may issue assets, in financial, economic, virtual, and/or physical form; in doing so, they may, additionally or alternatively, issue corresponding liability NFTs representing obligations incurred by the asset. For example, a first entity may issue a physical product and may mint a liability NFT representing a warranty for the physical product. Subsequently, the first entity may pay to transfer the liability token to a second entity. Other liabilities that the liability token may represent concepts including not limited to debt, carbon debits, maintenance obligations, account auditing responsibilities, taxes, utility bills, rental payments, cooperative fees, membership fees, license renewals, vehicle inspection, safety compliance, regulations and code compliance, meeting of food and hygiene regulations, accident insurance, company insurance compliance, payment of employee benefits and pensions, meeting probation terms and conditions, etc.

In some embodiments, the liability tokens (e.g., NFTs) may be time-limited, as disclosed in co-pending U.S. patent application Ser. No. 18/323,344, titled “Systems and Methods for Facilitating Access to Token Content,” filed May 24, 2023, the disclosure for which is incorporated by reference in its entirety. For example, a liability NFT representing a warranty to repair and/or replace a product may have a time limit of validity imposed. In various embodiments, the product owners may be able to purchase extensions of the warranty periods, with the purchase of the extensions handled through smart contracts instantiating the liability tokens. This may be facilitated by the purchase being conducted using cryptocurrency and/or digital tokens of economic value.

In multiple embodiments of the invention, liability tokens may be transferred through tendering processes. An example of a possible tendering process may include (but is not limited to) a first entity providing a listing, including the liability token and a payment. A second entity may claim the listing, thus receiving the liability token and the payment.

Another possible tendering process may include an auction-like process, in which the first entity may list the liability token and/or a plurality of entities may submit payment proposals they are willing to accept (e.g., as part of receiving the liability token). In accordance with some embodiments of the invention payment proposals may be made in the form of sealed bids. Auction-like processes implemented in accordance with many embodiments may include but are not limited to reverse auctions, negative auctions, tendering processes, some other auction process, and/or a combination of some or all of the aforementioned processes. Once the auction-like process is complete, a winning entity that submitted the lowest payment may receive the lowest payment and the liability token. Other auction-like processes may include but are not limited to Vickrey auctions in which the winning entity receives a second lowest payment for accepting the liability token and/or reverse Dutch auctions, in which a proposed payment rises in value over time until a winning entity accepts the proposed payment; or some other auction process for a liability.

In certain embodiments, liability tokens may form part of an economic system when linked to (e.g., NFT-based) entitlement tokens provided to buyers. In some instances, all transactions may be implemented such that they include issuing (e.g., NFT-based) entitlement tokens. Upon acquiring and/or receiving assets (which may be digital and/or physical) buyers may, additionally or alternatively, acquire entitlement tokens. The entitlement tokens may represent entitlement to some or all ongoing products or services associated with the asset(s). As an example, presented for illustrative purposes only and not meant to be limiting in any way, an entitlement may include a replacement of the asset when the asset becomes non-functional (e.g., a product warranty). In another example, special rights may be assigned, where an entitlement assigned to a first party may correspond to a liability assigned to a second party.

Creation and/or issuance of entitlement tokens may thus be accompanied by issuance of associated liability tokens obligating delivery of the entitlement. Associated liability tokens may include but are not limited to groups of identical entitlements, for example, a generalized warranty program. In various embodiments of the invention, liability tokens may be held individually and/or may be issued in a batch. Additionally or alternatively, batches of NFTs may be owned by wrapper NFTs, as described in co-pending U.S. patent application Ser. No. 18/323,344, titled “Systems and Methods for Facilitating Access to Token Content,” filed May 24, 2023, incorporated by reference in its entirety.

In several embodiments of the invention, monetary issuing agencies (for example, a central bank and/or a national treasury) may utilize liability tokens during the issuance of currency. The agencies may issue currency tokens (for example, a stablecoin pegged to a national currency) and may simultaneously issue a corresponding liability token. Additionally or alternatively, monetary issuing agencies may auction packages including currency tokens and the liability tokens to interested parties.

Additionally or alternatively, monetary issuing agencies may auction the stablecoins and liability tokens separately. In many embodiments, the auctions may incorporate but are not limited to bidding on a rate of increase of liability for the liability tokens (as disclosed above), bidding on liability repayment schedules, and/or bidding on liability maturity times/dates. Through this, liability tokens may be used to instantiate government bonds with bespoke parameters determined through auction.

In a number of embodiments of the invention, banks may provide loans to customers as a quantity of stablecoin, and may transfer an equivalent quantity of liability tokens representing debt incurred through the loans. The liability tokens may thus function as records of a state of the loans. The customers may subsequently refinance their loans at a later date through transfers of some or all of the liability tokens to third parties. In such cases, the third parties may accept the liability tokens with payments for the acceptance and/or through incorporating issuances by the third parties to the customers of other liability tokens. In many cases, a third party may wish to accept a liability token because an interest rate for the liability token is desirable compared to current market rates.

Those skilled in the art may assume that blockchain may provide an enablement for a form of “triple-entry bookkeeping,” in which double-entry bookkeeping is extended to not just provide an indication of fraud or error, but to indicate which of fraud or error is the case, through the breaking down of accountancy silos of individual financial institutions. Transactions on a blockchain provide a form of a transaction and asset ownership ledger that may be decomposed into separate traditional asset ledgers for each participant, with added advantage that transactions are tracked across the separate traditional asset ledgers. However, conventional triple-entry bookkeeping on a blockchain is not truly triple-entry. This is because. although blockchains in their present form provide a means for recording ownership of assets and transference of said assets, blockchains do not provide a means for recording liabilities. The traditional assets ledgers decomposed from the blockchain are thus merely single-entry ledgers, and the purported triple-entry ledger is in truth a cross-organizational double-entry ledger.

It is not sufficient for debt holders to digitally sign notes of liability to be recorded, for example, on a blockchain, as there is no guarantee that these parties exist or may be held responsible to pay the liabilities. An implementation of liabilities on a blockchain requires further systems and methods to enforce responsibility and trust in relation to liabilities, and to enable transacting with liabilities in a corresponding counter-party agreed manner to transacting with assets, as disclosed in the present invention.

In various embodiments of the invention, blockchains with liability tokens may be used to implement double-entry bookkeeping systems, with the liability tokens used to record liabilities. Through using liability tokens, liability transactions may be recorded in parallel with asset transactions, thus instantiating bookkeeping following standard accounting practice. This may carry an added benefit where transactions may be tracked across a plurality of accounting books maintained by a plurality of financial entities. As assets move from a first financial entity to a second financial entity, liabilities may move from the second financial entity to the first financial entity. In multiple embodiments of the invention, two or more of the plurality of the financial entities may be the same entity, and correspondingly two or more of the plurality of accounting books may represent accounting books of a plurality of departments or divisions within the same entity. In some embodiments of the invention, on reconciliation of the plurality of accounting books, the liabilities may be destroyed in a pairwise manner.

Liability tokens implemented in accordance with miscellaneous embodiments of the invention are not limited to use within NFT platforms. Accordingly, it should be appreciated that applications described herein may also be implemented outside the context of an NFT platform network architecture unrelated to fungible tokens and/or NFTs. Moreover, any of the computer systems described herein with reference to FIGS. 21-25 may be utilized within any of the NFT platforms described above.

### C. Wallet-Based Messaging

Systems and methods in accordance with several embodiments of the invention may allow the communication of data between two or more anonymous, pseudonymous, and/or exposed parties over blockchains.

In current public permissionless blockchain systems such as Bitcoin and Ethereum, a blockchain address is derived from a public key of an ECDSA secp256k1 public/private key pair. For example, in Ethereum, the blockchain address of an externally owned account consists of the rightmost 160 bits of a Keccak256 hash of the public key and, in Bitcoin, the blockchain address is constructed using a base58 encoding of a RIPEMD-160 hash of a SHA256 hash of the public key concatenated with two bytes indicating the network and a four-byte checksum. As the blockchain address is generated using a cryptographic hash function in both cases, it is not possible to reverse-derive the public key from the blockchain address.

In accordance with some embodiments of the invention, when transactions are to be validated by blockchain validators and/or miners, they may be signed with private keys (associated with public keys and/or verified using the public keys). As such, public keys may therefore be determined from prior transactions.

Methods performed in accordance with a number of embodiments of the invention, for the purpose of ensuring that both parties of a transaction know each other's public keys, may involve (but are not limited to) conducting transactions of little-to-no value. In numerous embodiments, the transactions may be one-way (that is, from an intended recipient to an intended sender) and/or concern mutual exchanges between two or more parties. In some embodiments transactions may be conducted using zero-knowledge proofs, in which only select information is revealed, but evidence of further knowledge is provided. In some blockchain systems (for example, Bitcoin at the present time) a transaction must include a transfer of value, but this value may be as small as a single satoshi. In several blockchain systems (for example, Ethereum) a transaction may not necessarily include a transfer of value. The blockchain may then be parsed by one or more of the two or more parties for transactions to retrieve the corresponding public keys.

In certain embodiments of the invention, mailbox smart contracts may be implemented to provide drop-off points for messages generated by senders (i.e., “mailboxes”), and encrypted with public keys of receivers. In some embodiments, the messages may be encrypted with symmetric keys, which themselves may be encrypted with the public keys of the receivers. Potential drop-off point arrangements may include but are not limited to data structures within smart contracts, mutable pointers on decentralized systems (such as the InterPlanetary Name System), blockchain addresses, message structures (and/or) headers indicating transactions include mail messages, references to locations on file servers, etc.

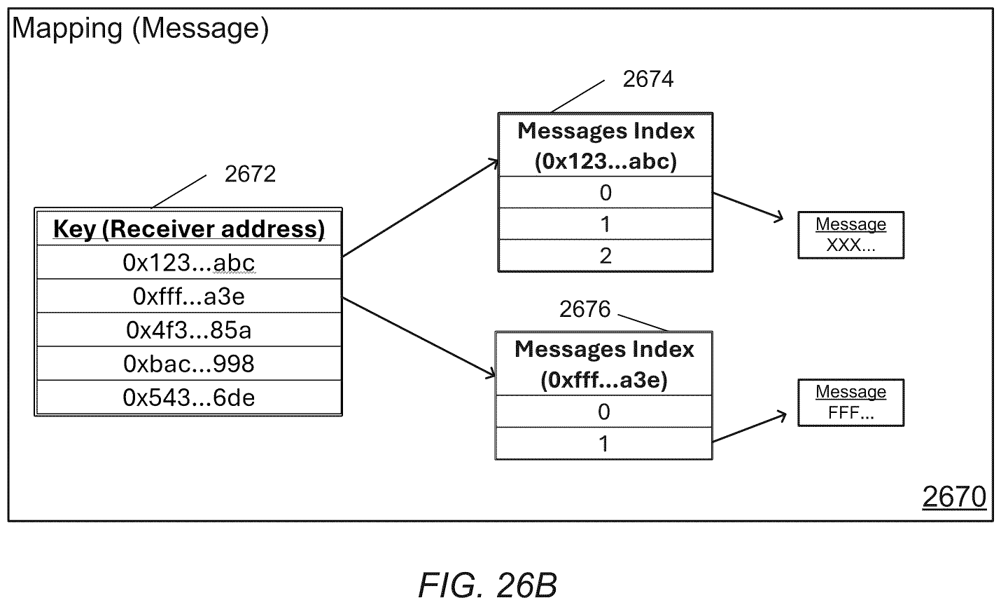

An implementation of a mailbox smart contract configured in accordance with some embodiments of the invention is illustrated in FIGS. 26A-26B. Mailbox smart contracts 2600 may incorporate functions including but not limited to address registration functions (e.g., registerMailbox( ) 2610), key registration functions (e.g., registerSymmetricKey( ) 2620), message depositing functions (e.g., depositMsg( ) 2630), and/or message retrieval functions (e.g., retrieveMsg( ) 2640). Additionally or alternatively, mailbox smart contracts 2600 may operate based on mapping data structures including but not limited to address-to-public-key mapping 2650 data structures, address-to-symmetric-key mapping 2660 data structures, and/or message (i.e., address-to-message) mapping 2670 data structures.

In accordance with multiple embodiments of the invention, the registerMailbox( ) 2610 function may take, as input, blockchain addresses, providing functionality for receivers to register the blockchain addresses and/or public key(s) (derived based on the address). In many embodiments, registerMailbox( ) may (additionally or alternatively), write entries to address-to-public-key mapping 2650 data structures, associating blockchain addresses with the corresponding public key(s). Once entries are added, address-to-public key mapping 2650 data structures may be queried with blockchain addresses to determine when mailboxes exist for the blockchain addresses. Additionally or alternatively, when mailboxes exist, address-to-public-key mapping 2650 data structures may be used to retrieve the corresponding public keys.

Mailbox smart contracts 2600 configured in accordance with various embodiments of the invention may utilize symmetric key registration functions (e.g., registerSymmetricKey( ) 2620) for providing functionality for senders to register shared symmetric keys for two or more blockchain addresses. The shared symmetric keys may be stored in address-to-symmetric-key mapping 2660 data structures. In several embodiments of the invention, symmetric keys may be encrypted (e.g., with the public key of the receiver) before being provided as parameters of the registerSymmetricKey( ) 2620 functions. In a few scenarios, the storage of symmetric keys, including but not limited to via address-to-symmetric-key mapping 2660 data structures, may be private. For example, the storage may be associated with the particular wallets of one or more users but not publicly accessible. Additionally or alternatively, storage may be done through public resources, including but not limited to blockchains. The storage may, additionally or alternatively, be done through cloud storage for which the access rights may be controlled using policies. A person of skill in the art will recognize that other types of storage may be used.

In many embodiments of the invention, key exchange protocols may take various forms. For example, they may include but are not limited to the encryption of the symmetric keys with the public key of the recipient(s) of singular blockchain transactions. Additionally or alternatively, different key exchange and/or key transport protocols may be used. In such cases, key exchanges may be implemented using a plurality of blockchain transactions. These key exchange/transport protocols may include but are not limited to Diffie-Hellman key exchanges, Elliptic-curve Diffie-Hellman key agreement protocols, etc. In some embodiments, key exchanges may, additionally or alternatively, include various stages. This may include but is not limited to authentication stages; for example, a one-way and/or bi-directional challenge-response round of transactions. In some embodiments, transactions for key exchanges and/or message delivery may include but are not limited to message authentication codes (MACs) to ensure message data integrity and authenticity.

Mailbox smart contracts 2600 may, additionally or alternatively, include functions for storing messages (e.g., depositMsg 2630) from senders that are intended for receivers. In numerous embodiments, function calls to depositMsg( ) 2630 may include, as input, encryptions of the message(s) using the symmetric key(s) and/or the original messages themselves. In some embodiments, mailbox smart contracts 2600 may store these messages in address-to-message mapping 2670 data structures. As above, the storage of (e.g., encrypted) messages may be private and/or be done through cloud storage for which the access rights may be controlled using policies. A person of skill in the art will recognize that other types of storage may be used. Systems in accordance with many embodiments of the invention may include private information retrieval protocols allowing receiving parties to retrieve database items without revealing which items are retrieved.

In multiple embodiments, the messages may include one or more of: uniform resource locators; images (for example, JPG images, GIF images, PNG images, SVG images, WEBP images, BMP images, TIFF images, and/or images of other image file formats); documents (for example, PDF files, Microsoft Word files, Apache OpenOffice files, and/or documents of other document formats), videos (for example, MP4 files, MOV files, WEBM files, FLV files, animated PNG and/or GIF files, QT files, SVI files, 3GPP files, and/or videos of other video file formats), software packages, database files, etc. In certain embodiments of the invention, messages may include but are not limited to digital vouchers and/or (other) digital credentials for retrieving data from data storage; for example, credentials for users with access to data in databases.

In accordance with a number of embodiments of the invention, mailbox smart contracts 2600 may include retrieval functions (e.g., retrieveMsg( ) 2640, for retrieving messages. In some embodiments, callers may call the retrieveMsg( ) 2640 functions through initiating transactions and/or by providing message indices (index) as parameters. In some embodiments, the callers may be one or more of: the transaction sender(s), the transaction receiver(s), and/or third parties. Once called, the mailbox smart contracts 2600 may retrieve the addresses of the callers from the transactions. Additionally or alternatively, the mailbox smart contracts 2600 may use message mapping 2670 data structures using index and/or caller address to retrieve associated messages.

An example of a message mapping 2670 data structure (e.g., the one used in FIG. 26A) implemented in accordance with certain embodiments of the invention is illustrated in FIG. 26B.

A message mapping 2670 data structure may include but is not limited to a record of keys 2672, for which each entry is a blockchain address, for example, a first blockchain address (e.g., 0x123 . . . abc), a second blockchain address (e.g., 0xfff . . . a3e), and further addresses. The first blockchain address may map to a first message index 2674, and the second blockchain address may map to a second message index 2676. In the example disclosed in FIG. 26B the first message index 2674 includes three integer entries, a first entry (index 0), a second entry (index 1), and a third entry (index 2). Additionally, the second message index 2676 includes two integer entries, a first entry (index 0) and a second entry (index 1), In accordance with various embodiments of the invention, each entry of the message index may map to one or more stored messages. In accordance with many embodiments of the invention, the messages may be stored separately from the indices. The example shown in FIG. 26B further discloses a displayed message (“XXX . . . ”) corresponding to the first entry of the first message index 2674 and a displayed message (“FFF . . . ”) corresponding to the second entry of the second message index 2676. Thus for any given blockchain address A, corresponding message index mappings may be referenced, and/or messages for blockchain address A may be retrieved by index.

Those skilled in the art will appreciate that the present figure is a specific example of data content for the message mapping data structure presented for illustrative purposes, and that it may be generalized to other data content.

In accordance with various embodiments of the invention, transactions transferring digital assets (including but not limited to Bitcoin) may be used as carriers to provide encrypted messages and/or associated details to users. For example, ordinal inscriptions may be used to send satoshis to receiver addresses, with inscription on the satoshis including the encrypted message and associated details. In multiple embodiments, ordinal inscription methods and/or commit transactions may be used for this purpose. Additionally or alternatively, systems in accordance with many embodiments of the invention may use inscription reveal transactions. In these transactions, inscribed satoshis may be transferred to recipients of inscribed messages, providing references to data on the blockchain that include the encrypted message(s) and/or associated/supplementary details. In a number of embodiments, the receipt of the inscribed satoshi by the recipient may, additionally or alternatively, provide notification that the encrypted message(s) are available for reading. Inscription of data is disclosed in C. Rodamor, Ordinals.com, “Ordinal Theory Handbook,” https://docs.ordinals.com/, the disclosure of which is incorporated by reference in its entirety.

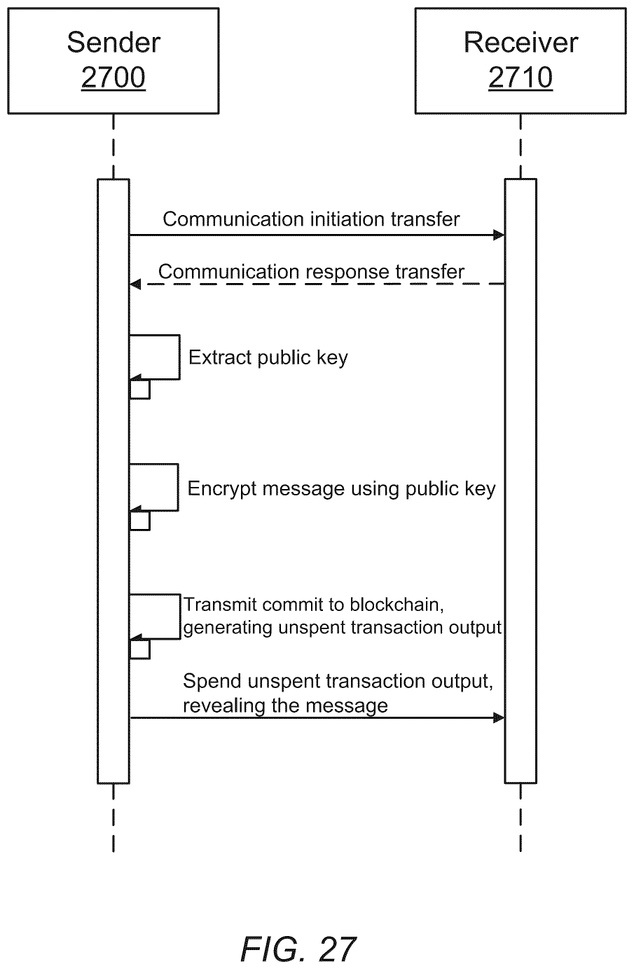

A signaling diagram illustrating a system for communicating encrypted messages in accordance with many embodiments of the invention is provided in FIG. 27. Systems in accordance with multiple embodiments of the invention may be implemented on (but are not limited to) smart-contract capable blockchains providing Turing-complete smart contracts functionality.

In FIG. 27, a message transfer between a sender 2700 and a receiver 2705 is illustrated. When the sender 2700 does not know the public key of the receiver 2705, the sender 2700 commences a communication initiation transfer to the receiver 2705. Upon receipt, the receiver 2705 responds with a communication response transfer to the sender 2700. The sender 2700 extracts the public key from the communication response transfer.

The sender 2700 may encrypt a message using the public key. As indicated above, in some embodiments of the invention, the messages may be encrypted with the public keys. Additionally or alternatively, the payload(s) of the message(s) may be encrypted with symmetric keys. Additionally or alternatively, a message may include a symmetric key, encrypted with the public key. Additionally or alternatively, payloads may be encrypted with the symmetric key(s).

The sender 2700 transmits a commit transaction to the (e.g., Bitcoin) blockchain. The commit transactions may include, but are not limited to commits to scripts including the associated messages. By doing so, the sender 2700 generates an unspent transaction output.

The sender 2700 reveals the message by spending the unspent transaction output, sending one or more units of cryptocurrency (e.g., satoshis) to the receiver 2705 in the process. These units of cryptocurrency may, in accordance with many embodiments of the invention, be sent through inscribed satoshi transfer. In doing so, the sender 2700 may reveal the script, including (but not limited to) the message on the (e.g., Bitcoin) blockchain. Through the above steps and communications the message may be stored on the (e.g., Bitcoin) blockchain and the receiver 2705 may be notified.

While specific transaction arrangements are described above, transactions can be implemented in any of many different ways to send messages as appropriate to the requirements of specific applications. In some embodiments, steps may be executed or performed in any order or sequence not limited to the order and sequence shown and described. In multiple embodiments, some of the above steps may be executed or performed substantially simultaneously where appropriate or in parallel to reduce latency and processing times. In a few embodiments, one or more of the above steps may be omitted. Additionally, the specific manner in which public keys and/or transaction requests can be utilized for messaging in accordance with numerous embodiments of the invention is largely dependent upon the requirements of a given application.

In various embodiments of the invention, blockchain wallets may include messaging components. The messaging components may include but are not limited to blockchain nodes and/or related components (e.g., components for connecting to a blockchain node). In many embodiments, the blockchain nodes may be used for parsing blockchains to detect the arrival of message transactions.

In numerous embodiments, blockchain wallets may, additionally or alternatively, include lists of blockchain addresses (e.g., to monitor for messages) and/or display components (e.g., for displaying received messages and/or keeping track of which messages are unread). The messaging components may regularly scan blockchains for the arrival of messages. Additionally or alternatively, messaging components may be configured to transfer new messages to the display component(s). The messages may include but are not limited to data extracted from message transactions and/or timestamps from blocks including the message transactions.

In accordance with various embodiments, messages received by messaging components may be encrypted. In several embodiments, the blockchain wallets may (additionally or alternatively) include decryption components. These decryption components may receive newly recovered messages from the messaging components. The decryption components may be configured to decrypt the new messages before passing them to display components.

In various embodiments, the message transactions may (additionally or alternatively) include encryption metadata providing information to the decryption components required for decrypting the messages. The encryption metadata may include but is not limited to symmetric encryption keys encrypted with public keys of recipients, encryption algorithms used, and/or other information relevant to decryption.

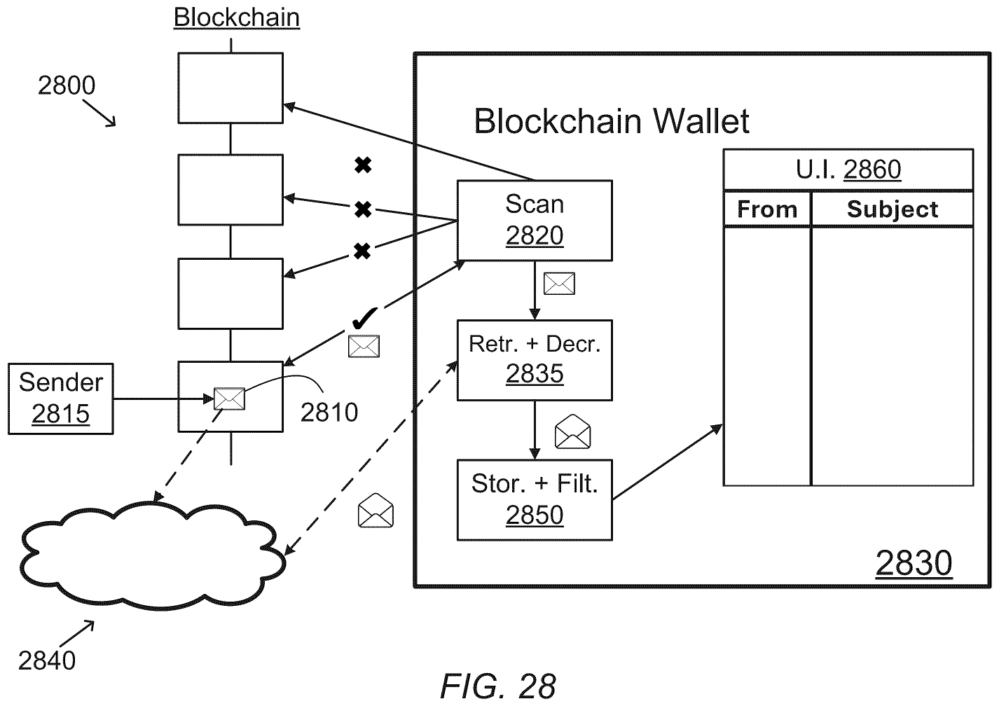

A blockchain wallet-based messaging component implemented in accordance with certain embodiments of the invention is illustrated in FIG. 28. In many embodiments, system processes may commence with a sender 2815 sending one or more message transactions 2810 for inclusion in a blockchain 2800 block to later be retrieved and processes by blockchain wallets 2830.

Blockchain wallets 2830 configured in accordance with several embodiments of the invention may include but are not limited to blockchain scanning components 2820, message retrieval and decryption components 2835, message storage and filtering components 2850, and/or message display user interface components 2860. Blockchain components may operate in various orders in accordance with multiple embodiments of the invention.

The blockchain wallet 2830 illustrated in FIG. 28 discloses a blockchain scanning component 2820 which may regularly scan the blockchain 2800 for new transactions. The new transactions scanned for, by blockchain scanning components 2820 configured in accordance with some embodiments of the invention, may include transactions specifically referencing particular user blockchain addresses. In various cases, blockchain scanning components 2820 may operate separately from the corresponding blockchain wallet(s) 2830. In their operation, blockchain scanning components 2820 may detect and retrieve (previously-sent) message transactions 2810. In the example disclosed in FIG. 28, the blockchain scanning component 2820 scans four blocks on the blockchain 2800, detecting and retrieving the message transaction 2810 from the fourth block.

The blockchain wallets 2830 may, additionally or alternatively, include message retrieval and decryption components 2835. In certain embodiments, these components may be performed by singular components and/or have distributed operations. The message retrieval and decryption components 2835 may be configured to receive the message transactions 2810 from other components (e.g., the blockchain scanning components 2820). In doing so, the message retrieval and decryption components 2835 may retrieve any messages included in the message transactions 2810 and/or decrypt the retrieved messages. As suggested in FIG. 28, the message transactions 2810 may include (but are not limited to) pointers to external locations 2840, and the message retrieval and decryption components 2835 may retrieve the message from those locations 2840.

The blockchain wallets 2830 may include message storage and filtering components 2850. In some embodiments, operations may be performed by singular components and/or be distributed. As above, the message storage and filtering components 2850 may receive decrypted messages from other components (e.g., the message retrieval and decryption components 2835). The message storage and filtering components 2850 may, additionally or alternatively, store the decrypted messages (along with any supplementary data) for each message received. Supplemental data for given received messages may include but are not limited to whether the message has been read, whether the message should be displayed, whether the message has been classified as spam, any payment amount received with the message, any token type used for received payment amounts, and/or other metadata indicating a current status of the message.

The blockchain wallets 2830 may incorporate message display user interface components 2860. In various embodiments, operations may be performed by singular components and/or be distributed. The message display user interface components 2860 may retrieve and/or receive messages and supplementary data from other components (e.g., the message storage and filtering components 2850). Based on the message data and/or supplementary data, the message display user interface components 2860 may display some or all of the messages for user review. In accordance with various embodiments, the messages may be ordered and highlighted based on the supplementary data for each message.

In accordance with many embodiments of the invention, message display user interface components 2860 may keep records of which messages have been viewed, and which have not. In numerous embodiments messages that have been previously viewed may be displayed in different formats to messages that have not. For example, previously viewed messages may be displayed in a normal-weight font, and other messages may be displayed in a bold-weight font.

Blockchain messaging systems configured in accordance with numerous embodiments of the invention may be configured to provide spam protection. As sending a transaction including a message may require the payment of a transaction fee for a miner or validator to include the transaction in the blockchain, a base level of spam protection is provided for the system as each message requires a small charge to be paid for sending.

In various embodiments, blockchain wallets may include settings specifying payment requirements. For example, these payment requirements may refer to a minimum payment required for the blockchain wallets to retrieve and display the messages. In various embodiments, the minimum payments may be required to go to the address(es) owned by the recipient(s), thus implementing a “pay to be read” system.

In multiple embodiments, the displaying of certain messages may be configured with a plurality of settings. The user interface of the blockchain wallets of the recipients may display messages in a predetermined order with some messages not being displayed at all. Which messages (of a message transaction) to display may be based on (but are not limited to) established prior relationships with the senders, amount of payment, whether the payment is made using specified tokens, how many payment transactions are involved, whether the sender and/or receiver addresses are listed on a banlist/allowlist, and/or any metric/threshold for displaying and ordering messages. In numerous embodiments, the user interface may include interface elements enabling the users to adjust and/or select which parameters to use for determining the displaying and ordering of messages.

For example, in one implementation, a user may select that messages accompanied by a payment less than 0.0001 ETH will not be displayed by the user interface unless coming from an address in the user's address book. Additionally or alternatively, the user may select that messages accompanied by payments of more than 0.0005 ETH are displayed at the top of the message list, ordered by the size of the payments. Additionally or alternatively, a user may require a message to be accompanied by a transfer of a stablecoin, for example, USDC, to be displayed, with a requirement that the transfer exceeds 0.05 USDC.

In miscellaneous embodiments of the invention, banlists (and/or allowlists) may be provided to the blockchain wallets (e.g., by third-party service providers). In such cases, blockchain wallets may be prevented from displaying messages originating from blockchain addresses on the banlist. In some cases, this limitation may be conditional; for example, some blockchain wallets may not display messages from banlisted addresses unless accompanied by a payment in a token valued at more than a certain value (e.g., $100) at the time the particular message is detected. Blockchain wallets implemented in accordance with multiple embodiments may be configured to detect message transactions, retrieve the amount (e.g., tokens and/or cryptocurrency) accompanying the constituent messages, determine (e.g., via querying an exchange application programming interface) a current currency value of the amount of currency, evaluate the amount relative to a particular threshold, and/or (when the value exceeds the threshold) display the message.

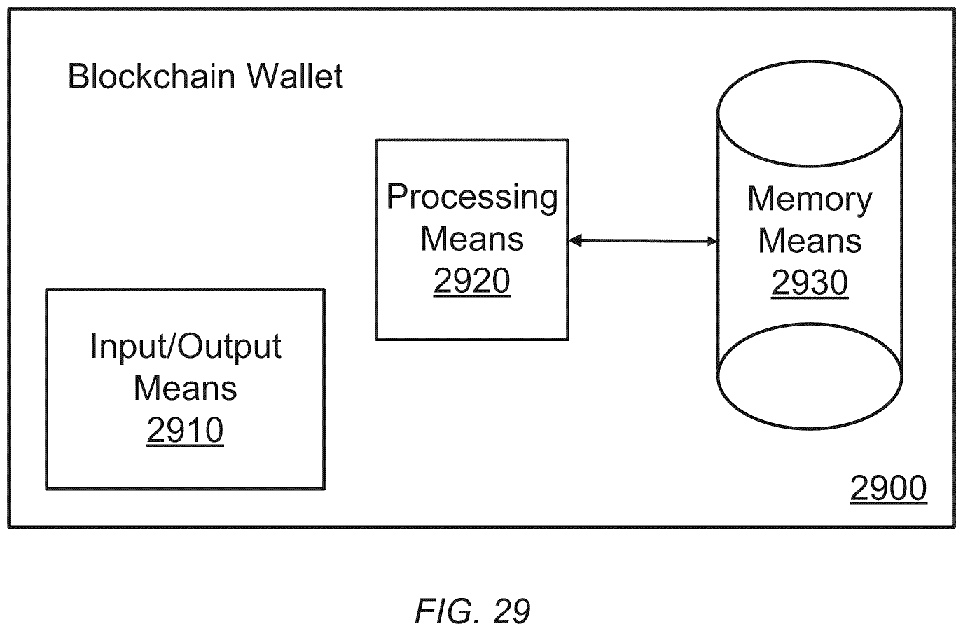

A block diagram depicting a blockchain wallet implemented in accordance with various embodiments of the invention is illustrated in FIG. 29. In accordance with some embodiments of the invention, blockchain wallets 2900 may be configured for retrieving and displaying messages mediated through transactions on blockchains. In such cases, the transactions may include messages and/or pointers to messages. Blockchain wallets 2900 implemented in accordance with various embodiments of the invention may incorporate input/output means 2910 including but not limited to receivers configured to receive information and/or transmitters configured to provide information to other units, devices and/or entities. FIG. 29 illustrates that blockchain wallets 2900 may, additionally or alternatively, include processing means 2920 and memory means 2930. The memory means 2930 may include instructions, which, when executed by the processing means 2920 causes the blockchain wallets 2900 to perform methods configured in accordance with certain embodiments of the invention.

In various embodiments of the invention, message transactions may include pointers to off-chain locations of messages. In doing so, users may be able to avoid any written messages being rendered permanently visible by blockchain immutability. Additionally or alternatively, the pointers and/or the messages may be encrypted in the off-chain locations. Potential off-chain locations may include but are not limited to web servers, file servers, cloud storage systems, decentralized file storage, network databases, and/or other (de) centralized data storage system(s).

In multiple embodiments of the invention, messages may be sent to multiple recipients, for example, through blockchain transactions with a plurality of recipients.

In a number of embodiments of the invention, using Bitcoin, senders may submit transactions including multiple recipient Bitcoin addresses and/or payments (with additional data including messages and/or pointers to messages). In several embodiments, each recipient of the plurality of recipients may receive a predetermined amount of Bitcoin corresponding to an amount equal to or above a threshold (e.g., a threshold set by the recipient for spam protection).

In many embodiments, senders may submit transactions including messages and arrays of Ethereum addresses to smart contracts on the Ethereum blockchain (and/or equivalent Ethereum Virtual Machine-compatible blockchains). In some cases, smart contracts may emit events on the blockchain including but not limited to Ethereum addresses of a plurality of recipients. Each blockchain wallet of each of the plurality of recipients may detect the emitted event(s) and/or a subset of the emitted events, with the events referencing addresses in one or more of the constituent blockchain wallets. In doing so, recipients may be able to retrieve and display the message(s) in the aggregate.

Additionally or alternatively, senders may submit transactions including messages and arrays of Ethereum addresses to smart contracts on the Ethereum blockchain. Smart contracts configured in accordance with some embodiments of the invention may transfer a small amount of ETH to each address in an array, thus providing an alert (to each of the blockchain wallets including an address in the array) that the messages have been sent. In numerous embodiments, blockchain wallets may subscribe to mailing smart contracts, labeling Ethereum addresses of the mailing smart contracts as a mailing service. Subsequently, any transaction sent by the mailing smart contract address to an address of the blockchain wallets may be interpreted by the blockchain wallets as alerts of the presence of messages for the addresses of the blockchain wallets in the mailing smart contracts.

With the methods and systems disclosed herein, senders may determine the addresses of the owners of NFTs (even when unregistered on the corresponding NFT marketplace). In doing so, senders may be able to send messages to owners: for example, to make a purchase offer on an NFT, to inquire about an NFT, etc. In accordance with multiple embodiments of the invention, the NFT owner may not need to be a person or an organization. For example, such systems may work even with owners that are DAOs and/or tokens, as disclosed in co-pending U.S. patent application Ser. No. 18/323,344, titled “Systems and Methods for Facilitating Access to Token Content,” filed May 24, 2023, the disclosure for which is incorporated by reference in its entirety. In accordance with certain embodiments, sending messages to owners may be used to pass information to token and/or associated processes. Whether the owner is a token, a process, a person or an organization—or a collection of one or more of such entities—the messages may include human-readable components and/or machine-readable components. Examples human-readable components may include but are not limited to text documents and/or images. Examples of machine-readable components may include but are not limited to segments of executable code; references to documents, tokens, segments of code, segments of byte-code segments of compiled machine code; smart contracts; and/or libraries used in smart contracts. Thus, messaging may be used for process-to-process communication for tokens to interact with each other. There are many applications of such interactions, including but not limited to creating complex systems from simple components; static and/or dynamic composition of components; creation and maintenance of trusted code libraries; automated trade; AI-managed data discovery (wherein one or more of the tokens involved in the interaction may be guided by AI; etc.

In numerous embodiments, the messages may cause the transfer of one or more resources, including but not limited to tokens; and/or access, identity, and/or ownership rights. In accordance with various embodiments, access rights, identity rights, and/or ownership rights, may include one or more of: digital rights management (DRM) related to proprietary content; access to data stores; execution rights to software as a service; rights pertaining to deletion and/or modification of data; compliance with data regulations such as the European Union General Data Protection Regulation (GDPR) and/or corresponding data protection legislation; action on compliance with Anti-Money Laundering (AML) and/or Know Your Customer (KYC) legislation; etc.

Messaging configurations implemented in accordance with multiple embodiments of the invention are not limited to use within NFT platforms. Accordingly, it should be appreciated that applications described herein may also be implemented outside the context of an NFT platform network architecture unrelated to token transactions. Moreover, any of the computer systems described herein with reference to FIGS. 21-29 may be utilized within any of the NFT platforms described above.

### D. Escrow Authorities

Transfers of access rights (e.g., sale of tokens) naturally may be done for reasons of escrow. For instance, escrow may be used where issues of trust exist where a first party owns and/or controls a first token; a second party owns and/or controls a second token; the first party and the second party wish to perform an exchange; the exchange would result in the first party owning and/or controlling the second token; and/or the exchange would result in the second party owning and/or controlling the first token.

In cases like the above, one or more of the parties to potential transactions may temporarily transfer their token(s) to an escrow entity. In accordance with multiple embodiments of the invention, escrow entities may include but are not limited to tokens, companies, and/or programs. Escrow entities may be associated with policies governing the conditions where ownership and/or control of each token may change. Potential conditions may include but are not limited to: the time by which the escrow entities must receive the token(s) owned by the each party with instructions and/or policies to forward the token(s) to the opposing party. Policies governing escrow-based transactions may include but are not limited to deadlines and/or other conditions for when to reverse the transactions (e.g., within a day when the escrow entity does not receive the promised value from each party). In accordance with numerous embodiments, escrow entities may be audited by anybody wishing to determine that they are legitimate.

Legitimacy may be determined by auditing entities that determine whether the escrow entities embody the instructions governing their functionality and/or whether the pre-determined instructions (and/or functionality) pass scrutiny. In some embodiments, legitimacy may be established through (e.g., automated) auditing of the escrow entities. Such auditing may be used to evaluate whether the auditing entities comply with functional specifications; correspond to legal requirements; and/or other auditing requirements.

Additionally or alternatively, auditing may be performed through deterministic code and/or AI parsing the code corresponding to the escrow entities, and determining whether the escrow entities implement viable escrow functionality or not. In many embodiments of the invention, code and/or instructions guiding/disclosing the functionality of the escrow entities may be placed on tokens (e.g., on blockchain). In numerous embodiments, the “functionality” tokens may be transferred to entities corresponding to processes located in the IPFS (Inter Planetary File System). In such cases, the names and/or hashes of the code for the processes may determine where the functionality tokens are stored. Additionally or alternatively, code/instructions governing operation may be certified by one or more trusted entities, digital signatures, and/or other indications of approval associated with the code/instructions.

Escrow configurations implemented in accordance with certain embodiments of the invention are not limited to use within NFT platforms. Accordingly, it should be appreciated that applications described herein may also be implemented outside the context of an NFT platform network architecture unrelated to token transactions. Moreover, any of the computer systems described elsewhere may be utilized within any of the NFT platforms described above.

### NFT Platform Token Abuse Protection

One aspect of the disclosure is a method of receiving, using a user interface (UI), at least one user selection and/or specification related to at least one policy, the at least one policy governing the conditions under which actions may be taken related to one or more tokens, where example actions include but are not limited to the transfer of ownership and changes of accesses rights related to resources associated with the one or more tokens. The one or more policies, and/or references to these, are transmitted to a wallet entity. Example wallet entities include services such as Binance™ and hardware wallets such as Trezor™, but also includes software wallets implemented as apps, whether with trusted computing platform (TPM) support and/or not. Such apps can be executed on mobile devices and/or other consumer computing devices and/or enterprise computers, including servers. An example TPM is TrustZone. The wallet entity associates the one or more policies with one or more tokens, e.g., according to a user selection of the one or more tokens. The association can be performed, for example, by wrapping the one or more tokens, whether individually and/or collectively, with a contract that includes and/or refers to the one or more policies. As the wallet entity receives an instruction to perform an action to a token belonging to the one or more tokens associated with the one or more policies, the one or more policies are evaluated to determine whether the action is permitted. The determination may utilize additional inputs, e.g., user inputs, inputs from an oracle (such as information related to the date and/or time), and/or inputs provided using a sensor associated with a user device, where an example sensor is a biometric sensor such as a fingerprint sensor and/or one or more cameras used to perform a facial recognition of a user. The inputs may come in part from users without access to the account including the one or more tokens of the wallet entity, e.g., from a designated friend of the user with such access. The input may include one or more time indications, e.g., to implement a delayed execution of the requested action, e.g., a delay of 24 hours, where such a delay can be specified in the one or more policies.

Example policies that can be selected, created and/or configured, include but are not limited to:
Access to content associated with a token is limited to users that satisfy a policy including using a device with a qualifying digital rights management unit, and with an access credential matching one of the permitted credentials indicated by the policy. The access credential may relate to being a particular individual, having a subscription of a particular type, owning a token of a specified type, and/or matching criteria of pre-specified types such as age and/or residency. Users (and their devices) not matching such policies may not access the content associated with the token, but may optionally, based on other policies, have the right to own such tokens.
A token can only be transferred to a user and/or account satisfying a given requirement, such as a user on a specified list of users, which may be co-workers at an enterprise, family members, other residents within the same jurisdiction, people who have purchased tokens from the current owner at a previous time, users who have been on a whitelist associated with the current owner of the token for at least 48 hours, users who are certified by a trusted third party as being trusted, e.g., based on having been audited, having purchased a bond, having a reputation exceeding a threshold value, etc.
A token can only be transferred away from the current owner after the current owner approves the transaction using a biometric-protected service of a trusted computing device associated with the current owner; this may be a phone satisfying some minimum requirements that may be specified in the policy.
One policy may indicate velocity constraints, e.g., when a certain number and/or value of transactions are requested within a given timeframe, then a certain action is required, where this action may be a mandatory waiting period, a requirement for the user to approve the transaction using a secure device, etc.
Some policies may state the need to perform additional actions, e.g., by the party owning the token(s) before the action, and/or by a party that is a beneficiary of the requested action. An example additional action may be the payment of a royalty, the establishment of an ownership record in a database and/or escrow entity, etc.

A first token and/or first token amount owned by a first entity may be transferred to a smart contract, with the smart contract subsequently issuing a second token and/or second token amount. The second token and/or second token amount is commonly referred to as a wrapped instance of the first token and/or first token amount if, on returning the second token and/or second token amount to the smart contract, the first token and/or first token amount is automatically returned. The second token and/or second token amount may be transferred to a second entity, and on returning the second token and/or second token amount to the smart contract by the second entity, the second entity may receive the first token and/or first token amount in return. In some embodiments:
the first token may include a non-fungible token and the second token may include a non-fungible token,
the first token may include a non-fungible token and the second token may include a fungible token,
the first token amount may include a quantity of a fungible token and the second token may include a non-fungible token, and/or
the first token amount may include a quantity of a fungible token and the second token amount may include a quantity of a fungible token.

The second token and/or amount of token may thus represent the first token and/or amount of token, with the first token and/or amount of token acting as an underlying asset. The second token and/or amount of token may then be subject to restrictions, verification processes, and/or other processes embodying one or more security policies. In some embodiments, the one or more security policies may be implemented within a smart contract, for example, the smart contract, a smart contract library, a second smart contract, and/or a constellation and/or collection of smart contracts. In other embodiments the one or more security policies may be implemented off-chain, that is, in code stored and executed independently from a blockchain. In yet other embodiments, the security policies may be implemented in a hybrid manner, with some functionality implemented on-chain in one or more smart contracts, and some functionality implemented off-chain.

In an exemplary embodiment, presented for illustrative purposes only, and not meant to be limiting in any way, a first smart contract may implement an authentication token distributed to a set of users, with a user being required to complete a know-your-customer (KYC) process before receiving the authentication token. The KYC process may include providing identifying information, such as a scan and/or photo of a passport, a utility bill, information regarding prior residence addresses and employment, biometric information such as one or more photos of the user's face, hand, eyes, bank account information, etc. Such information is used to verify the identity of the user, and/or aspects of the user's such as age, rights to drive a vehicle, citizenship, gender. The KYC process may also involve a user authenticating to a device with access to a soul-bound token, e.g., a token tied to the user by means of biometrics, wherein the soul-bound token has been associated by a trusted authority to one or more predicates, such as an identity, an age, an address, a phone number, a social security number, a residency permit, a birth date, etc. In some instances, the disclosure of KYC information is limited to a required minimum, e.g., membership in a specified organization, access rights to a given resource, etc. Some received KYC data may include escrow data and/or references to escrow data, where the escrow data includes encrypted identifying information, and where the escrow data can be decrypted only by one or more trusted parties, and potentially, only when some policy is satisfied. Subsequently to receiving optional KYC data, a security protocol implemented in a second smart contract may restrict and/or provide functionality available to users based on whether a given user does and/or does not own an authentication token.

The second smart contract may issue a wrapped token and/or wrapped tokens to users on receipt of an amount of a popular known token, for example, an amount of an ERC20 token, said wrapped token and/or wrapped tokens being directly exchangeable for the amount of the ERC20 token.

A token may be wrapped in a smart contract and/or otherwise associated with a smart contract where the smart contract requires an owner to perform an action to disassociate the smart contract from the token, where the smart contract may prevent any transfers to take place, and/or limit the size of the transfers according to a policy associated with the smart contract. This policy may specify a maximum amount that may be transferred from a given address and/or wallet within any given 24 hour period, for example. To remove and/or disassociate the smart contract with this limiting functionality from the token, a user may be required to pass a test, such as providing a proof of identity to the wallet and/or exchange. The proof may be based on KYC data, including biometric identification. In some instances a proof may be a zero-knowledge proof of knowledge, e.g., of a private key possessed by a wallet associated with the smart contract, where the private key possessed by the wallet is only used in such a proof after the wallet and/or a device associated with the user has successfully verified the user's identity, e.g., by biometric verification, knowledge based authentication such as a PIN and/or a password, the possession of a token, and/or a combination of available methods to assert identity. A token can be wrapped using a multiplicity of smart contracts, each such smart contract associating limitations and functionality with the token. One smart contract may also be used to wrap multiple tokens in a manner that associates these tokens with each other.

The wrapped token and/or wrapped tokens may be subject to one or more security policies. In an embodiment, presented for illustrative purposes only and not meant to be limiting in any way, a transfer function for the wrapped token and/or wrapped tokens may be subject to transfer limitations, for example but not limited to, a maximum amount that may be transferred in a predetermined time period. For example, a user may wrap 100 tokens, receiving 100 wrapped tokens. Subsequently, the user may be restricted by the security policy of the wrapping contract to only transferring 10 tokens in any given 24 hour period. Thus transferring all 100 wrapped tokens would take over 216 hours.

In another embodiment, there may be a maximum amount of underlying wrapped tokens may be unwrapped in a predetermined time period by the security policy. For example, a user may wrap 100 tokens, receiving 100 wrapped tokens. Subsequently, the user may be restricted by the security policy of the wrapping contract to only unwrapping 1 wrapped token per hour. Thus unwrapping all 100 wrapped tokens would take over 99 hours.

A process for securing transactions performed in accordance with multiple embodiments is illustrated in FIG. #30. The figure discloses a flow chart #3000 illustrating an exemplary embodiment of the present disclosure. Actions may commence with an owner transferring an amount of tokens to a smart contract, as illustrated in step #3010.

Actions may then proceed to step #3020, in which the smart contract transfers an amount of wrapped tokens to the owner. In some embodiments, the wrapped tokens may represent the amount of tokens, either through a proportionally equivalent amount of fungible tokens and/or one or more non-fungible tokens.

Actions may then proceed to step #3030, in which the owner submits a transaction including an action on the wrapped tokens to the smart contract.

Actions may then proceed to step #3040, in which the smart contract may determine whether the action complies with a security policy.

When the action complies with the security policy, actions may proceed to step #3050, in which the smart contract may accept the transaction and perform the action.

When the action does not comply with the security policy, actions may proceed to step #3060, in which the smart contract may reject the transaction and not perform the action.

While specific processes are described above, transaction security may be applied in any of a number of different ways as appropriate to the requirements of specific applications in accordance with many embodiments of the invention. In various embodiments, steps may be executed or performed in any order or sequence not limited to the order and sequence shown and described. In numerous embodiments, some of the above steps may be executed or performed substantially simultaneously where appropriate or in parallel to reduce latency and processing times. In some embodiments, one or more of the above steps may be omitted. Additionally, the specific manner in which tokens may be utilized within NFT platforms in accordance with a number of embodiments of the invention is largely dependent upon the requirements of a given application.

A configuration of smart contract interactions performed in accordance with many embodiments of the invention is illustrated in FIG. #31 a block diagram illustrating an exemplary embodiment of the present disclosure is presented. A smart contract #3110 may be used to enforce a security policy #3150 on transactions relating to a token. An owner #3100 of an amount of tokens #3120 may transfer the amount of tokens #3100 to the smart contract, and may receive an amount of wrapped tokens #3130 in return, said wrapped tokens #3130 representing a claim to the amount of tokens #3120.

Subsequently, the owner #3100 may wish to transfer the amount of wrapped tokens, as shown in transaction #3140, to a recipient #3170. The security policy may example the transaction #3140, and when the transaction #3140 is approved, may transfer the wrapped tokens to the recipient, as shown in transaction #3160.

The recipient #3170 may then wish to unwrap the wrapped tokens, as indicated by transaction #3180. Again, the security policy #3150 may examine the transaction #3180, and when approved, the smart contract #3110 may transfer an amount of tokens #3190 equivalent to the amount of tokens #3120.

In some embodiments, an action may be taken by the first smart contract only when authorized and in compliance with the security policy. Compliance may be determined on-chain by smart contracts, off-chain, and/or in a hybrid manner. In some embodiments, a transaction may include the action, and the transaction may be signed using a private key controlled by an owner of the second token and/or second token amount. In other embodiments, authorization may be provided through an action statement including a description of the action that is signed off-chain using the private key controlled by the owner of the second token and/or second token amount, and the action statement may be submitted to the smart contract and/or contracts through a transaction provided by a third party, with a signature of the action statement verified on-chain by the smart contract and/or contracts. In some embodiments, the third party may be a designated authority for assessing risks associated with the action statement and/or verifying that the action statement complies with the security policy.

Another embodiment applies the policies at a wallet level instead, whether the wallet is a hosted service and/or a client-side process. The latter may run on a general-purpose computing device, including a smartphone, a tablet, a laptop, a desktop and/or a wearable device, and may either be software-only and/or have special-purpose hardware support, such as a trusted computing platform (TCP). Another example of special-purpose hardware is a software implementation that is protected from abuse by hardware constraints, such as a secure enclave, TrustZone™, etc. When policies are applied to a wallet, this can be done by associating these one or more policies with one or more tokens that are accessible from the wallet, wherein these policies will be evaluated as a request is made to perform an action related to the tokens. However, when these same tokens are accessible from other wallets, where these other wallets are not associated with the protective policies, then the protection only applies to accesses via the wallets that are protected. The use of wallet-centric theft protection, however, has benefits in contexts where the adversary has limited capabilities and/or knowledge, and may be useful, for example, to easily apply protective policies in contexts involving limitations applied to minors by their guardians, and/or limitations applied to employees using enterprise-issued devices hosting the wallets where these limitations are applied by the employer and/or a representative thereof. In some contexts, some policies are applied to the tokens, e.g., by wrapping, whereas others are applied to the wallets. In yet other cases, a first wallet may have a first policy applied to a given token whereas a second wallet may have a second policy different from the first policy applied to the same given token. Such wallet-based distinctions can also be implemented, e.g., using wrapping, where the conditions associated with the policies may include information that is specific to the wallet from which the request comes. For example, a parent-operated wallet may permit immediate access to a token, optionally with the requirement for biometric identification of the user, whereas a child-operated wallet may have delayed access to the same token, where the delay may be purely time-based (such as 24 hours after a request is made), require parental approval (e.g., using a biometric verification by the parent), and/or some other triggering event. A third wallet, such as a wallet that is not on the whitelist specified in and/or by the parent wallet, may have heavily limited access to the token, and limited access can only be granted after a process involving the approval by an operator of the parent wallet and of the child wallet.

Some tokens may be associated with a requirement to only transfer ownership of them on specified chains and/or side-chains. Such chains and/or side chains may be associated with policies governing what applicable actions may be performed on the tokens in question, and under what condition this may take place. Alternatively, a watchful bridge and/or a watchful consensus mechanism (e.g., PCT Patent Application No. PCT/US23/62851, titled “Systems and Methods for Abuse Safeguards in NFT-Directed Environments,” filed on Feb. 17, 2023, incorporated by reference in its entirety) may implement the verification of one or more policies of the types described herein, thereby applying such policies to the transfer of tokens. The determination of what policies that should be applied may be specified in and/or related to the token(s); by a policy list accessible by the watchful entity; and/or by statement recorded on the blockchain upon the transfer of a token to an entity wishing to apply the one or more policies to the token and/or tokens as a way of protecting against abuse. Policy lists may be specific to jurisdictions, enterprises, families, types of content associated with tokens, aspects related to the parties involved in a transfer (such as their age, reputation, specified location, etc.).

In one embodiment, a user specifies a policy that requires that an approval is provided by a pre-registered computational entity (or one or more of several such). This policy may be specified per token, and/or be a property associated with a wallet entity, and be implicitly stated by the user in that the user selected to use this wallet entity. It may also be selected by another party associated with the user, such as an employer and/or a parent. The approval may be given by a user utilizing an approved device associated with a public key, wherein the approval includes providing a digital signature using the private key associated with the public key, on a message including a transaction description (e.g., identifying the token and the address to which this is to be transferred). The approval is only given after an approved user of the device uses his and/or her biometrics successfully and approves the transaction, which may be presented to the user in a user interface before and/or after the biometric authentication, and which the user may acknowledge by pressing a button indicating “complete transfer.” The user interface of the computational entity, e.g., phone, may be used to provide the user with alerts and/or warnings, e.g., raising awareness of the size of the indicated transaction, the unknown identity of the recipient.

Some policies may be associated with a given owner, and once the associated token is successfully transferred away from this owner, the policy would cease to exist in the context of the token in question. This is a wallet-centric implementation in which policies are associated with wallets and their contents, but as the contents are transferred out, the policies cease to be associated with them. Some policies may be associated with the tokens, e.g., at the time of being minted and/or as a result of being augmented in a permanent manner by an authorized entity (such as an owner and/or a jurisdiction) at a later time. Yet other policies may be associated with jurisdictions, e.g., always apply to all tokens within such a jurisdiction. Here, a jurisdiction may correspond to a political and/or geographic area, an enterprise, a family, etc. Policies may also be associated with a specified time period, e.g., be valid for the duration of the year 2027, but not after that. A policy may also indicate a series of versions, each version corresponding to one or more contexts indicating when that policy version applies. Combinations of the aforementioned policies may also apply, and in some embodiments later policies may apply and/or may not apply depending on prior policies that are applied. For example, an owner-centric and token-centric policy may apply in a first jurisdiction, whereas in a second jurisdiction, only the token-centric policy may apply.

The disclosed technology can also be implemented by using a blockchain and/or other publicly accessible database to post policies and updates to policies.

In some embodiments including a blockchain, policies and/or updates to policies may be stored in a smart contract, and wallets and/or blockchain nodes may query the smart contract to obtain a currently valid set of policies and/or policy updates. In other embodiments, policies and/or updates to policies may be announced through transactions, with specific policies for a given address indicated through a transaction to the given address.

In further embodiments, policies and/or policy updates may be communicated through non-fungible tokens, wherein a metadata file may include a policy and/or a policy update, and may further include data indicating an applicability of the policy and/or policy update, for example but not limited to: a validity period, a jurisdiction of relevant, and/or other information pertaining to the policy and/or policy update, and a non-fungible token transferred to a blockchain address may include a universal resource identifier (URI) pointing to the metadata file. The non-fungible token, henceforth referred to as a policy token, may be transferable, and/or it may be non-transferable and hence soul-bound. In some embodiments of the further embodiment, the policy token may be cloneable, that is, an owner of the blockchain address may mint copies of the policy to other addresses.

In yet other embodiments, policies and/or updates may be transmitted directly to blockchain wallets from a policy server, wallets may periodically query a server for current policies and/or policy updates, and/or wallets may query a server for current policies and/or policy updates before presenting a transaction for signing and/or before transmitting the transaction.

In some embodiments, a restriction may include a user account and/or one or more policies to be associated with the user account. An example restriction may identify a user account by its address and/or parts thereof, and identify two policies, such as “Policy 1: Any transfer of one or more coins with a cumulative value exceeding $1000, in any 24 h period, must be accompanied with a digital signature attesting to the approval of a user associated with a biometrically protected trusted computing environment associated with public key P, where the digital signature must identify the transaction and that the biometric authentication score exceeded 68 for the access, where the score indicates the quality level of the biometric match”, and “Policy 2: any transfer to a recipient that the user has not transferred tokens to before must be accompanied by a digital signature using public key P, where the access to the public key P may be performed either using biometric authentication and/or using a password, but in the latter case, the device associated with P must be within a mile from its ‘home’ location.”

The blockchain and/or public database entry may have to be authenticated using a key associated with one or more public keys associated with the user, the user account, and/or devices associated with the user account, and may only be removed and/or reduced in scope by a modification request that satisfies a policy included in and/or referenced in the entry. Such a policy may be to provide a seed corresponding to a public key indicated in the entry, for example, and/or a policy that the user requests a change using a trusted computing device associated with a biometric authentication for access. Policies like these may also be used to control transfer of individual tokens.

A jurisdiction may associate policies with any users associated with it. Here, a jurisdiction may correspond to a country, a state, a city, an enterprise and/or other organization, a family, a distributed autonomous organization (DAO), and/or other entity. Any user identified, e.g., by location, recorded membership, indication in certificate associated with user, etc., will have to comply with the one or more policies of the jurisdiction to perform actions indicated in the policies, where such actions may be to transfer ownership, provide content access, lend, pawn and/or otherwise provide as security, etc. The jurisdiction may indicate users for whom such policies apply, but may alternatively and/or in addition indicate tokens, content types, tokens on indicated blockchains, etc., for which the policies apply. The jurisdiction may be a hardware manufacturer, e.g., the manufacturer of a hardware wallet, and the policy may require a specified user action to enable given token actions from the hardware wallet.

In one embodiment, a first entity receives a request from a second entity to transfer a token (which may possess other tokens, as described above). The first entity (which may be a token, as described above) evaluates the request, e.g., the terms of the transfer and determines whether to perform a transfer of the token to the second entity. However, before such a transfer may complete, an approval is required from a third entity (which may be a person, a token, an automated process, and/or a combination of such). The policy indicating the need for the third entity to approve may be included in the token, associated with the token, be associated with the first entity, and/or be required in a jurisdiction associated with the first and/or second entity. The third entity may be an automated process executing on a device that is separate from that of the first entity, and by requiring the approval of the third entity, protection is obtained against abuse, mistakes, and fraud such as malware-based fraud.

In an alternative version, there is no request from the second entity to the first entity, but the first entity initiates the transaction based on information possessed by the first entity, some of which may originate with the second entity and/or associated parties.

The first and third entity may correspond to two devices and/or processes that are controlled by one and the same user, such as a laptop used for initiating payments, purchases and/or transfers, and a mobile device such as a smartphone, that is used to approve transactions that are initiated from the laptop. The two devices may be indirectly controlled by one and the same entity, e.g., the approving device (i.e., the third entity) may be controlled by the parent and/or guardian of the user associated with the first entity (e.g., a child's device, including smartphone, tablet, game station, laptop, desktop and/or other computational device).

In yet another alternate embodiment the policy may be implemented in a smart contract and/or collection of smart contracts and associated with one or more of the token, the first entity, the second entity, and/or the third entity. In an example presented for illustrative purposes only, and not meant to be limiting in any way, the token may include a requirement, encoded in a first smart contract instantiating the token and/or associated with the token, that the second entity has an identified jurisdictional location, and that the identified jurisdictional location is not on a ban list for recipients of the token.

An example of a token transfer performed in accordance with many embodiments of the invention is illustrated in FIG. #32. A first entity #3200 may be registered as an owner of a token #3225 instantiated by a token smart contract #3220. The token smart contract #3220 may also include a ban list #3227, which in the present embodiment may include the United States, the United Kingdom, Canada, Australia, and New Zealand.

The first entity #3200 may wish to transfer the token #3225 to a second entity #3210, and may transmit a transaction request requesting a transfer of the token #3225 to the second entity #3210 to the token smart contract #3220.

The token smart contract #3220 may include functionality implementing a policy requiring evidence that the second entity #3210, namely a recipient of the token #3225, to reside and/or be registered in a jurisdiction not on the ban list #3227. Evidence may be provided through a jurisdiction token smart contract #3230 instantiating jurisdiction tokens.

A jurisdiction token #3240, instantiated by the jurisdiction token smart contract #3230, may be assigned to the second entity #3210, indicating a location of the second entity. In the present example, for illustrative purposes, the location is Finland.

On receiving the transaction request requesting the transfer of the token #3225 the token smart contract #3220 may examine the transaction request, determine an address and/or identity of the recipient, which in this example is the second entity, and may query the jurisdiction token smart contract #3230 to determine when a jurisdiction token #3240 exists for the second entity. When the jurisdiction token does not exist, the transaction request may fail. When the jurisdiction token #3230 does exist for the second entity #3210, the token smart contract #3220 may examine the jurisdiction token #3240 and/or may query the jurisdiction token smart contract #3230 for a jurisdiction registered in the jurisdiction token #3240.

When the ban list #3227 includes the jurisdiction registered in the jurisdiction token #3240 owned by the second entity #3210, the transaction may fail, and when the ban list #3227 does not include the jurisdiction registered in the jurisdiction token #3240 owned by the second entity #3210, then the transaction may succeed, and ownership of the token #3225 may be transferred to the second entity #3210.

Those skilled in the art will appreciate that other embodiments may implement policies through token smart contracts instantiating tokens other than jurisdiction tokens, for example but not limited to, employment tokens indicating an owner is an employee of a company, qualification tokens indicating an owner holds a qualification such as a university degree, age tokens indicating an owner is above and/or below a given age, license tokens indicating an owner is licensed and/or qualified for some purpose, client tokens indicating an owner is a paying customer, nationality tokens indicating an owner is a citizen of a specified country, and so on. Similarly the policy may include a ban list, an allow list, and/or some other condition that must be met and/or not met.

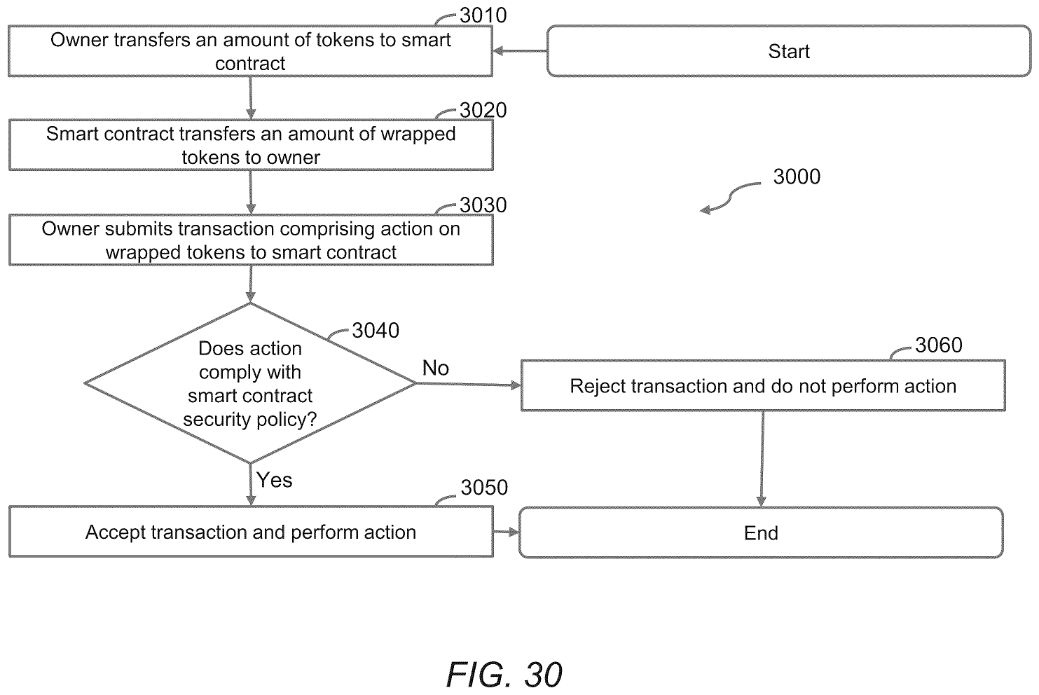

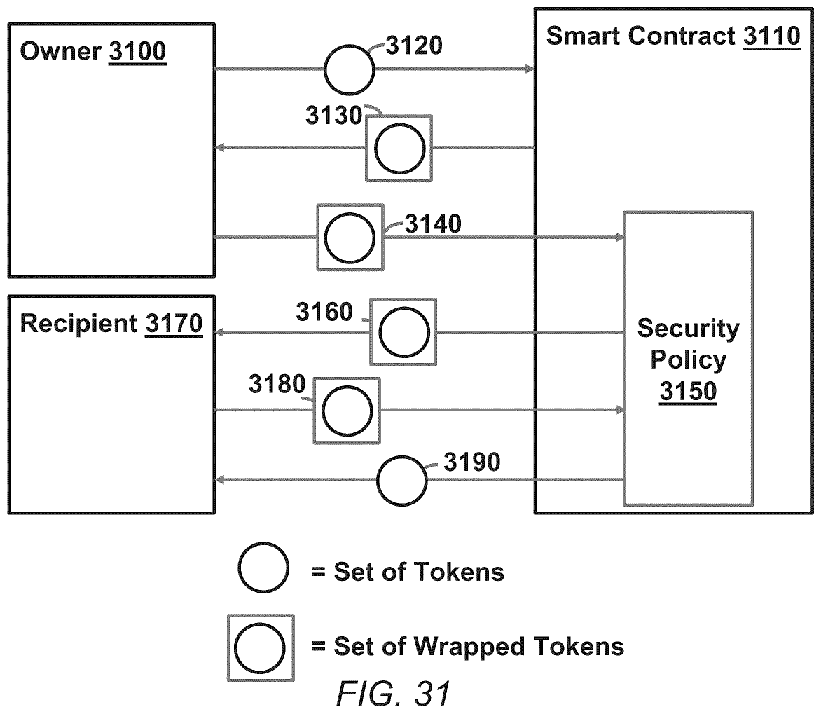

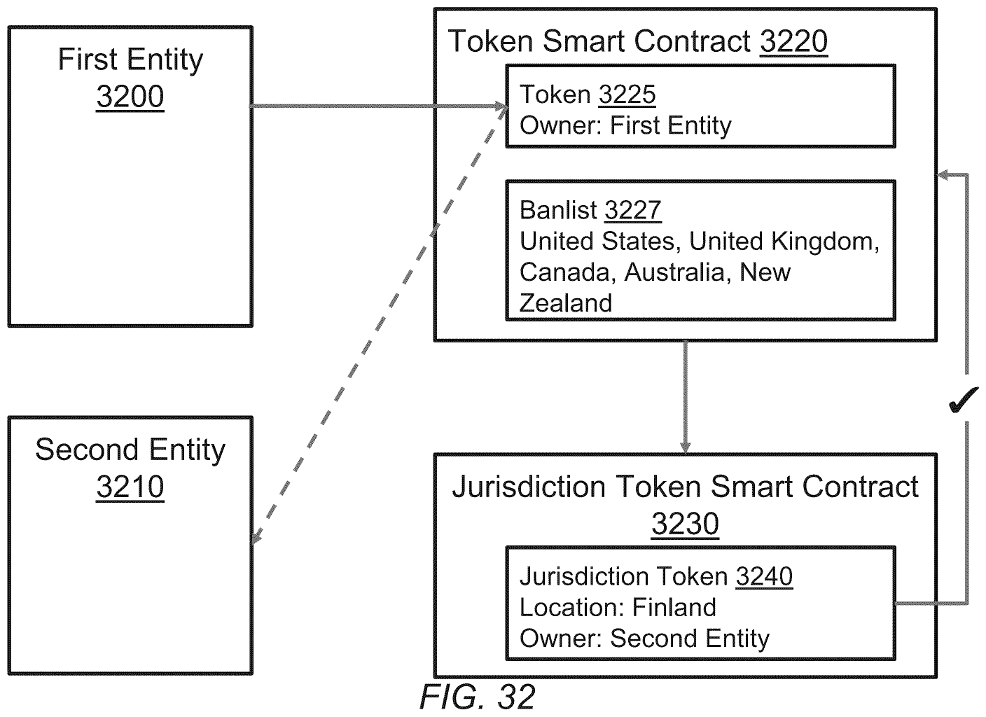

The different embodiments disclosed herein can be combined with each other, as will be appreciated by a person of skill in the art. Security configurations implemented in accordance with some embodiments of the invention are not limited to use within NFT platforms. Accordingly, it should be appreciated that applications described herein may also be implemented outside the context of an NFT platform network architecture unrelated to token transactions. Moreover, any of the applications described herein with reference to FIGS. 30-32 may be utilized within any of the NFT platforms described above.

### NFT Platform Blockchain Functionalities

### A. Bound Blockchains

An aspect of the present invention includes a plurality of blockchains. In a first embodiment of the present invention, a first blockchain of the plurality of blockchains may be a public permissionless blockchain, typically, but not necessarily, immutably recording transactions and ownership of digital assets. Techniques relevant to the present disclosure describing systems and methods for cross-chain assets are disclosed in co-pending U.S. patent application Ser. No. 18/299,546, titled “Systems and Methods for Instant NFTs and Protection Structure, Detection of Malicious Code within Blockchain Smart Contracts, Tokens with Transfer Limitations, Mirror Tokens and Parallel Addresses, Smart Contract Risk Scoring Method, and Cross-Device Digital Rights Management,” filed Apr. 12, 2023, the disclosure of which is incorporated by reference in its entirety. The first blockchain may be censorship-resistant due to a consensus protocol that ensures control over the blockchain is not exclusive to one party. A second blockchain of the plurality of blockchains may be a permissioned (and optionally private) blockchain, on which a central authority may be able to revert transactions under certain conditions, which may be predetermined, and on which the central authority may have a right to inspect and optionally decline transaction requests permanently.

Transactions may also be reversed or otherwise modified using a watchful bridge (and/or related techniques), as disclosed in PCT Patent Application No. PCT/US23/62851, titled “Systems and Methods for Abuse Safeguards in NFT-Directed Environments,” filed on Feb. 17, 2023, the disclosure of which is incorporated by reference in its entirety. In this disclosure, we also demonstrate how watchfulness can be implemented using smart contracts.

The first blockchain and the second blockchain may be bound together. In the first embodiment the first blockchain and the second blockchain may be bound together using a bridge, which in some embodiments may be partially or completely bi-directional. In one embodiment, on launching the first blockchain and the second blockchain, the bridge may be provided with a large amount of pre-mined native cryptocurrency of the first blockchain to be used primarily for transaction fees, also sometimes known as gas fees. The bridge may also either be similarly provided with a large amount of pre-mined native cryptocurrency for the second blockchain, or may be provided with special status on the second blockchain.

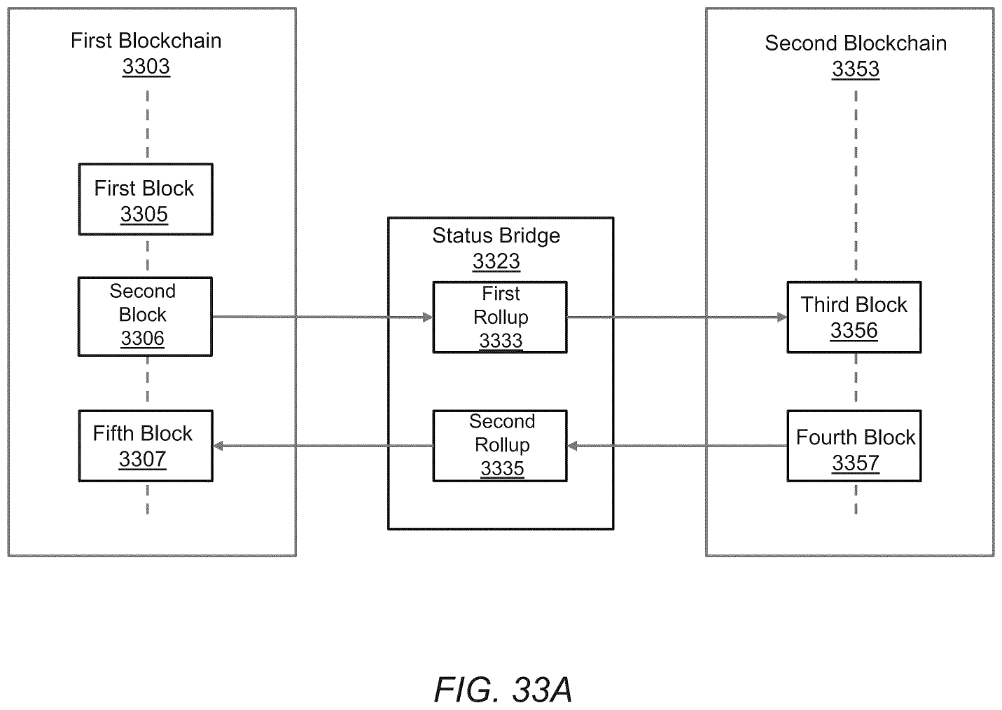

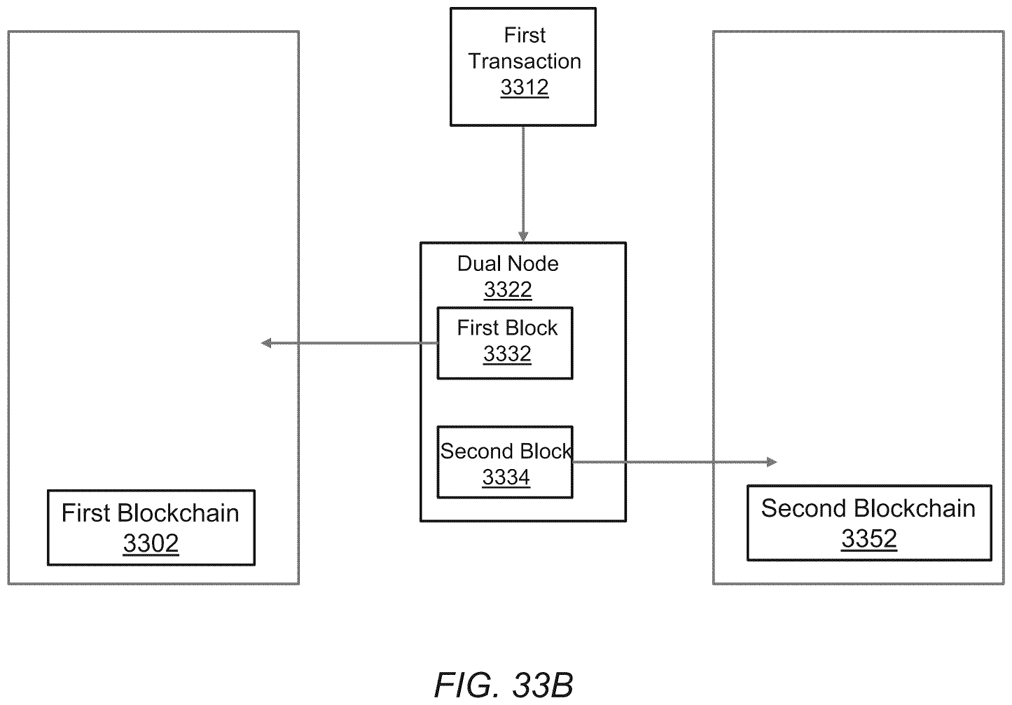

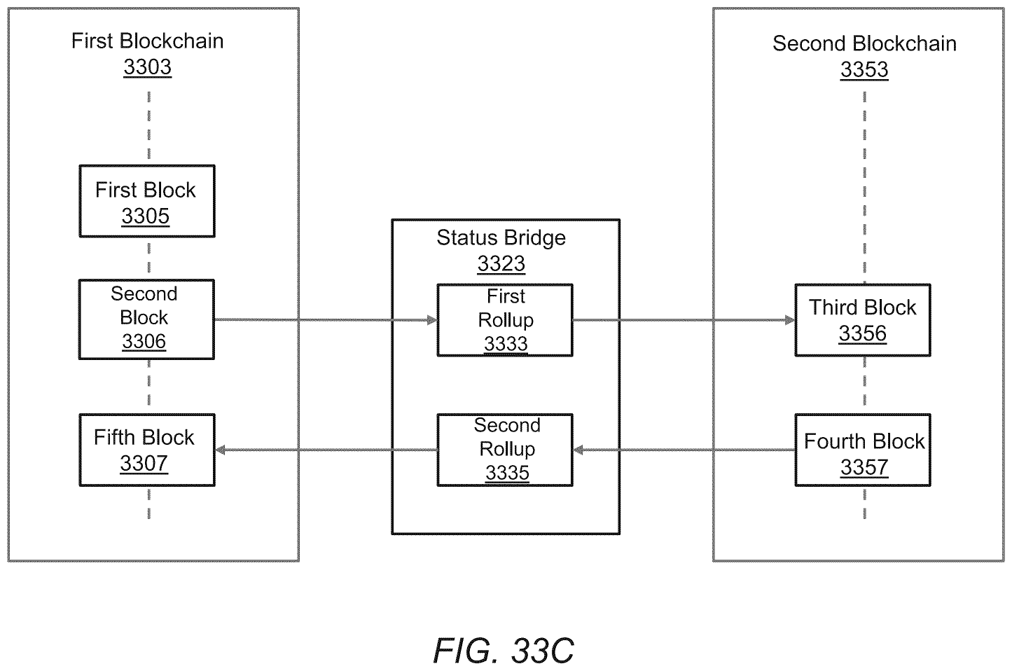

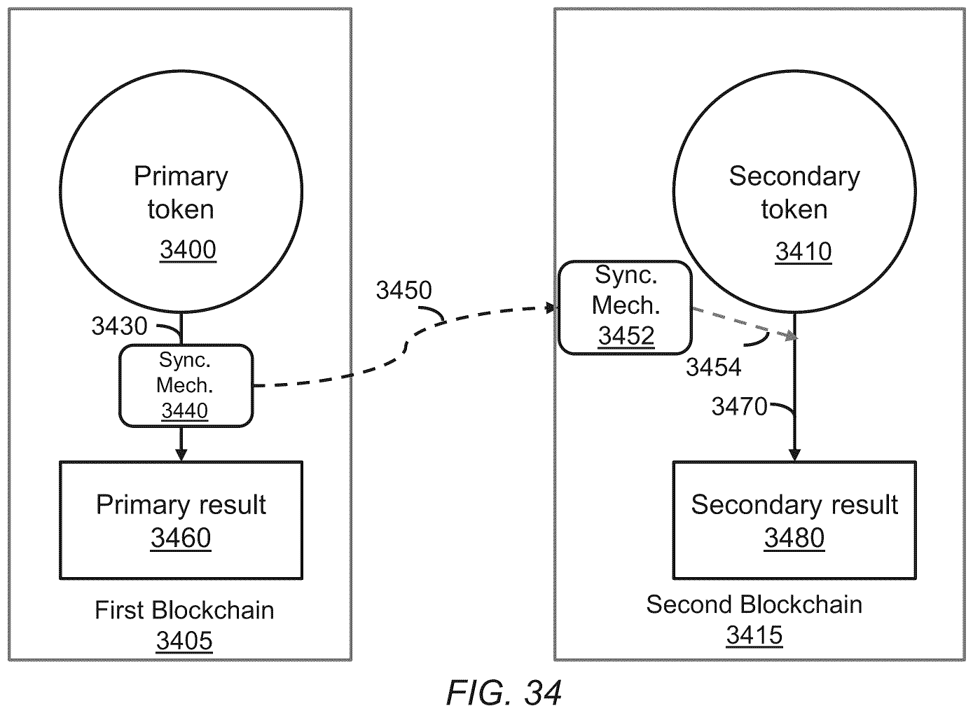

A possible embodiment of the first embodiment is presented in FIG. 33A using a block diagram. A first blockchain 3301 may be open and/or permissionless, and a second blockchain 3351 may be private and/or permissioned. A first transaction 3311 may be submitted to the first blockchain 3301 and may be included in a first block 3321, for example, by a miner or validator node.

A bridge 3331 may detect a presence of the first transaction 3311 in the first block 3321 of the first blockchain 3301, determine that the first transaction 3311 is of material importance to assets instantiated on the second blockchain 3351, and may therefore construct a second transaction 3341 homologous to the first transaction 3311. The bridge 3331 may then submit the second transaction 3341 to the second blockchain 3351 for inclusion in a second block 3361.

In a second embodiment, the first blockchain and the second blockchain may be bound together using dual nodes. A dual node is a blockchain node that monitors, maintains, and extends two blockchains, and thus the dual node may have access to data from blocks from the first blockchain and the second blockchain, may store smart contract states for the first blockchain and the second blockchain, may maintain a mempool, that is, a store of unprocessed transactions, for both the first blockchain and the second blockchain, and may mine or validate blocks for both the first blockchain and the second blockchain. The dual node may inspect a first transaction for the first blockchain to determine whether the first transaction affects a state of the second blockchain, and on determining that the transaction does affect the state of the second blockchain, may construct a second transaction reflecting an effect of the first transaction on the second blockchain.

A possible embodiment of the second embodiment is presented in FIG. 33B, which is a block diagram illustrating the first blockchain and the second blockchain bound using a dual node. A first blockchain 3302 and a second blockchain 3352 may be maintained and extended by a dual node 3322. If a first transaction 3312 is received for the first blockchain 3302 that affects a state of the second blockchain 3352 the dual node 3322 may construct a first block 3332 including the first transaction 3312 as a candidate for inclusion on the first blockchain 3302, and the dual node 3322 may construct a second transaction and a second block 3334, wherein the second block 3334 includes the second transaction, and wherein the second transaction reflects an effect of the first transaction 3312 on the state of the second blockchain 3352.

In a third embodiment, a rollup of a status of the first blockchain may regularly be written to the second blockchain, and similarly a rollup of a status of the second blockchain may be written to the first blockchain, thus maintaining a bi-directional record of statuses of the respective blockchains on each other. Each rollup may include: an optimistic rollup, a zero-knowledge rollup, or some other form of rollup.

A possible embodiment of the third embodiment is in FIG. 33C, which is a block diagram illustrating the status of the first blockchain 3303 and the status of the second blockchain 3353 synchronized or partially synchronized using a bi-directional record of statuses of the respective blockchains using a status bridge 3323 and rollups.

The first blockchain 3303 may be extended by a first block 3305 including transactions and/or state changes, and then by a second block 3306 also including transactions and/or state changes. The status bridge 3323 may parse the first blockchain 3303 including the first block 3305 and the second block 3306, and may construct a first rollup 3333. The status bridge 3323 may then write the first rollup 3333 to the second blockchain 3353, and the first rollup 3333 may be inscribed in a third block 3356 on the second blockchain 3353.

Subsequently the second blockchain 3353 may be extended by a fourth block 3357 including transactions and/or state changes. The status bridge 3323 may parse the second blockchain 3353 including the third block 3356 and the fourth block 3357, and may construct a second rollup 3335. The status bridge 3323 may then write the second rollup 3335 to the first blockchain 3303, and the second rollup 3335 may be inscribed into a fifth block 3307 on the first blockchain 3303.

The above method described in the possible embodiment of the third embodiment may be repeated at regular or irregular intervals.

In some embodiments, transactions may alter the state of both blockchains and/or ownership of assets in an inconsistent manner that must be resolved. In one configuration, a first blockchain which is more permissioned may take precedence over a second blockchain that is less permissioned, and a first transaction proposed for inclusion in a block for the first blockchain that is inconsistent with a second transaction proposed for inclusion in a block on the second blockchain may be resolved by a miner or validator selecting the first transaction in preference to the second transaction. In a second configuration, the first blockchain may be less permissioned and the second blockchain may be more permissioned, and the first transaction may take precedence over the second transaction.

An asset may be represented by a first token on the first blockchain and a second token on the second blockchain, with information concerning a status of the first token transferred from the first blockchain to the second blockchain through one of the embodiments previously described. The two blockchains may be based on different technologies, e.g., proof or work vs. proof of stake, or they may be of the same type, including a private chain.

In some embodiments, the first token may be a primary representation of the asset, and the second token may be a secondary representation of the token, with changes made to the status of the first token necessarily replicated by the second token, but with changes made to a status of the second token not necessarily replicated by the first token. For example, when instantiated on the Ethereum blockchain, if the first token is transferred to a zero address (that is, “burned” in common blockchain parlance), on receiving this change in status on the second blockchain, a smart contract instantiating the second token may similarly transfer the second token to a zero address on the second blockchain, or perform another action that modifies the usage or ownership of the second token. In one embodiment, the second token may be transferred to the party that originated it instead of being burnt. If the smart contract is not an autonomous smart contract, as disclosed below, the transfer of the second token to the zero address may not occur until a transaction submitted to the smart contract is executed. For example, a transaction to transfer the second token to a recipient address may cause the smart contract to first check for a change in status of the first token, by examining state information transferred from the first blockchain to the second blockchain, and on determining that the first token was previously transferred to the zero address, may transfer the second token to the zero address rather than to the recipient address. This, in effect, renders the second token worthless even before the attempt to transfer it, as it will be understood that transferring it will cause it to be burnt.

An embodiment of the present disclosure is presented in a block diagram in FIG. 34. A primary token 3400 may be instantiated on a first blockchain 3405) and a secondary token 3410 on a second blockchain 3415). Using the present invention, behaviors of the secondary token may be linked or bound to behaviors of the primary token, as is now disclosed.

An action 3430 may be invoked on the primary token 3400 causing a primary result 3460. Actions may include one or more of: a transfer of ownership, a burning, alteration of a property of the primary token, or some other state change relating to the primary token.

Information concerning the action 3430 may be collected as part of a blockchain synchronization mechanism 3440 and communicated to the second blockchain 3415) as shown by 250. A corresponding synchronization component 3452 may detect the action 3430 within synchronization data, and may subsequently trigger a corresponding action 3470 as shown by 254, resulting in a secondary result 3480, said secondary result 3480 corresponding to the primary result 3460.

In a further embodiment, a role of primary token and secondary token may be swapped, for example, through a duly authorized transaction. For example, a first smart contract instantiating the first token and a second smart contract instantiating the second token may both include a state, variable, or memory slot storing whether a token instantiated by the first smart contract or the second smart contract is the primary token or the secondary token. A transaction submitted to one of the first smart contract or the second smart contract, by an authorized party, for example a first token or second token owner or an approved administrator, may convert the first token from primary to secondary. Through a transfer of state information from the first blockchain to the second blockchain, the transaction and the conversion of the token may be transferred to the second smart contract, thus inducing a conversion of the second token to the role of primary token. In one alternative embodiment, both (or all) of the related tokens are given a functionality such that any modification to the token causes a corresponding, or in other cases inverse, modification to the other, related tokens. In a setting with three tokens that are related to each other, two of these may cause a change for the other two tokens, whereas the third may not cause any change for the other. This may be generalized to M tokens, where a modification to N of M tokens (for N less than or equal to M) results in corresponding modifications to a remaining M-N tokens.

As will be appreciated by a person of skill in the art, the actions imposed on one token based on status changes for another token may also depend on policies associated with these tokens; and the content or capabilities (such as access rights) associated with one of the tokens may be different from that of other related tokens. In one embodiment, the ownership of a threshold number of related tokens confers rights related to yet other related tokens, to the owner of the threshold number of tokens. This can be used to gamify the use and ownership of tokens.

Other combinations include: the first blockchain with the first token in the role of secondary token converting to the role of primary token and the second blockchain with the second token in the role of primary token subsequently converting to the role of secondary token, the second blockchain with the second token in the role of secondary token converting to the role of primary token and the first blockchain with the first token in the role of primary token subsequently converting to the role of secondary token, and the second blockchain with the second token in the role of primary token converting to the role of secondary token and the first blockchain with the first token in the role of secondary token subsequently converting to the role of primary token.

The above disclosure may be extrapolated to a plurality of blockchains with a plurality of tokens and a plurality of token roles.

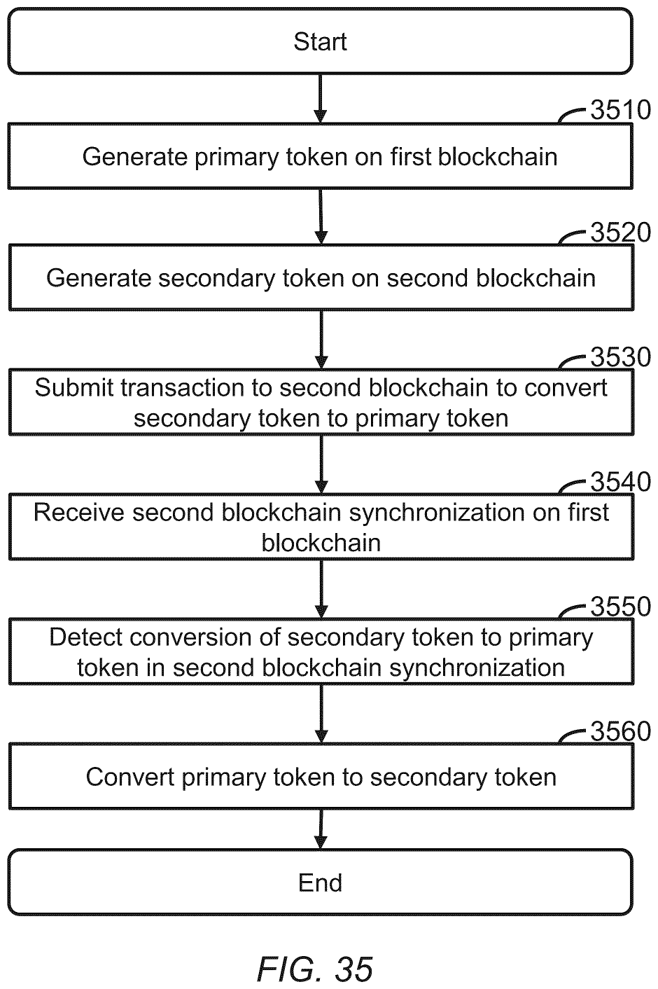

An embodiment of present disclosure for a primary token and a secondary token, wherein a conversion of the secondary token to primary status results in a conversion of the primary token to secondary status is presented in a flowchart in FIG. 35.

Actions may commence with step 3510, in which the primary token is generated on a first blockchain, for example, through a deployment of a first smart contract on the first blockchain.

Actions may then proceed to step 3520, in which the secondary token is generated on a second blockchain, for example through a deployment of a second smart contract on the second blockchain. In some embodiments, step 3520 may be taken before or at the same time as step 3510. In further embodiments, the second smart contract may include some or all of code including the first smart contract, or the first contract may include some or all of code including the second smart contract.

Actions may then proceed to step 3530, in which a transaction is submitted to the second blockchain to convert the secondary token to primary status, the second token thus becoming a new primary token. In some embodiments, the transaction may require multiple digital signatures from multiple parties to be valid.

Actions may then proceed to step 3540, in which a second blockchain synchronization may be received on the first blockchain. The second blockchain synchronization may occur through an optimistic rollup, a zero-knowledge rollup, or some other synchronization method.

Actions may then proceed to step 3550, in which a conversion of the secondary token to primary status may be detected in the second blockchain synchronization. In some embodiments the conversion may be detected by an autonomous smart contract. Autonomous smart contracts are disclosed below. In other embodiments, the conversion may be explicitly communicated to the first smart contract through a transaction, and may be verified by the first smart contract through an examination of the second blockchain synchronization.

If the conversion is determined to be valid, for example, by the first smart contract or through some other proxy contract or contract library, actions may proceed to step 3560, and the primary token may be converted to secondary status.

While specific processes are described above, bound blockchains may be applied in any of a number of different ways as appropriate to the requirements of specific applications in accordance with several embodiments of the invention. In various embodiments, steps may be executed or performed in any order or sequence not limited to the order and sequence shown and described. In numerous embodiments, some of the above steps may be executed or performed substantially simultaneously where appropriate or in parallel to reduce latency and processing times. In many embodiments, one or more of the above steps may be omitted. Additionally, the specific manner in which (e.g., dual) nodes may be utilized within NFT platforms in accordance with numerous embodiments of the invention is largely dependent upon the requirements of a given application.

Further embodiments of the above embodiments may include a plurality of blockchains, in which each of the plurality of blockchains may have a different level of permissiveness and publicness when compared to the other blockchains. Synchronization between individual pairs of blockchains may be achieved through any of the above embodiments, or may be achieved transitively through a path of connections implemented using any of the above embodiments.

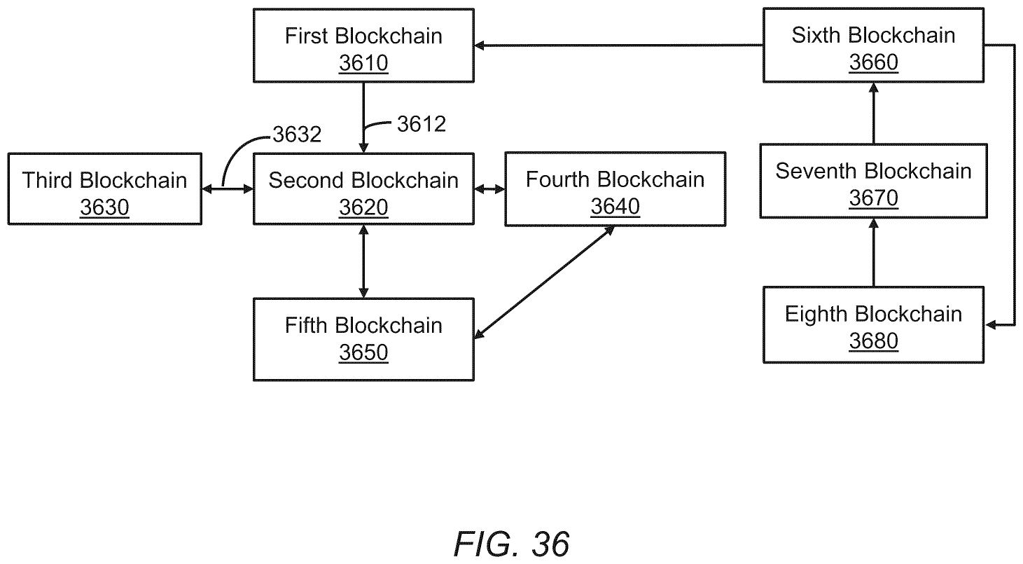

A graph with each of the plurality of blockchains representing a node of the graph, and each of the connections between connected pairs of the plurality of blockchains representing an edge of the graph is presented in FIG. 36, which is shown for illustrative purposes only, and is not meant to be limiting in any way. FIG. 36 presents an embodiment of a specific implementation of a plurality of blockchains chosen to illustrate various configurations of bound blockchains. However, in light of the example, those skilled in the art will appreciate that other graphs representing different topologies may be implemented.

As illustrated in a subgraph of FIG. 36, in some embodiments, a first blockchain 3610 may be bound to a second blockchain 3630 in a unidirectional manner as indicated by a first vertex 3612 that is unidirectional, with some or all of a state of the first blockchain 3610 duplicated onto the second blockchain 3620. In some embodiments, the first blockchain 3610 may be more open and/permissive than the second blockchain 3620, and thus outcomes of transactions on the first blockchain 3610 may be replicated to the second blockchain 3620 but not vice versa. In other embodiments, the first blockchain 3610 may be less open and/permissive than the second blockchain 3620, and thus outcomes of transactions on the first blockchain 3610 may be replicated to the second blockchain 3620 but not vice versa.

As illustrated in a subgraph of FIG. 36, in some embodiments, a third blockchain 3630 may be bound to the second blockchain 3620 in a bidirectional manner as indicated by a second vertex 3632, with some or all of a state of the third blockchain 3630 duplicated onto the second blockchain 3620, and some or all of a state of the second blockchain 3620 duplicated onto the third blockchain 3630. In some embodiments, nodes biding the second blockchain 3620 to the third blockchain 3630 may ensure that transactions and/or data duplicating state from the second blockchain 3620 onto the third blockchain 3630 are not subsequently reduplicated from the third blockchain 3630 to the second blockchain 3620 and/or vice versa, to ensure that an infinite loop of reduplication is not initiated.

As illustrated in a subgraph of FIG. 36, in some embodiments, a fourth blockchain 3640 may be bound to the second blockchain 3620, a fifth blockchain 3650 may be bound to the second blockchain 3620 and the fourth blockchain 3640 may also be bound to the fifth blockchain 3650, thus forming a cycle within a topology of the graph. Without loss of generality, we may now examine duplication of a state of blockchains connected via the cycle: if some or all of a state of the second blockchain 3620 is duplicated to the fourth blockchain 3640, the state of the second blockchain 3620 may also be duplicated to the fifth blockchain 3650, either directly from the second blockchain 3620 or transitively via the fourth blockchain 3640. In some embodiments, nodes enacting a duplication may prevent infinite loops of reduplication by examining each proposed duplication to determine whether it has already occurred. In some embodiments a hash or a Merkle tree of a state duplicated through a rollup may be examined to decide whether a blockchain onto which a state is duplicated already includes a corresponding value or values of the hash or the Merkle tree, and rejecting part or all of the state based on the determination.

As illustrated in a subgraph of FIG. 36, in some embodiments, a sixth blockchain 3660 may be unidirectionally bound to the first blockchain 3610, which is unidirectionally bound to the second blockchain 3620. Through this, a state of the sixth blockchain 3660 may be replicated to the first blockchain 3610 and from there to the second blockchain 3620. Therefore, transitively, the state of the sixth blockchain 3660 may be replicated onto the second blockchain 3620. In some embodiments, the sixth blockchain 3660 may be equal to or less open and/or permissionless than the first blockchain 3610, which may be equal to or less open and/or permissionless than the second blockchain 3620, with a formula for determining openness and/or permissionless relying on metrics including one or more of: a number of authorities required to approve account creation on a blockchain, a number of authorities required to approve a transaction, an ability to reverse or delete prior transaction under certain predetermined conditions, a level of anonymity provided to participants on the blockchain, an absence or presence of restrictions on a value of assets transferred within a given transaction or given time period, or some other metrics. In other embodiments, the sixth blockchain 3660 may be equal to or more open and/or permissionless than the first blockchain 3610, which may be equal to or more open and/or permissionless than the second blockchain 3620. The disclosure of the present paragraph may be generalized to any ordered directed acyclic subgraph of a graph.

As illustrated in a subgraph of FIG. 36, in some embodiments, a seventh blockchain 3670 may be unidirectionally bound to the sixth blockchain 3660, which may be unidirectionally bound to an eighth blockchain 3680, which may be unidirectionally bound to the seventh blockchain 3670. The subgraph therefore forms a directed cyclic graph. Without loss of generality, we may now examine duplication of a state of blockchains connected via the directed cyclic graph: if some or all of a state of the seventh blockchain 3670 is duplicated to the sixth blockchain 3660, the state of the seventh blockchain 3670 may also be duplicated to the eighth blockchain 3680 transitively via the sixth blockchain 3660. In some embodiments, nodes enacting a duplication may prevent infinite loops of reduplication by examining each proposed duplication to determine whether it has already occurred. In some embodiments a hash or a Merkle tree of a state duplicated through a rollup may be examined to decide whether a blockchain onto which a state is duplicated already includes a corresponding value or values of the hash or the Merkle tree, and rejecting part or all of the state based on the determination.

Bound blockchains implemented in accordance with various embodiments of the invention are not limited to use within NFT platforms. Accordingly, it should be appreciated that applications described herein may also be implemented outside the context of an NFT platform network architecture unrelated to token transactions. Moreover, any of the applications described herein with reference to FIGS. 33A-36 may be utilized within any of the NFT platforms described above.

### B. Autonomous Smart Contracts

Smart contracts on current blockchains require an external action to be executed. For example, a function call may be made to a smart contract function through a blockchain transaction submitted by an external script or a person using a blockchain wallet. However, in the current state of the art, smart contracts are unable to independently execute functionality. If a function in a smart contract needs to be run on a regular basis, for example once a month, or once a day, an external agency must make the function call on each occasion required. Thus, for example, a smart contract implementing the equivalent of a direct debit or standing order on a smart contract enabled blockchain such as Ethereum requires an externally owned account, person, or external script to perform a repeated action.

In one embodiment of the present disclosure, a blockchain protocol, node software, and/or a smart contract programming language may include functionality to execute a function or functions of a smart contract on a regular stated basis, or triggered by specified conditions that may be stored on a blockchain or otherwise known by one or more external entities that have the capability of “waking up” the smart contract when the conditions are met. One example of such an entity is a bounty hunter. Bounty hunters are disclosed in, among other places, the co-pending U.S. patent application Ser. No. 17/806,065, titled “Systems and Methods for Maintenance of NFT Assets,” filed Jun. 8, 2022, the disclosure for which is incorporated by reference in its entirety. One or more nodes that are part of the consensus mechanism may implement functionality of bounty hunters.

Henceforth we refer to smart contracts with functionalities such as those described above as autonomous smart contracts. We note that many of the disclosed methods involving autonomous smart contracts also apply to smart contracts that are not autonomous, or that are only partially autonomous, as a person of skill in the art will recognize. Smart contracts can be made autonomous, partially autonomous, intermittently autonomous, conditionally autonomous, or temporally autonomous using the methods disclosed herein. Execution may occur in a manner similar to a Linux cron job or a Microsoft Windows scheduled task, although such functionality is not possible with today's blockchain technology, which is not compatible with Linux cron jobs, Microsoft Windows scheduled tasks, or similar technologies. Furthermore, even if it were possible to execute smart contracts externally using a system including external hardware and software, a failure in said system would result in a potentially highly costly failure to execute the function or functions of the smart contract. On the other hand, a blockchain protocol including functionality to execute a function or functions would result in reliable execution provided at least one node of the blockchain is functional. If no nodes are functional, the entire blockchain is non-functional, and the question of reliable smart contract execution becomes moot. The present disclosure therefore provides the most reliable implementation of automated smart contract execution, enhancing smart contract enabled blockchains with superior autonomous functionality compared to currently available methods.

In the embodiment, nodes validating and extending the blockchain may include a component responsible for storing a registry of autonomous smart contracts that are run on a regular basis, and the periodicity of execution for each. Some autonomous smart contracts, when executed, may cause other smart contracts to be executed, where the selection of what smart contract to execute may be a function of the input to the autonomous smart contract that causes the execution. A smart contract may also set or change the periodicity or the triggering conditions for causing another smart contract to execute. Some autonomous smart contracts may be associated with instructions or configurations that specify the range of frequencies and/or the type of contracts that may cause them to execute. A wallet may, likewise, cause one or more autonomous smart contracts to be activated, e.g., start execution, and may provide such autonomous smart contracts with inputs used in their execution; the autonomous smart contracts may also use inputs that are environmental and/or data stored on the blockchain. Autonomous smart contract execution may be proxied, chained, or cascaded.

The smart contract programming language or code may include a function modifier indicating that a function marked with the function modifier is to be run on a regular basis, thus making the resulting smart contract autonomous. Execution of the function may consume gas for each execution, and the smart contract may be required to own a sufficient amount of native cryptocurrency to cover gas costs for execution. If the autonomous smart contract does not own or have privileges enabling access to enough native cryptocurrency to cover gas costs and other potential costs, nodes may decline to execute the function. Funds needed to cover gas fees and other costs may also be provided by an entity that activates the autonomous smart contract, e.g., another smart contract, a wallet, or through account abstraction and paymasters such as that provided on Ethereum through ERC-4337/EIP-4337, “Account Abstraction Using Alt Mempool” (reference: https://eips.ethereum.org/EIPS/eip-4337), the disclosure for which is incorporated by reference in its entirety.

In one embodiment, the function modifier may take a period of time specified in one or more of: a number of blocks, a Unix timestamp, UTC time, or a period of time in standard time units such as seconds.

In an example presented for illustrative purposes only and not meant to be limiting in any way, an autonomous smart contract deployed on the Ethereum blockchain may implement a pocket money payout system, and may include a payout function modified with a function modifier indicating that the payout function should be run every 604800 seconds (that is, one week), with the payout function transferring an ERC20 token representing pocket money to a blockchain address of a child. Blockchain nodes may register the autonomous smart contract, and may execute the payout function once a week automatically, subject to the autonomous smart contract owning enough ether to cover gas costs or through other payment methods as disclosed above.

In one embodiment of the present disclosure, henceforth referred to as an autonomous smart contract trigger, a blockchain protocol, node software, and/or a smart contract programming language may include functionality to automatically execute a function or functions of a smart contract in response to an observable change in a state of the blockchain, in a manner similar to a database hook or trigger. In the embodiment, nodes validating and extending the blockchain may include a component responsible for storing a registry of smart contracts including smart contract triggers for functionality to be executed under specific conditions, along with details of the specific conditions triggering execution.

The smart contract programming language may include a function modifier indicating that a function marked with the function modifier is to be run automatically by some or all of the blockchain nodes on an occurrence of a specified condition. Execution of the smart contract trigger may consume gas for each execution, and the smart contract may be required to own a sufficient amount of native cryptocurrency to cover gas costs for execution. If the smart contract does not own enough native cryptocurrency to cover gas costs, nodes may decline to execute the smart contract trigger.

Alternatively, the smart contract may purchase a bond that is included with the smart contract, where the activation of the smart contract provides the activating entity with a reward from a third party that is associated with the bond. The reward may be probabilistic, e.g., be determined based on information not known to the bounty hunter at the time of activation, but generated from information in a deterministic and verifiable manner, e.g., from records on a blockchain posted after the activation of the smart contract. A bond may correspond to a specified number of activations, a specified value, or a combination thereof, and the payment may be conditional on the activation taking part according to one or more policies associated with the smart contract, e.g., a payment is only performed if the smart contract policy indicates that activation is proper, and only one payment is performed per associated time period, where the smart contract may specify how often it is to be activated by indicating a time period, and wherein the time period may be described in term of time, event, or a combination thereof. In one embodiment, the bond is implemented without the use of an external party, but as a payment order that is conditional on policies specified in or by the smart contract, and wherein the smart contract, when activated, can enable the transfer of fund of a specified amount to the party causing the activation, conditional on rules specified in or by the smart contract. One use of these rules is to avoid that multiple bounty hunters get paid for two or more overlapping activations, where two activations are overlapping if they correspond to the same time interval. If multiple activations are performed, a tie-breaker function determines what entity gets paid, where said payment may be probabilistic.

It is understood that the different embodiments described herein can be combined with each other, and that they can be used in the context of the cited prior art to create improved combinations. The disclosed technology can also be used by itself, applied to a blockchain of relevance.

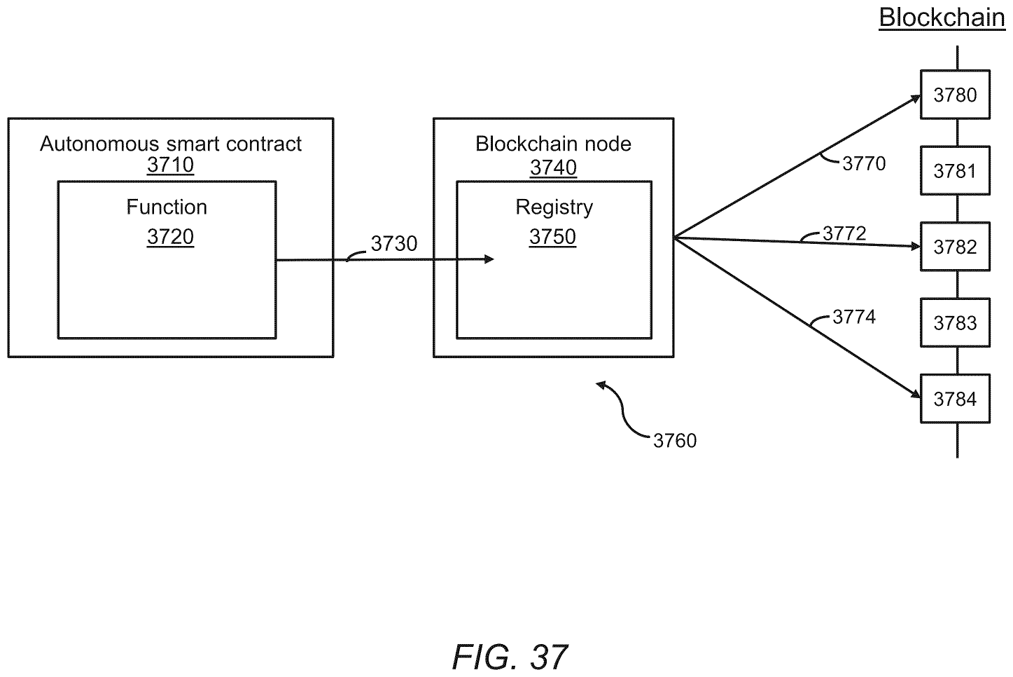

In FIG. 37 a block diagram is presented, for illustrative purposes only and not meant to be limiting in any way, describing an embodiment of a system for executing a function 3720 of an autonomous smart contract 3710 automatically on a regular basis. In the embodiment, details of the function 3720 may be recorded by a blockchain node 3740 including a registry 3750. The details of the function 3720 may be recorded in the registry 3750. In some embodiments, the blockchain node 3740 may not include the registry 3750, and the registry 3750 may be stored in one or more of: a blockchain block, a cloud server, an external storage device, a database, or a file.

The details of the function 3720 may include a notification that the function 3720 is to be run on a regular basis. In the present example, for illustrative purposes, the regular basis may be to run the function 3720 in every other block generated on a blockchain 3760. It will be appreciated that there are many different running triggers or configurations that may be selected for the function 3720, in light of the above.

Once the function 3720 of the autonomous smart contract 3710 is registered in the registry 3750, the blockchain node may run the function 3720 as prescribed. For example, in the present embodiment, the function 3720 is prescribed to run every other block, as shown in FIG. 37 by action 3770 running the function 3720 in block 3780, by action 3772 running the function 3720 in block 3782, and by action 3774 running the function 3720 in block 3784, but not running the function 3720 in block 3781 or block 3783.

The function 3720 may be run by the blockchain node 3740 through a generation of a transaction for each function run. The transaction may include a transaction sender address of the autonomous smart contract, and fees for running each function run may be taken from a balance held by the autonomous smart contract.

A plurality of nodes maintaining and extending the blockchain 3760 may each add an entry to their own registry, said entry constructed when parsing a block in which the autonomous smart contract 3710 was deployed. Through this, each of the plurality of nodes may construct an identical registry. In some embodiments, different nodes from the set of the plurality of nodes may be running different blockchain node software implementing the blockchain 3760 protocol using a different code base and/or programming language, and thus the registry of each node may not necessarily be syntactically or structurally identical, but may be semantically identical.

In an example presented for illustrative purposes only and not meant to be limiting in any way, an autonomous smart contract deployed on the Ethereum blockchain may implement a funding top-up system, and may include a top-up function modified with a function modifier indicating that the top-up function should be executed, said top-up function transferring 10 ether to a blockchain address. A condition under which the function modifier applies may include the blockchain address having a balance less than 1 ether.

A smart contract may belong to one or more categories, where the category may correspond to the functionality of the smart contract, the creator of the smart contract, a reputation range of the smart contract, a certification type of the smart contract, an assurance associated with the smart contract; one or more jurisdictions associated with the smart contract; information about the originator of the smart contract; or a combination of such descriptions and classifications. There may be many smart contracts in a category. Each one may be associated with a score indicating its past performance, where this may correspond to a recommendation value, a fit, the number of times it has been activated, etc. Each contract in the category may also be associated with a fee, corresponding to the cost a calling contract, wallet or other entity has to pay to activate the contract. This enables a marketplace of routines that may be used as subroutines in other smart contracts. An example of such a routine may be an AI that takes a provided input and generates a result, such as a local minimum associated with a search space. The fee may depend on the performance, e.g., whether the called smart contract (or other routine) produces a response that satisfies some criteria.

An autonomous smart contract, which may include functions configured to execute either periodically, or in response to a predefined event, may be implemented to belong to the one or more categories, which may affect its automatic execution. Automatic execution may be affected by a change in one or more of: a reputation of the autonomous smart contract, a reputation of the creator of the autonomous smart contract, a reputation of the deployer of the autonomous smart contract, a certification of the autonomous smart contract, an assurance associated with the smart contract, a jurisdiction the autonomous smart contract is registered in, or a combination of some or all of the preceding. Automatic execution of the autonomous smart contract may also be affected by changes in reputation to other smart contracts, for example, smart contracts used as libraries by the autonomous smart contract. The affected change may include one or more of: a restriction on execution of one or more of the autonomous smart contract functions, a relaxation of restrictions on execution of one or more of the autonomous smart contract functions, a limitation on an amount of cryptocurrency or tokens that may be minted, burned or transferred by the autonomous smart contract, an alteration to an allowlist or banlist associated with the autonomous smart contract.

A smart contract may specify conditions under which an action is performed, where this action may be to revert ownership of a token to a previous owner, to assign ownership or access rights to a specified party such as a trustee selected to determine the rightful owner and transfer the token, or combinations of such actions and associated policies. The smart contract may make determinations of this type when executed. Smart contracts may be required to be executed when ownership is transferred. Smart contracts that are also autonomous may also come with specification of conditions at which the contract should be executed, where such conditions may include the filing of complaints signed by a previous owner of the token using a key associated with this previous owner used to prove the previous ownership. When a condition is met, a bounty hunter may cause the autonomous contract to be invoked, thereby in turn causing the determination, by the contract, of how to modify ownership and/or access rights. These are ways to implement watchfulness using smart contracts, including using autonomous contracts.

A smart contract may implement a functionality that corresponds to a mining event. For example, the smart contract of a token on a first chain may specify a computational task that corresponds to a mining action on a second chain. The funding for the invocation of the smart contract may be in the form of an extra bonus compared with the traditional mining reward, or it may be a separate payment. The smart contract may include other functionality as well, e.g., functionality that causes two chains to be linked, functionality that implements a watchful bridge, functionality that causes the replication of data from one chain to another, functionality that implements an oracle, a matchmaking functionality, a general purpose computation, or a combination of such functionality. Filtering of different types can be outsourced to bounty hunters who identify and report triggered rules for entries in a mempool, a transaction database, on a ledger, or on other types of storage; the functionality of the search performed by the bounty hunter may in part be specified using a smart contract. One type of filtering is the detection of actions that should be blocked, scrutinized, reclassified, prioritized or otherwise processed in a manner specified by one or more rules, where such one or more rules may, fully or in part, be specified or referenced in a smart contract that causes the filtering action when executed.

In some embodiments, mining or proof of work effort may be performed as part of a blockchain protocol requirement or smart contract requirement for the generation of a valid transaction that interacts with the smart contract. Techniques related to are disclosed in co-pending U.S. patent application Ser. No. 18/179,884, titled “Systems and Methods for the Facilitation of Blockchains,” filed Mar. 7, 2023, the disclosure for which is incorporated by reference in its entirety. Mining may be performed by a miner, or as a side-effort by a proof-of-stake validator, with the mining an additional security or spam-prevention requirement to validate a transaction or plurality of transactions interacting with some smart contracts. Transactions synchronizing state between two or more blockchains may require additional proof of work for validation.

Furthermore, in some embodiment, the execution of one or more smart contracts may be required as part of the mining effort. The execution may require all posted smart contracts to be executed; some indicated portion of these; one pseudo-randomly selected smart contract from a collection of smart contracts, or other variants. At the same time, the execution may be required by each individual miner hoping to find a solution to a computational problem; by all individual miners that have qualified, e.g., by having submitted a solution to the computational problem; or by the winning miner, i.e., the miner whose solution has the greatest fitness value. In some embodiments, the solution is a function of values that depend on the output from one or more smart contracts that are selected for execution.

Smart contracts implemented in accordance with many embodiments of the invention are not limited to use within NFT platforms. Accordingly, it should be appreciated that autonomous smart contract configurations described herein may also be implemented outside the context of an NFT platform network architecture unrelated to blockchain configurations. Moreover, any of the applications described herein with reference to FIG. 37 may be utilized within any of the NFT platforms described above.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed is:

1. A machine-readable medium containing bytecode stored within an immutable ledger, where the bytecode encodes a review token, comprising:
a token identifier;
a content element, wherein:
the content element comprises a text document; and
the text document corresponds to a written review;
a recipient identifier, wherein the recipient identifier identifies a blockchain address of an intended recipient;
access control information, comprising a right to transfer; and
execution of the bytecode:
occurs automatically when the recipient identifier matches a current owner of the review token;
renders of the content element; and
blocks the blockchain address of the intended recipient from possessing the right to transfer.
